(19) United States
(12) Patent Application Publication
(10) Pub. No.: US 2026/0046763 A1
(43) Pub. Date: Feb. 12, 2026

(54) ENHANCEMENTS FOR ON-DEMAND SIB1 TRIGGERED BY CELL RESELECTION

(71) Applicant: QUALCOMM Incorporated, San Diego, CA (US)

(72) Inventors: Jianghong LUO, Skillman, NJ (US); Navid ABEDINI, Basking Ridge, NJ (US); Qing LI, Princeton Junction, NJ (US); Hung Dinh LY, San Diego, CA (US); Jae Ho RYU, San Diego, CA (US)

(21) Appl. No.: 19/220,897

(22) Filed: May 28, 2025

Related U.S. Application Data
(60) Provisional application No. 63/681,092, filed on Aug. 8, 2024.

(51) Int. Cl. H04W 52/02; H04W 48/16; H04W 48/20

(52) U.S. Cl. CPC H04W 52/0206; H04W 48/16; H04W 48/20

(57) ABSTRACT

The apparatus may be a wireless device may be configured to select, while camped on a first cell, a second cell that supports a network energy saving (NES) mode and check, in response to selecting the second cell supporting the NES mode, a validity of one or more information elements associated with an on demand system information block 1 (OD-SIB1) for the second cell based on one or more value tags. The apparatus may be a wireless device configured to camp on a first cell and receive, while camping on the first cell, a cross-cell change indication of an update in a next modification period to system information (SI) transmitted by a second cell associated with the first cell.

### CROSS REFERENCE TO RELATED APPLICATION(S)

This application claims the benefit of U.S. Provisional Application Ser. No. 68/681,092, entitled “Enhancements for On-Demand SIB1 Triggered by Cell Reselection” and filed on Aug. 8, 2024, which is expressly incorporated by reference herein in its entirety.

### TECHNICAL FIELD

The present disclosure relates generally to communication systems, and more particularly, to a random access procedure in association with wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device that may be configured to select, while camped on a first cell, a second cell that supports a network energy saving (NES) mode and check, in response to selecting the second cell supporting the NES mode, a validity of one or more information elements associated with an on demand system information block 1 (OD-SIB1) for the second cell based on one or more value tags.

In an aspect of the disclosure, a method, a computer-readable medium, and an apparatus are provided. The apparatus may be a wireless device that may be configured to camp on a first cell and receive, while camping on the first cell, a cross-cell change indication of an update in a next modification period to SI transmitted by a second cell associated with the first cell.

In an aspect of the disclosure, a method, a computer-readable medium, and an apparatus are provided. The apparatus may be a network entity that may be configured to obtain an indication of a change associated with system information for a first cell that provides information about a second cell that supports a NES mode or for the second cell and transmit, based on the indication, one or more of a value tag associated with updated system information of the second cell that supports the NES mode or a cross-cell change indication for a system information update.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a call flow diagram illustrating aspects of wireless communication associated with a first cell associated with one or more NES cells in accordance with some aspects of the disclosure.

FIG. 5 includes a set of diagrams illustrating a SI change indication in accordance with some aspects of the disclosure.

FIG. 6A is a diagram illustrating a network including at least a first cell that periodically transmits SI and a set of associated cells that transmit SI on an on-demand basis in accordance with some aspects of the disclosure.

FIG. 6B is a diagram illustrating transmissions associated with cell selection and/or reselection in the network of FIG. 6A in accordance with some aspects of the disclosure.

FIG. 7 is a diagram illustrating a cross-cell change indication in accordance with some aspects of the disclosure.

FIG. 8A illustrates a set of cells associated with a first cell for sharing cross-cell change indications in accordance with some aspects of the disclosure.

FIG. 8B illustrates a first set of NES cells associated with a first NES cell and a second set of NES cells associated with a second NES cell for sharing cross-cell change indications in accordance with some aspects of the disclosure.

FIG. 8C illustrates a set of cells associated with a second cell for sharing cross-cell change indications in accordance with some aspects of the disclosure.

FIG. 8D illustrates a set of cells associated with a NES cell for sharing cross-cell change indications in accordance with some aspects of the disclosure.

FIG. 9 is a call flow diagram illustrating a method of wireless communication associated with value tags in accordance with some aspects of the disclosure.

FIG. 10 is a call flow diagram illustrating a method of wireless communication associated with value tags in accordance with some aspects of the disclosure.

FIG. 11 is a call flow diagram illustrating a method of wireless communication associated with cross-cell change indications in accordance with some aspects of the disclosure.

FIG. 12 is a call flow diagram illustrating a method of wireless communication associated with cross-cell change indications in accordance with some aspects of the disclosure.

FIG. 13 is a call flow diagram illustrating a method of wireless communication associated with cross-cell change indications in accordance with some aspects of the disclosure.

FIG. 14 is a call flow diagram illustrating a method of wireless communication associated with cross-cell change indications in accordance with some aspects of the disclosure.

FIG. 15 is a call flow diagram illustrating a method of wireless communication associated with cross-cell change indications in accordance with some aspects of the disclosure.

FIG. 16 is a call flow diagram illustrating a method of wireless communication associated with cross-cell change indications in accordance with some aspects of the disclosure.

FIG. 17 is a flowchart of a method of wireless communication.

FIG. 18 is a flowchart of a method of wireless communication.

FIG. 19 is a flowchart of a method of wireless communication.

FIG. 20 is a flowchart of a method of wireless communication.

FIG. 21 is a flowchart of a method of wireless communication.

FIG. 22 is a flowchart of a method of wireless communication.

FIG. 23 is a flowchart of a method of wireless communication.

FIG. 24 is a flowchart of a method of wireless communication.

FIG. 25 is a flowchart of a method of wireless communication.

FIG. 26 is a diagram illustrating an example of a hardware implementation for an example apparatus and/or network entity.

FIG. 27 is a diagram illustrating an example of a hardware implementation for an example network entity.

FIG. 28 is a diagram illustrating an example of a hardware implementation for an example network entity.

FIG. 29 is a call flow diagram 2900 illustrating a method of wireless communication associated with cross-cell change indications in accordance with some aspects of the disclosure.

### DETAILED DESCRIPTION

In some aspects of wireless communication, a cell selection and/or reselection procedure may be performed by an idle and/or inactive UE. During initial cell selection, e.g., upon UE power on, a UE may determine whether it can camp on a detected cell (e.g., a cell detected via a synchronization signal block (SSB)). The determination, in some aspects, may involve evaluating a cell selection criterion (e.g., a signal strength “S”) associated with a secondary synchronization signal (SSS) measurement (e.g., a reference signal received power (RSRP) and/or a reference signal received quality (RSRQ)) of the detected cell. During cell reselection, e.g., for a UE camped in a first cell having detected a second cell, a UE may determine whether to switch its camped cell to the detected second cell by evaluating the cell reselection criterion based on the SSS signal measurement (e.g., the RSRP and/or the RSRQ) of both the first cell and the second cell. In the discussion below references to a cell or cells may refer to a particular cell(s) having, or associated with, a particular cell identifier (ID) or to a base station or access point associated with the cell(s).

In some aspects, a first cell (e.g., a cell not operating in an energy saving mode) may carry and/or provide information for one or more cells supporting a network energy saving (NES) mode (e.g., NES cells) associated with the first cell. The information may include an UL wake up signal (UL-WUS) configuration for OD-SIB1 of one or more NES cells and/or system information (e.g., SIB1) of one or more associated NES cells. The first cell, in some aspects, may operate at a different carrier frequency and/or in a different band or frequency range from its associated NES cells. For example, the first cell may operate in a first frequency range (e.g., FR1 (410 MHz-7.125 GHz)) while the associated NES cells may operate in a second frequency range (e.g., FR2 (24.25 GHz-52.6 GHz) or FR3 (7.125 GHz-24.25 GHz)).

Various aspects relate generally to improving cell selection and/or cell reselection procedures. In some aspects, the improvements may be related to cell selection and/or reselection involving one or more NES cells associated with one or more non-NES cells (e.g., a cellA). Some aspects more specifically relate to validating stored system information and/or configuration information using value tags. Additional aspects, specifically relate to a cross-cell change indication received from a first cell (e.g., a first NES cell or non-NES cell) regarding a SI change (e.g., a change to one or more information elements) associated with a second cell (e.g., a second NES cell or non-NES cell). In some examples, a wireless device may be configured to select, while camped on a first cell, a second cell that supports a NES mode and check, in response to selecting the second cell supporting the NES mode, a validity of one or more information elements associated with an OD-SIB1 for the second cell based on one or more value tags. In some examples, a wireless device may be configured to camp on a first cell and receive, while camping on the first cell, a cross-cell change indication of an update in a next modification period to SI transmitted by a second cell associated with the first cell. A network entity, in some aspects, may be configured to obtain an indication of a change associated with system information for a first cell that provides information about a second cell that supports a NES mode or for the second cell and transmit, based on the indication, one or more of a value tag associated with updated system information of the second cell that supports the NES mode or a cross-cell change indication for a system information update.

Particular aspects of the subject matter described in this disclosure can be implemented to realize one or more of the following potential advantages. In some examples, by validating stored information and/or by receiving cross-cell SI change indications, the described techniques can be used to reduce a latency associated with cell selection and/or cell reselection.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

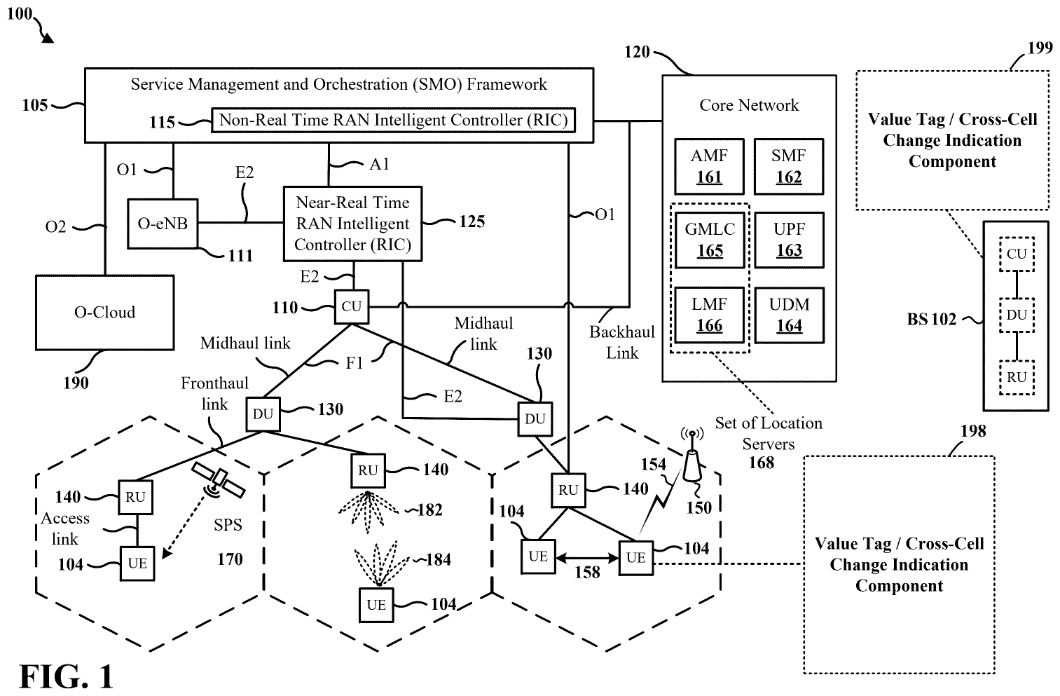

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a value tag/cross-cell change indication component 198 that may be configured to select, while camped on a first cell, a second cell that supports a NES mode and check, in response to selecting the second cell supporting the NES mode, a validity of one or more information elements associated with an OD-SIB1 for the second cell based on one or more value tags. The value tag/cross-cell change indication component 198, in some aspects, may be configured to camp on a first cell and receive, while camping on the first cell, a cross-cell change indication of an update in a next modification period to SI transmitted by a second cell associated with the first cell. In certain aspects, the base station 102 may have a value tag/cross-cell change indication component 199 that may be configured to obtain an indication of a change associated with system information for a first cell that provides information about a second cell that supports a NES mode or for the second cell and transmit, based on the indication, one or more of a value tag associated with updated system information of the second cell that supports the NES mode or a cross-cell change indication for a system information update. Although the following description may be focused on 5G NR, the concepts described herein may be applicable to other similar areas, such as LTE, LTE-A, CDMA, GSM, and other wireless technologies.

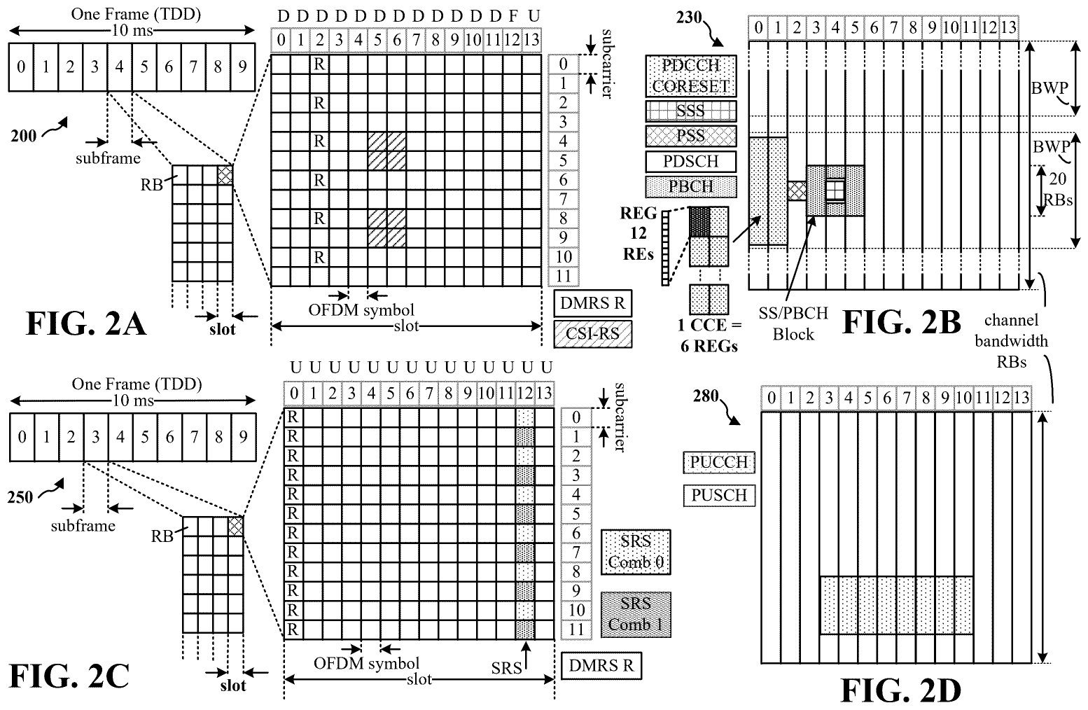

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

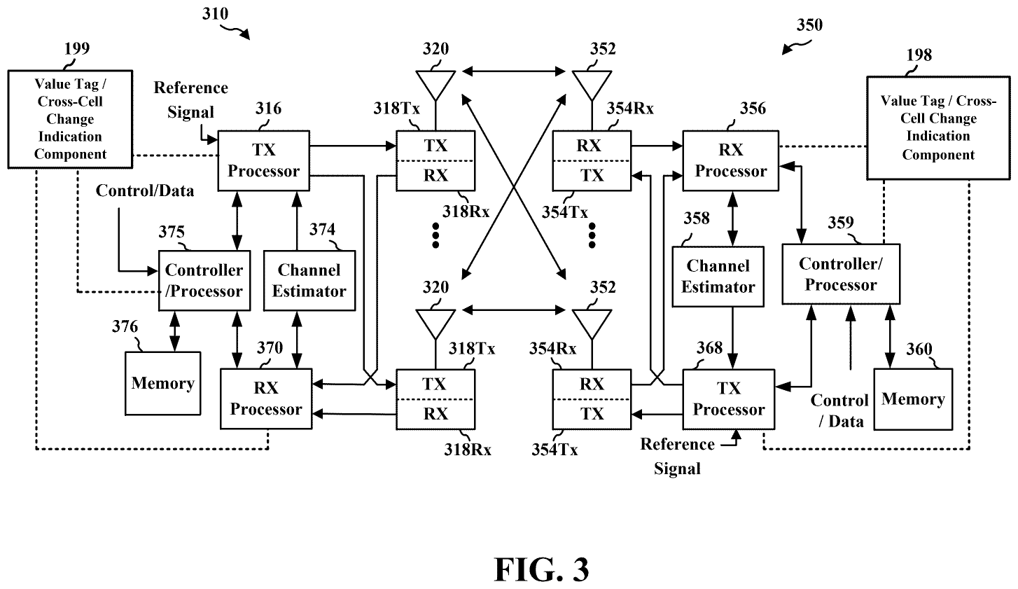

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the value tag/cross-cell change indication component 198 of FIG. 1.

At least one of the TX processor 316, the RX processor 370, and the controller/processor 375 may be configured to perform aspects in connection with the value tag/cross-cell change indication component 199 of FIG. 1.

In some aspects of wireless communication, a cell selection and/or reselection procedure may be performed by an idle and/or inactive UE. During initial cell selection, e.g., upon UE power on, a UE may determine whether it can camp on a detected cell (e.g., a cell detected via a SSB). The determination, in some aspects, may involve evaluating a cell selection criterion (e.g., a signal strength “S”) associated with a SSS measurement (e.g., a RSRP and/or a RSRQ) of the detected cell. During cell reselection, e.g., for a UE camped in a first cell having detected a second cell, a UE may determine whether to switch its camped cell to the detected second cell by evaluating the cell reselection criterion based on the SSS signal measurement (e.g., the RSRP and/or the RSRQ) of both the first cell and the second cell.

In some aspects, a first cell (e.g., a cell not operating in an energy saving mode) may carry and/or provide information for one or more cells supporting a NES mode (e.g., NES cells) associated with the first cell. The information may include an UL-WUS configuration for OD-SIB1 of one or more NES cells and/or system information (e.g., SIB1) of one or more associated NES cells. The first cell, in some aspects, may operate at a different carrier frequency and/or in a different band or frequency range from its associated NES cells. For example, the first cell may operate in a first frequency range (e.g., FR1) while the associated NES cells may operate in a second frequency range (e.g., FR2 or FR3).

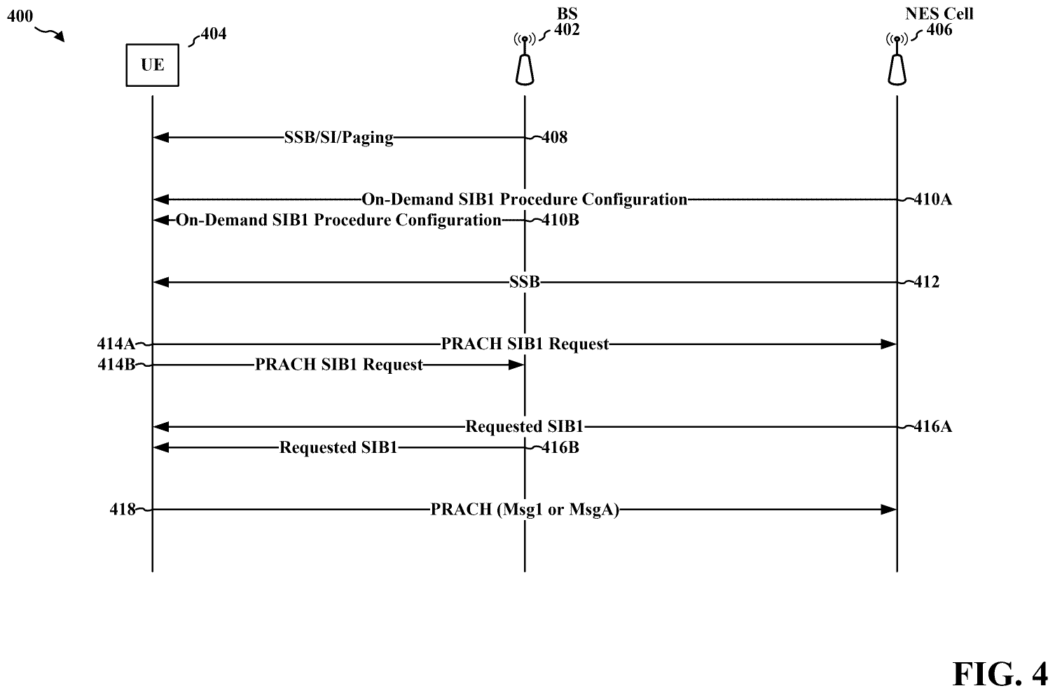

FIG. 4 is a call flow diagram 400 illustrating aspects of wireless communication associated with a first cell associated with one or more NES cells in accordance with some aspects of the disclosure. In some aspects, a first cell (e.g., a base station 402, that may be a non-NES cell) may periodically transmit SSB, SI, and/or paging 408. A UE 404 may receive a configuration for an OD-SIB1 request (e.g., UL-WUS configuration information for OD-SIB1 from one or more NES cells, such as NES cell 406). For example, the UE 404 may receive the OD-SIB1 procedure configuration 410A from the NES cell 406 or may receive the OD-SIB1 procedure configuration 410B from the base station 402. The configuration information for an OD-SIB1, in some aspects, may be referred to as an UL-WUS configuration and/or as UL-WUS configuration information.

The NES cell 406, in some aspects, may transmit, and the UE 404 may receive SSB 412. If the UE 404 selects the NES cell 406 to camp on, the UE 404 may transmit one of PRACH SIB1 request 414A (e.g., an OD-SIB1 request) to NES cell 406 or PRACH SIB1 request 414B to base station 402, based on the OD-SIB1 procedure configuration 410A or the OD-SIB1 procedure configuration 410B, respectively. The UE 404 may, in response to one of the PRACH SIB1 request 414A or the PRACH SIB1 request 414B, receive requested SIB1 416A from the NES cell 406 or requested SIB1 416B from the base station 402, respectively. Based on the SIB1 received from either the NES cell 406 or the base station 402, the UE 404 may transmit a PRACH message 418 (e.g., a Msg1 or a MsgA of a RACH procedure) to establish a connection with the NES cell 406.

In some aspects, a UE camping on the first cell or a first NES cell associated with the first cell may reselect a second NES cell associated with the first cell and, to camp on the second NES cell may request the OD-SIB1 of the second NES cell or otherwise attempt to acquire the SIB1 for the second NES cell. Requesting the OD-SIB1 for the second NES cell, in some aspects, may include transmitting a PRACH request based on the UL-WUS configuration carried and/or provided by the first cell. Before transmitting the PRACH request for the OD-SIB1 for the second NES cell, the UE may determine whether it has stored a valid UL-WUS configuration, e.g., an UL-WUS configuration for the OD-SIB1 for the second NES cell previously acquired and stored from the first cell that is still valid. If a stored UL-WUS configuration is determined to be valid, the UE may transmit the PRACH request based on the stored UL-WUS configuration, but if the stored UL-WUS configuration is determined to not be valid (or to be invalid), the UE may acquire a current and/or valid UL-WUS configuration from the first cell and send the PRACH request based on the updated (e.g., current and/or valid) UL-WUS configuration. However, if a UE camps at the first NES cell, the UE may only monitor PDCCH paging from the first NES cell and may not receive a SI change indication from the first cell regarding a change to the UL-WUS configuration for the OD-SIB1 of the second NES cell. Accordingly, when camped at the first NES cell, the UE may not be capable of verifying the validity of the stored UL-WUS configuration without monitoring the first cell for a periodic UL-WUS configuration transmission which may lead to increased latency if the stored UL-WUS configuration is valid.

Additionally, in association with a selection and/or reselection of the second NES cell and in order to avoid requesting SI that the UE has already acquired, the UE may determine whether it has stored valid SI (e.g., SIB1) for the second NES cell. For example, the UE may determine whether it stores SIB1 for the second NES cell and if SIB1 for the second NES cell is stored, the UE may check the validity of the stored SIB1 for the second NES cell. As described for the UL-WUS configuration, if a UE camps at the first NES cell, the UE may only monitor PDCCH paging from the first NES cell and may not receive a SI change indication from the first cell regarding a change to the SIB1 of the second NES cell. Accordingly, when camped at the first NES cell, the UE may not be capable of verifying the validity of the stored SIB1 without monitoring the first cell or the second NES cell for information that can be used to validate the stored SIB1 which may lead to increased latency if the stored SIB1 is valid.

In some aspects of wireless communication using on demand other system information (OD-OSI), the OD-OSI may be associated with a set of indications and/or parameters such as a value tag (e.g., in a valueTag field), a scope indication (e.g., in an areaScope field), and/or an area ID (e.g., in a SystemInformationAreaID field). In some aspects, each OSI in a configurable list of SIBs (“SIBx” where x may be a number identifying a specific SIB) may be associated with a separate set of indications and/or parameters. The list of SIBs, in some aspects, may not include SIB1, and the SIB1 may carry the information related to the OD-OSI (e.g., the sets of indications for a configured list of SIBs). A value tag may be used to determine whether a UE transmits a UL-WUS associated with acquiring a corresponding SIB (or OD-OSI). For example, the UL-WUS may be sent if, for particular SI, a value tag, or a value associated with the value tag, acquired from SIB1 is not equal to a stored value (or a stored value tag). The value tag, in some aspects, may depend on a public land mobile network (PLMN) identifier and one of a cell identifier (e.g., if no area ID is indicated) or an area ID (e.g., a SystemInformationAreaID value) if an area ID is indicated.

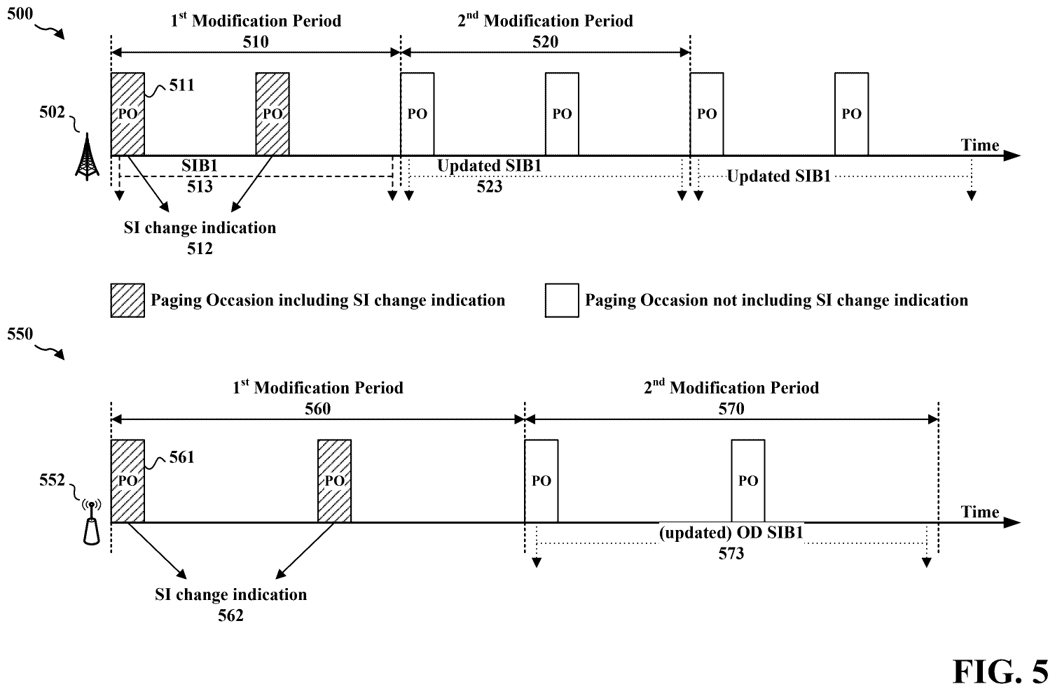

FIG. 5 includes a set of diagrams (e.g., diagrams 500 and 550) illustrating a SI change indication in accordance with some aspects of the disclosure. Diagram 500 illustrates that a cell (e.g., base station 502) may, during a first modification period 510, transmit an SI change indication 512 (e.g., an indication of an upcoming change to SI during a second modification period 520) via PDCCH (using a paging RNTI, or P-RNTI,) associated with a paging occasion 511. Base station 502 is illustrated as sending a SIB1 513 during the first modification period 510 and an updated SIB1 523 during the second modification period 520 (e.g., as indicated by SI change indication 512). The SI change indication 512, in some aspects, may be a short message using a specific format or set of fields (e.g., a Short Message field, and more specifically, a first bit associated with a modification of SI such as a systemInfoModification field/bit in a specific DCI format, such as DCI format 1_0) indicating a change to one or more of a MIB, SIB1, or OSI (e.g., SIBs other than SIB6/7/8). In some aspects in which the SIB1 carries a value tag for each OSI, any change to OSI will lead to a change of SIB1 and an indication of a change to the SI. The SI change indication 512, in some aspects, may be for an SI change of the transmitting cell, e.g., base station 502.

Diagram 550 illustrates that a cell (e.g., NES cell 552) may, during a first modification period 560, transmit an SI change indication 562 (e.g., an indication of an upcoming change to SI during a second modification period 570) via PDCCH (using a P-RNTI,) associated with a paging occasion 561 (where a modification period may include multiple paging occasions). The SI change indication 562, in some aspects, may be a short message using a specific format or set of fields (e.g., a Short Message field, and more specifically, a first bit associated with a modification of SI such as a systemInfoModification field/bit in a specific DCI format, such as DCI format 1_0) indicating a change to one or more of a MIB, SIB1, or OSI (e.g., SIBs other than SIB6/7/8). In some aspects in which the SIB1 carries a value tag for each OSI, any change to OSI may lead to a change of SIB1 and an indication of a change to the SI. The NES cell 552 is illustrated as not transmitting an OD-SIB1 during the first modification period 560 and transmitting an (updated) OD-SIB1 573 during the second modification period 570 (e.g., where the transmission of the OD-SIB1 may be triggered by the SI change indication 562 instead of a PRACH request from a UE). The SI change indication 562, in some aspects, may be for an SI change of the transmitting cell, e.g., NES cell 552.

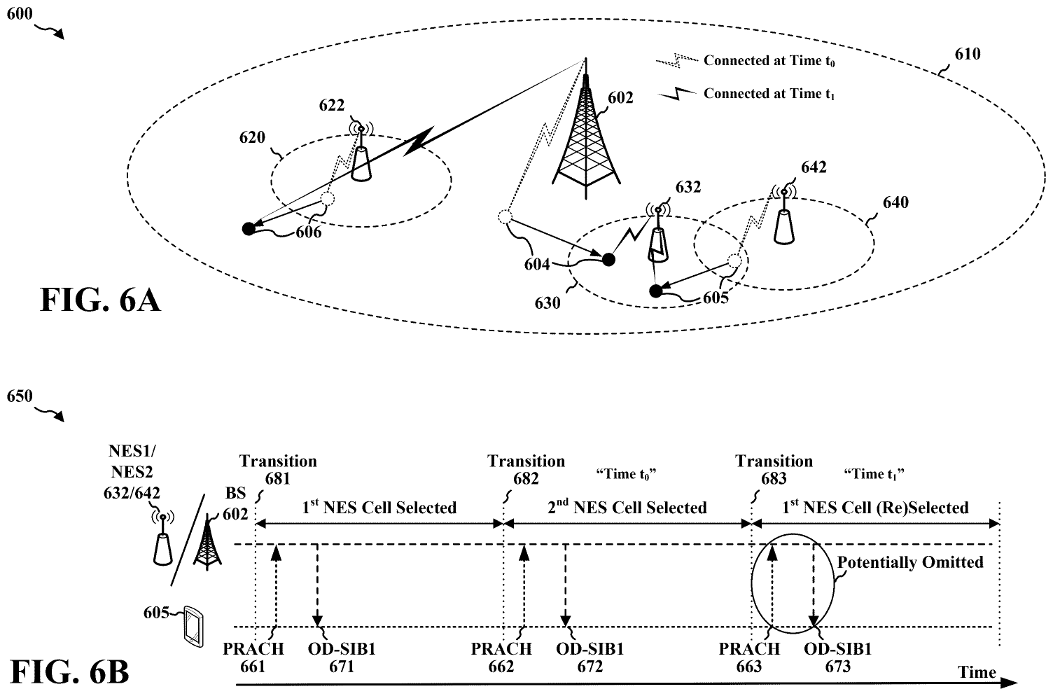

FIG. 6A is a diagram 600 illustrating a network including at least a first cell that periodically transmits SI and a set of associated cells that transmit SI on an on-demand basis in accordance with some aspects of the disclosure. FIG. 6B is a diagram 650 illustrating transmissions associated with cell selection and/or reselection in the network of FIG. 6A in accordance with some aspects of the disclosure. Diagram 600 illustrates a first cell (e.g., a base station 602) that, in some aspects, may cover a large area (e.g., an area 610) that may include a number of smaller areas (e.g., an area 620, an area 630, and an area 640) that are also covered by smaller cells (e.g., a NES cell 622, a NES cell 632, and a NES cell 642, respectively). The first cell, in some aspects, may operate at a different carrier frequency and/or in a different band or frequency range from its associated NES cells. For example, the first cell may operate in a first frequency range (e.g., FR1) while the associated NES cells may operate in a second frequency range (e.g., FR2 or FR3). In some aspects, the first cell (e.g., the base station 602) may not operate in an energy saving mode and/or may transmit periodic signals including SI for the first cell. The first cell, in some aspects, may additionally periodically transmit SI and/or configuration information (e.g., UL-WUS configuration information for OD-SIB1) for one or more associated cells (e.g., the NES cell 622, the NES cell 632, and the NES cell 642). In some aspects, the UL-WUS configuration information may indicate, for an associated cell, the resources associated with transmitting a request for OD-SIB1 from the associated cell.

In some aspects, a UE (the UE 604 and/or the UE 605), at a time t₀, while camping at a cell outside a particular NES cell (e.g., the NES cell 632), e.g., camping at the NES cell 642 or at the first cell (e.g., the base station 602), may select and/or reselect the particular NES cell (e.g., the NES cell 632). For example, the UE 604 (connected to, or camped on, the base station 602) may move within the area 610 to the area 630 and select the NES cell 632 to connect to, or camp on, and/or the UE 605 (connected to, or camped on, the NES cell 642) may move from a location that is in both the area 640 and the area 630 to a location that is in area 630 and select the NES cell 632 to connect to, or camp on. To connect to (or camp on) the NES cell 632, at a subsequent time t₁, the UE 604 and/or the UE 605 may acquire SIB1 for the NES cell 632 (e.g., an OD-SIB1). In some aspects, to acquire SIB1, the UE 604 and/or the UE 605 may acquire, e.g., from the first cell or from the particular NES cell, UL-WUS configuration information associated with requesting the OD-SIB1. Based on the UL-WUS configuration (e.g., the UL-WUS configuration information received from the first cell), the UE 604 and/or the UE 605 may transmit a request for OD-SIB1 (e.g., the UE 605 may transmit PRACH request 663 for OD-SIB1) to the NES cell 632 or to the first cell (e.g., the base station 602), and receive the OD-SIB1 (e.g., the OD-SIB1 673) from the NES cell 632 or from the first cell.

In some aspects, the first cell (e.g., the base station 602) may transmit, and UEs in at least the area 610 may receive, the UL-WUS configuration information for one or more of the associated NES cells on a scheduled basis (e.g., periodically or at known times). Before requesting the OD-SIB1 (e.g., before transmitting a PRACH request for the OD-SIB1), a UE may determine if it has valid and/or current UL-WUS configuration information for the OD-SIB1. For example, a UE may determine whether it had acquired (and stored) UL-WUS configuration information and, if the UL-WUS configuration information was acquired and stored, whether the stored UL-WUS configuration information is still valid or if it is no longer valid (e.g., has been updated since the last time the UE acquired the UL-WUS configuration information). If the UL-WUS configuration information is still valid, the UE may send the PRACH request for the OD-SIB1 based on the (stored and/or previously acquired) UL-WUS configuration information. If the UL-WUS configuration information is no longer valid, the UE may first acquire the latest and/or updated UL-WUS configuration information from the first cell and then send the PRACH request for the OD-SIB1 based on the latest and/or updated UL-WUS configuration information. However, if a UE camps at a particular NES cell of the associated NES cells, the UE may monitor PDCCH paging from the particular NES cell (but not the PDCCH paging from the first cell) and may not receive a SI change indication from the first cell regarding the change to the UL-WUS configuration information.

In addition to checking the validity of the UL-WUS configuration information, the UE may determine if it has valid and/or current OD-SIB1. For example, a UE may determine whether it had acquired (and stored) the OD-SIB1 and, if the OD-SIB1 was acquired and stored, whether the stored OD-SIB1 is still valid or if it is no longer valid (e.g., has been updated since the last time the UE acquired the OD-SIB1). If the OD-SIB1 is still valid, the UE may omit and/or skip sending the PRACH request for the OD-SIB1 and use the stored OD-SIB1. If the OD-SIB1 is no longer valid, the UE may send the PRACH request for the OD-SIB1 based on the latest and/or updated UL-WUS configuration information. Referring to FIG. 6B, the UE 605 may select, at a transition 681, a first NES cell (e.g., the NES cell 632) to camp on, determine that it does not have valid OD-SIB1 for the first NES cell, transmit a PRACH request 661, and receive (and store) OD-SIB1 671. The UE 605 may subsequently select, at transition 682, a second NES cell (e.g., the NES cell 642) to camp on, determine that it does not have valid OD-SIB1 for the second NES cell, transmit a PRACH request 662, and receive (and store) OD-SIB1 672. Upon reselection, at transition 683, of the first NES cell (e.g., the NES cell 632) to camp on, the UE 605 may determine if the stored OD-SIB1 for the first NES cell is valid and may, if the OD-SIB1 is not valid, transmit the PRACH request 663 and receive (and store) OD-SIB1 673. If the UE 605 determines that the stored OD-SIB1 for the first cell (e.g., OD-SIB1 671) is valid, the UE 605 may omit a transmission of the PRACH request 663. However, if a UE camps at a particular NES cell of the associated NES cells, the UE may monitor PDCCH paging from the particular NES cell (but not the PDCCH paging from the first cell) and may not receive a SI change indication from the first cell regarding the change to the UL-WUS configuration information. Accordingly, in the example of diagram 650, if the first NES cell transmits a SI change indication while the UE 605 is camped on the second NES cell, the UE 605 may not be aware that OD-SIB1 671 is no longer valid and may mistakenly base a first message in a random access procedure on the invalid OD-SIB1 671.

Various aspects relate generally to improving cell selection and/or cell reselection procedures. In some aspects, the improvements may be related to cell selection and/or reselection involving one or more NES cells associated with one or more non-NES cells (e.g., a cellA). Some aspects more specifically relate to validating stored system information and/or configuration information using value tags. Additional aspects, specifically relate to a cross-cell change indication received from a first cell (e.g., a first NES cell or non-NES cell) regarding a SI change (e.g., a change to one or more information elements) associated with a second cell (e.g., a second NES cell or non-NES cell). In some examples, a wireless device may be configured to select, while camped on a first cell, a second cell that supports a NES mode and check, in response to selecting the second cell supporting the NES mode, a validity of one or more information elements associated with an OD-SIB1 for the second cell based on one or more value tags. In some examples, a wireless device may be configured to camp on a first cell and receive, while camping on the first cell, a cross-cell change indication of an update in a next modification period to system information (SI) transmitted by a second cell associated with the first cell. A network entity, in some aspects, may be configured to obtain an indication of a change associated with system information for a first cell that provides information about a second cell that supports a NES mode or for the second cell and transmit, based on the indication, one or more of a value tag associated with updated system information of the second cell that supports the NES mode or a cross-cell change indication for a system information update.

In some aspects, when a UE (re) selects a second NES cell while camping at a first cell (or a first NES cell) outside the second NES cell, before sending a PRACH to request OD-SIB1 of the second NES cell, the UE may acquire one or more value tags to check the validity of one or more of its stored information elements for OD-SIB1 of the second NES cell. A stored information element for the OD-SIB1, is valid (and may be determined to be valid) if the acquired value tag matches the stored value tag for the stored information element, otherwise (if the value tags do not match) the information element is invalid (and may be determined to be invalid).

In some aspects, the one or more stored information elements may include one or more of the UL-WUS configuration information for OD-SIB1 of the second NES cell and/or UL-WUS configuration information for OD-SIB1 of a set of NES cells including the second NES cell, a SIB1 of the second NES cell and/or SIB1s of a set of NES cells including the second NES cell. In some aspects, the acquisition of the value tag may be from a first cell (e.g., referring to FIG. 6A, the UE 604 and/or UE 605 selecting the NES cell 632 may acquire a value tag from the base station 602), the camped cell (e.g., the base station 602 for the UE 604 or the NES cell 642 for the UE 605), or the second NES cell.

The value tag used to check the validity of a stored information element (e.g., to perform a validity check for an information element), in some aspects, may be included in a same container message (or transmission) as the information element (e.g., the information element corresponding to the value tag). In some aspects, the value tag used to check the validity of a stored information may be included in a different container message (or transmission) than the information element. For example, an information element, in some aspects, may be carried by SIBx (not SIB1) of a first cell (e.g., base station 602), while a corresponding value tag may be carried by periodic SIB1 of the first cell. In some aspects, both an information element and a corresponding value tag may be carried by (or included in) a same SIBx of the first cell. Both an information element and a corresponding value tag, in some aspects, may be carried by (or included in) a same RRC release message of a camped cell. In some aspects, a value tag may be carried by a MIB of the second NES cell (a currently selected, but not camped NES cell), while a corresponding information element may be carried by (or transmitted by) a first cell or a camped cell (the first cell or a different NES cell). In some aspects, the value tag may be carried by (or included in) a periodic message, e.g., SIB1 or SIBx of the first cell, to avoid a transmission from the UE of a PRACH request when checking the validity of an information element. The indication of a change of, or to, one or more of the UL-WUS configuration information for OD-SIB1, the SIB1 of the second NES cell, the value tag for the UL-WUS configuration information, or the value tag for the SIB1 of the second NES cell may be included in a message in the F1-AP interface and/or Xn interface.

If a value tag for the UL-WUS configuration information and/or a value tag for the SIB1 of the second NES cell is carried by, or transmitted by, a first cell (a non-NES cell), a UE may need to tune to the first cell (to a frequency range used by the first cell but not by the second NES cell or other selected NES cells) to acquire the value tag(s) during each cell reselection to the second NES cell (or other NES cells) if not camping at the first cell. In order to avoid tuning to the first cell when the value tag for the UL-WUS configuration information and/or the value tag for the SIB1 of the second NES cell is valid, a cross-cell change indication may be transmitted and/or received via an enhanced short message.

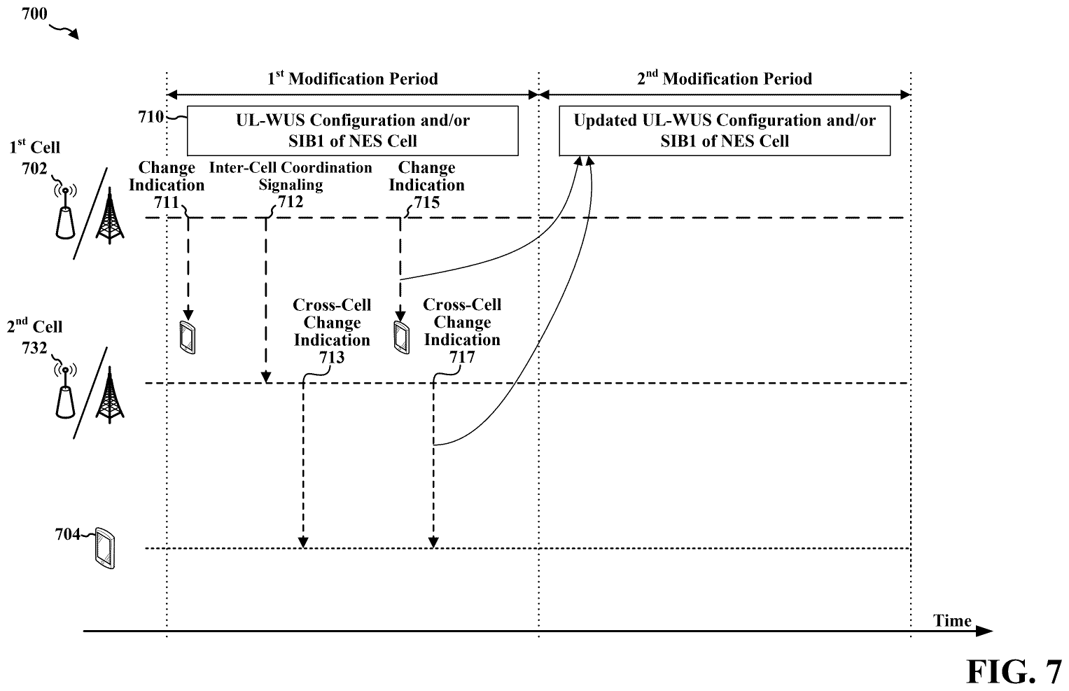

FIG. 7 is a diagram 700 illustrating a cross-cell change indication in accordance with some aspects of the disclosure. A UE 704, in some aspects, may be camped on a second cell 732 (a non-NES base station or a NES cell that does not provide OD-SIB1 for at least a first cell 702). While the UE 704 is camped on the second cell 732, the first cell 702 may transmit a change indication 711 to one or more UEs (e.g., inactive or idle UEs) camped on the first cell 702 indicating a change to a system information transmitted by the first cell 702. In addition to transmitting the change indication 711 to the UEs, the first cell 702 may transmit an inter-cell coordination signaling 712, where the inter-cell coordination signaling 712, in some aspects may be triggered by the change to the SI and/or the transmission of the change indication 711 (e.g., a transmitted inter-cell coordination signaling). In some examples, a system information transmitted by the first cell may carry to the UL-WUS configuration information and/or the OD-SIB1 710 associated with the first cell 702 (or another cell associated with the first cell 702). In turn, the second cell 732 may transmit a cross-cell change indication 713 including an indication of the change of a system information transmitted by the first cell 702. In some example, a system information transmitted by the first cell may carry the UL-WUS configuration information and/or the OD-SIB1 710 associated with the first cell 702 (or the other cell associated with the first cell 702), and the change of the system information may refer to the change to the UL-WUS configuration information and/or the OD-SIB1 710. Similarly, while the UE 704 is camped on the second cell 732, the first cell 702 may transmit an additional change indication 715 indicating an additional change to the UL-WUS configuration information and/or the OD-SIB1 710 associated with the first cell 702 (or another cell associated with the first cell 702). In turn, the second cell 732 may transmit an additional cross-cell change indication 717 including an indication of the change to the UL-WUS configuration information and/or the OD-SIB1 710 associated with the first cell 702 (or the other cell associated with the first cell 702). Based on at least one of the cross-cell change indication 713 or the cross-cell change indication 717, the UE 704 may be made aware of changes to the UL-WUS configuration information and/or the OD-SIB1 710 associated with the first cell 702 (or the other cell associated with the first cell 702) and may retrieve the updated UL-WUS configuration information and/or the updated OD-SIB1 720 associated with the first cell 702 (or the other cell associated with the first cell 702) when the first cell is selected or to prepare for the possibility that the first cell may be selected.

As described above in relation to FIG. 7, one or more cells (e.g., NES cells and/or non-NES cells such as the NES cells and base station illustrated in FIG. 6A) may support a cross-cell change indication transmitted by a first cell (e.g., the second cell 732) to indicate a change in one or more information elements transmitted by (or associated with) a second cell (e.g., the first cell 702) during a next modification period following the change indication, where the first cell is different from the second cell. The one or more information elements transmitted by the second cell that are indicated to be changed and/or updated during (or for) a next modification period (e.g., via an SI change indication and/or inter-cell coordination signaling from the second cell), in some aspects, may include the OD-SIB1 of a NES cell, and/or the UL-WUS config for OD-SIB1 of a NES cell. In some aspects, the first cell may be a NES cell camped on by the UE and the second cell may be an additional NES cell or non-NES cell that is in a set of cells associated with the first cell (e.g., a set of cells within a threshold distance of the first cell, all cells adjacent to the first cell, one or more non-NES cell(s) associated with the first cell along with all (or a subset of) other NES cells associated with the one or more non-NES cell(s), or other groupings based on one or more other criteria).

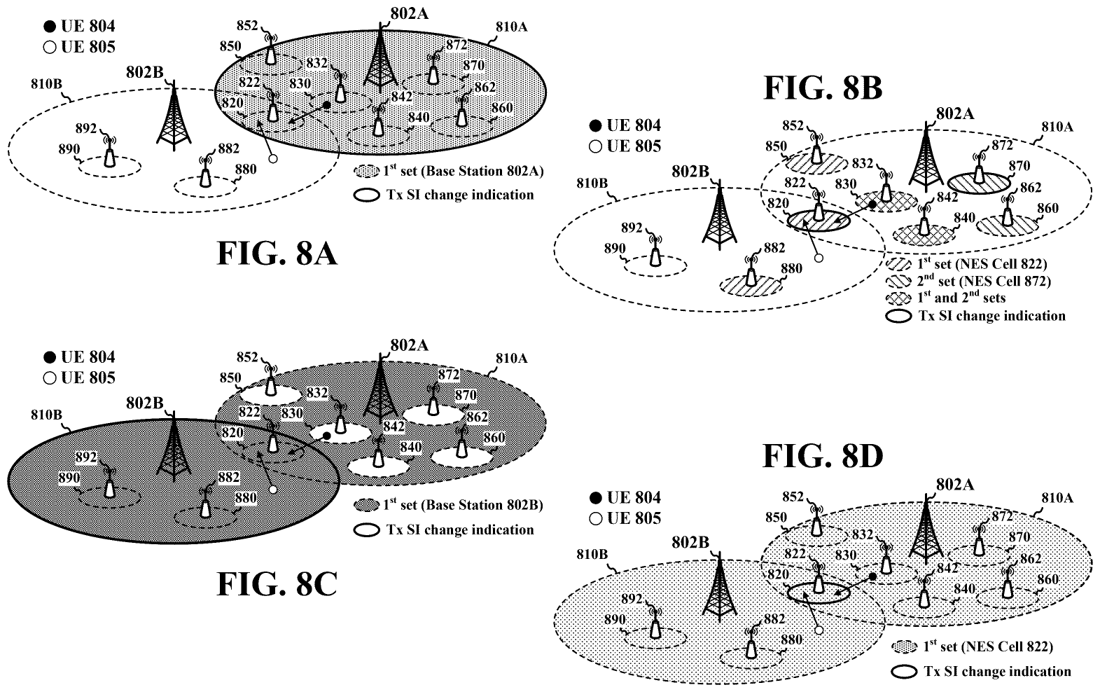

FIG. 8A illustrates a set of cells associated with a first cell for sharing cross-cell change indications in accordance with some aspects of the disclosure. FIG. 8B illustrates a first set of NES cells associated with a first NES cell and a second set of NES cells associated with a second NES cell for sharing cross-cell change indications in accordance with some aspects of the disclosure. FIG. 8C illustrates a set of cells associated with a second cell for sharing cross-cell change indications in accordance with some aspects of the disclosure. FIG. 8D illustrates a set of cells associated with a NES cell for sharing cross-cell change indications in accordance with some aspects of the disclosure. FIGS. 8A-8D illustrate a first cell (e.g., a base station 802A) that may be associated with a coverage area 810A including a set of NES cells (e.g., a NES cell 822, a NES cell 832, a NES cell 842, a NES cell 852, a NES cell 862, and a NES cell 872). Each NES cell, in some aspects, may be associated with a corresponding coverage area (e.g., a coverage area 820, a coverage area 830, a coverage area 840, a coverage area 850, a coverage area 860, and a coverage area 870). A second cell (e.g., the base station 802B) may be associated with a coverage area 810B including a set of NES cells (e.g., the NES cell 822, a NES cell 882 and a NES cell 892). Each NES cell, in some aspects, may be associated with a corresponding coverage area (e.g., the coverage area 820, a coverage area 880 and a coverage area 890). A UE 804 may be within the coverage area 830 (and the coverage area 810A) at a first time and may move into the coverage area 820 (and the coverage area 810B without leaving the coverage area 810A). A UE 805 may be within the coverage area 810B (and outside the coverage area 810A) at a first time and may move into the coverage area 820 (and the coverage area 810A without leaving the coverage area 810B).

FIG. 8A illustrates that for a (non-NES) base station 802A (e.g., a cellA), a first set of NES cells in the coverage area 810A associated with the base station 802A (e.g., the NES cell 822, the NES cell 832, the NES cell 842, the NES cell 852, the NES cell 862, and the NES cell 872) may be associated with, or transmit, a cross-cell change indication based on inter-cell coordination signaling (or a cross-cell change indication) transmitted by the base station 802A (indicated by a solid line around coverage area 810A). While FIG. 8A depicts all NES cells being included in the first set of NES cells, in some aspects, the first set of NES cells may include a subset of NES cells within the coverage area 810A or associated with base station 802A where NES cells within the coverage area 810A but not in the first set of NES cells are not depicted for clarity. For example, a NES cell (e.g., any of the NES cell 822, the NES cell 832, the NES cell 842, the NES cell 852, the NES cell 862, or the NES cell 872) may, upon receiving inter-cell coordination signaling (e.g., inter-cell coordination signaling 712 of FIG. 7) from base station 802A, transmit a cross-cell change indication for UEs camped on the NES cell indicating that the SI (either the UL-WUS configuration information for the OD-SIB1 for one or more of the associated NES cells, SI [e.g., SIBx] for the base station 802A, or the OD-SIB1 for one or more of the associated NES cells) transmitted by the base station 802A has changed.

FIG. 8B illustrates that for a NES cell, at least a set of neighbor NES cells may be included in a set of cells configured to transmit a cross-cell change indication based on inter-cell coordination signaling received from the NES cell indicating a change to SI transmitted by the NES cell or based on inter-cell coordination signaling transmitted by, and received from, a non-NES cell (e.g., the base station 802A or the base station 802B) associated with the NES cell and indicating at least one of a change to the UL-WUS configuration for the OD-SIB1 for the NES cell or a change to the OD-SIB1 for the NES cell transmitted by the non-NES cell. The NES cells associated with the changed SI, in some aspects, may be indicated by a solid line around an associated coverage area. For example, for changed SI related to the NES cell 822, a first set of neighbor NES cells may include the NES cell 832, the NES cell 842, the NES cell 852, and the NES cell 882. For changed SI related to the NES cell 872, a second set of neighbor NES cells may include the NES cell 832, the NES cell 842, and the NES cell 862.

In some aspects, a non-NES base station or cell (e.g., base station 802A and/or base station 802B) may also be included in the set of cells configured to transmit the cross-cell change indication based on the inter-cell coordination signaling associated with the NES cell when the NES cell is within the coverage area of the non-NES base station or cell. For example, for the NES cell 822, both the base station 802A and the base station 802B may be included in the set of cells configured to transmit the cross-cell change indication, while for the NES cell 872, the set of cells configured to transmit the cross-cell change indication may include the base station 802A but not the base station 802B. If the non-NES cell transmits the OD-SIB1 for the NES cell, the NES cell may transmit a SI change indication relating to the OD-SIB1 (and/or the updated SIB1 in a next modification period). In some aspects, if the non-NES cell transmits a SIBx carrying OD-SIB1 for a set of NES cells, the non-NES cell may transmit a SI change indication based on determining that its SIBx has changed (in some aspects, this SI change indication may be referred to as, and share characteristics with, a cross-cell change indication because it is a change indication relating to SI information for another cell), and a NES cell in a set of associated NES cells may transmit an SI change indication based on determining that its own SIB1 has changed. Additionally, in some aspects, a NES cell in the set of associated NES cells may transmit a cross-cell SI change indication based on the reception of inter-cell coordination signaling (e.g., an inter-cell coordination signaling message) from the non-NES cell indicating that SIB1 of another NES cell in the set has changed. In some aspects, the members of the set may be selected based on criteria related to a likelihood for a UE camped on a cell to select the NES cell transmitting (or associated with) the SI change indication, the inter-cell coordination signaling, or the cross-cell change indication associated with a change to the SI in a next modification period (or in one of N next modification periods where N is greater than 1). For example, the criteria may be related to a distance from the NES cell, a signal strength of the NES cell at the potential member cell, or other relevant characteristics of the NES cell.

FIG. 8C illustrates that for a (non-NES) base station 802B (e.g., a cellA), a set of cells configured to transmit a cross-cell change indication based on a SI change indication and/or the inter-cell coordination signaling transmitted by the base station 802B (indicated by a solid line around coverage area 810B) may include, base station 802A (e.g., based on an overlap between the coverage area 810B and the coverage area 810A) and NES cells in the coverage area 810B associated with the base station 802B (e.g., the NES cell 822, the NES cell 882, and the NES cell 892). In some aspects, the set of cells may also include the NES cells in the coverage area 810A associated with the base station 802A (e.g., the NES cell 832, the NES cell 842, the NES cell 852, the NES cell 862, and the NES cell 872). While FIG. 8C depicts all NES cells in the coverage area 810B but not the NES cells in the coverage area 810A being included in the set of cells, in some aspects, the set of cells may include a subset of NES cells within the coverage area 810B and/or the coverage area 810A or associated with the base station 802B or the base station 802A, respectively, where additional NES cells not in the set of cells are not depicted for clarity. For example, a cell (e.g., any of the base station 802A, the NES cell 822, the NES cell 882, or the NES cell 892) may, upon receiving inter-cell coordination signaling from base station 802B, transmit a cross-cell change indication for UEs camped on the cell indicating that the SI (either the UL-WUS configuration information for the OD-SIB1 for one or more of the associated NES cells, SI [e.g., SIBx] for the base station 802B, or the OD-SIB1 for one or more of the associated NES cells transmitted by the base station 802B) transmitted by the base station 802A has changed.

When the inter-cell coordination signaling indicates a particular NES cell for which the inter-cell coordination signaling is transmitted (e.g., inter-cell coordination signaling related to a change to a SIBx related to, or carrying, the UL-WUS configuration information for the OD-SIB1 for a particular NES cell or the OD-SIB1 for the particular NES cell transmitted by the base station 802B), the members of the set of cells may further be determined based on the particular NES cell indicated. For example, for inter-cell coordination signaling related to the UL-WUS configuration information for the OD-SIB1 for the NES cell 822 or the OD-SIB1 for the NES cell 822 transmitted by the base station 802B, the base station 802A may be included in the set of cells (e.g., based on the NES cell 822 being within the coverage area 810A or based on the coverage area 810B overlapping with the coverage area 810A). However, if the inter-cell coordination signaling is related to the UL-WUS configuration information for the OD-SIB1 for the NES cell 892 or the OD-SIB1 for the NES cell 892 transmitted by the base station 802B, the base station 802A may not be included in the set of cells (e.g., based on the NES cell 892 being distant from the coverage area 810A).

FIG. 8D illustrates that for a NES cell (e.g., the NES cell 822), a set of cells configured to transmit a cross-cell change indication based on inter-cell coordination signaling transmitted by the NES cell (indicated by a solid line around coverage area 820) may include, base station 802A (e.g., based on an overlap between the coverage area 810A and the coverage area 820), the NES cells in the coverage area 810A associated with the base station 802A (e.g., the NES cell 832, the NES cell 842, the NES cell 852, the NES cell 862, and the NES cell 872), base station 802B (e.g., based on an overlap between the coverage area 810B and the coverage area 820), and the NES cells in the coverage area 810B associated with the base station 802B (e.g., the NES cell 882 and the NES cell 892). While FIG. 8D depicts all NES cells in the coverage area 810B and the coverage area 810A being included in the set of cells, in some aspects, the set of cells may include a subset of NES cells within the coverage area 810B and/or the coverage area 810A or associated with the base station 802B or the base station 802A, respectively, where NES cells not in the set of cells are not depicted for clarity. For example, a cell (e.g., any of the base station 802A, the base station 802B, the NES cell 832, the NES cell 842, the NES cell 852, the NES cell 862, the NES cell 872, the NES cell 882, or the NES cell 892) may, upon receiving inter-cell coordination signaling from the NES cell 822, transmit a cross-cell change indication for UEs camped on the cell indicating that the SI (e.g., SI [e.g., SIBx] for the NES cell 822 or the OD-SIB1 for the NES cell 822) transmitted by the NES cell 822 has changed. The inter-cell coordination signaling (e.g., an inter-cell coordination signaling message) for cross-cell SI change indication and/or a value tag associated with an information element, in some aspects, may be transmitted over an Xn interface or an F1-AP interface.

In some aspects, a cross-cell change indication may be carried by a short message, which may reuse an existing SI change indication or a may use a new indication (or indication format). For example, referring to FIGS. 8A-8D, if the UL-WUS configuration information for the OD-SIB1 transmitted by base station 802A has changed (and inter-cell coordination signaling has been transmitted by the base station 802A), all or a subset of the NES cells associated with the base station 802A may send the cross-cell change indication as described in relation to FIG. 8A. If the UL-WUS configuration information transmitted by the base station 802A for the OD-SIB1 of the NES cell 822 has changed, the NES cell 822 and all or a subset of neighbor cells of the NES cell 822 (e.g., the first set of NES cells in FIG. 8B) may send the cross-cell change indication. If a SIB1 (e.g., the OD-SIB1) for a first NES cell (e.g., the NES cell 822) and transmitted by the first NES cell, has changed (and inter-cell coordination signaling has been transmitted by the first NES cell), in some aspects, a non-NES cell (e.g., the base station 802A and/or the base station 802B) and/or a set of NES cells associated with the non-NES cell may send and/or transmit the cross-cell change indication (e.g., as depicted in relation to FIG. 8B and/or FIG. 8D). In some aspects, if a SIB1 (e.g., the OD-SIB1) for a first NES cell (e.g., the NES cell 822) and transmitted by a non-NES cell (e.g., the base station 802A) has changed, the non-NES cell may transmit and/or send an SI change indication based on and/or related to the change to the SIBx related to the NES cell. Based on the inter-cell coordination signaling transmitted by the non-NES cell, a set of NES cells associated with the non-NES cell and/or the first NES cell may transmit and/or send a cross-cell change indication e.g., as depicted in relation to FIG. 8B and/or FIG. 8D).

In some aspects, upon receiving a cross-cell change indication for at least a second cell (e.g., a NES cell) while camped on a first cell (e.g., a NES cell or a non-NES cell), a UE may determine whether a set of one or more relevant information elements transmitted by the second cell may change starting from the next modification period, where the relevant information elements can be associated with the second cell or some other cells. In some aspects, a relevant information element in the set of one or more relevant information elements may be an information element related to a cell selection and/or reselection process and/or a cell acquisition and/or random access process and/or procedure for the second cell and/or a third cell, such as one of the UL-WUS configuration information for the OD-SIB1 for one or more of the second cell or the third cell and/or the SIB1 (or OD-SIB1) for one or more of the second cell or the third cell. In some aspects, the inter-cell coordination signaling triggering a cross-cell change indication may be transmitted in association with a change to a relevant information element but not in association with changes to other information elements, such that the transmission of the cross-cell change indication indicates a change to a relevant information element. Accordingly, in some aspects, determining whether the set of one or more relevant information elements has changed may include determining whether the cross-cell change indication has been received. If the cross-cell change indication may be transmitted in association with a change to an information element other than a relevant information element, the determination, in some aspects, may be based on one or more value tags associated with the set of one or more relevant information elements stored at the UE and corresponding value tags received and/or acquired after receiving the cross-cell change indication.

As discussed above, the value tags may be carried in, or by, one or more of a periodic SIB1 of a non-NES cell (e.g., the base station 802A), a SIBx of the non-NES cell, a RRC release message of a camped cell, or a MIB of a selected and/or a reselected cell. Where the message (or message container) used to transmit an information element may be the same or different from the message (or message container) used to transmit the corresponding value tag. The value tag for the UL-WUS configuration information or the value tag for a SIB1 of a non-camped cell may be included in a message in the F1-AP interface and/or Xn interface.

If the UE determines that the set of one or more relevant information elements transmitted by (or associated with) the second cell will be changed beginning from the next modification period after the modification period during which the cross-cell change indication is transmitted, the UE may, in some aspects, acquire the updated information elements from the second cell in the next modification period following the change indication. In some aspects, the UE, may store an internal flag (e.g., a bit for each of a list of cells, or other data structure or information) indicating whether a relevant information element has changed since a last acquisition, where upon acquisition of a set of one or more relevant information elements for a particular cell, the internal flag may be reset to indicate that the set of one or more relevant information elements for the particular cell is current and/or valid. The UE, in some aspects, may, based on the determination that the set of one or more relevant information elements transmitted by (or associated with) the second cell has changed, update the internal flag to indicate that the set of one or more relevant information elements for at least the second cell is no longer current and/or valid. Based on the internal flag indicating that the set of one or more relevant information elements for at least the second cell is no longer current and/or valid and in association with a cell selection and or reselection of the second cell, the UE may (re) acquire the relevant information element (e.g., a current and/or latest version of the relevant information element) and reset the internal flag for the second cell.

In some aspects, if a UE (e.g., the UE 805) is camped at a particular cell (e.g., the base station 802B) not in the set of cells transmitting a cross-cell change indication for a selected and/or reselected cell (e.g., the NES cell 822), the UE may miss the change indication. Accordingly, for a UE that is aware that the particular cell is not in the set of cells transmitting the cross-cell change indication for the selected and/or reselected cell, the UE may fall back to acquiring (and comparing) value tags to check the validity of a stored set of one or more relevant information elements, and/or acquiring updated SI without a validity check (e.g., acquiring an UL-WUS configuration and/or transmitting the UL-WUS to acquire OD-SIB1 without checking the validity of stored SI).

In some aspects, for example, a first non-NES cell (e.g., the base station 802B) may carry, provide, and/or transmit UL-WUS configuration information for OD-SIB1 of a first set of NES cells (e.g., the NES cell 822, the NES cell 882, and the NES cell 892) and a corresponding and/or associated value tag. A cross-cell change indication may be transmitted by the first set of NES cells whenever the UL-WUS configuration information is updated by the non-NES cell (e.g., will be changed in a next modification period). Accordingly, if a UE is camped at the non-NES cell or any cell in the first set of NES cells, the UE may receive (or be capable of receiving) a notification about a change of the UL-WUS configuration information and acquire the updated (relevant information elements) or flag the relevant information elements for (re) acquisition in association with a subsequent cell selection and/or reselection. Accordingly, the UE may omit and or refrain from tuning to the non-NES cell (which may be operating in a different frequency range than a NES cell on which the UE is camped) to check the validity of a (locally) stored UL-WUS configuration information during a cell reselection associated with a NES cell in the first set of NES cells if no cross-cell change indication has been received or updated information elements have been acquired based on a received cross-cell change indication.

However, if a UE is camped at a cell that is not in the first set of NES cells and is not the first non-NES cell, it may not receive the cross-cell change indication and the UE may tune to the first non-NES cell (which may be operating in a different frequency range than a cell on which the UE is camped) to check the validity of a (locally) stored UL-WUS configuration information during a cell reselection associated with a NES cell in the first set of NES cells. Similarly, in the absence of the cross-cell change indication, a UE camped on any cell except the first non-NES cell would tune to the first non-NES cell to check the validity of stored UL-WUS configuration information in association with a selection and/or reselection involving a NES cell in the first set of NES cells. However, when using the cross-cell change indication, a UE camped on a NES cell in the first set of NES cells may omit and/or refrain from tuning to the first non-NES cell in association with a selection and/or reselection involving another NES cell in the first set of NES cells when it has not received a cross-cell change indication since a last acquisition of the UL-WUS configuration information. In some aspects, the last acquisition of the UL-WUS configuration information may have been triggered by a cross-cell change indication that was received prior to the selection and/or reselection involving another NES cell in the first set of NES cells. By acquiring the UL-WUS configuration information before the cell selection and/or reselection a latency and/or power consumption may be reduced when compared to a cell selection and/or reselection in the absence of the cross-cell change indication.

In some aspects, for example, a first non-NES cell (e.g., the base station 802B) may carry, provide, and/or transmit a value tag for an OD-SIB1 of at least a first NES cell (e.g., the NES cell 822) to UEs camped on the first non-NES cell, where the first NES cell transmits the OD-SIB1 (e.g., in response to a PRACH request based on UL-WUS configuration information transmitted by the first non-NES cell). A cross-cell change indication may be transmitted by a first set of cells (e.g., either a first set of cells including the first non-NES cell and a set of associated NES cells including the NES cell 882 and the NES cell 892 or the set of associated NES cells when the first non-NES cell transmits a SI change indication of a value tag or other SI associated with the OD-SIB1 transmitted by the first NES cell) whenever the OD-SIB1 (e.g., a SIB1 that is transmitted on-demand or after a change) is updated by the first NES cell (e.g., will be changed in a next modification period). Accordingly, if a UE is camped at any cell in the first set of cells, the UE may receive (or be capable of receiving) a notification about a change of the OD-SIB1 and acquire the updated (relevant information elements) or flag them for (re) acquisition in association with a subsequent cell selection and/or reselection of the first NES cell. Accordingly, the UE may omit and or refrain from tuning to the non-NES cell (which may be operating in a different frequency range than a NES cell on which the UE is camped) to check the validity of a (locally) stored SIB1 during a cell reselection associated with the first NES cell.

However, if a UE is camped at a cell that is not in the first set of NES cells, it may not receive the cross-cell change indication and the UE may tune to the first non-NES cell (which may be operating in a different frequency range than a cell on which the UE is camped) to check the validity of a (locally) stored SIB1 during a cell reselection associated with the first NES cell. Similarly, in the absence of the cross-cell change indication, a UE camped on any cell except the first non-NES cell would tune to the first non-NES cell to check the validity of stored SIB1 in association with a selection and/or reselection involving the first NES cell. However, when using the cross-cell change indication, a UE camped on a NES cell in the first set of NES cells may omit and/or refrain from tuning to the first non-NES cell in association with a selection and/or reselection involving the first NES cell when it has not received a cross-cell change indication since a last acquisition of the SIB1. In some aspects, the last acquisition of the SIB1 may have been triggered by a cross-cell change indication that was received prior to the selection and/or reselection involving the first NES cell. By acquiring the SIB1 before the cell selection and/or reselection a latency may be reduced when compared to a cell selection and/or reselection in the absence of the cross-cell change indication. The call flow diagrams below provide examples illustrating aspects of the disclosure discussed above.

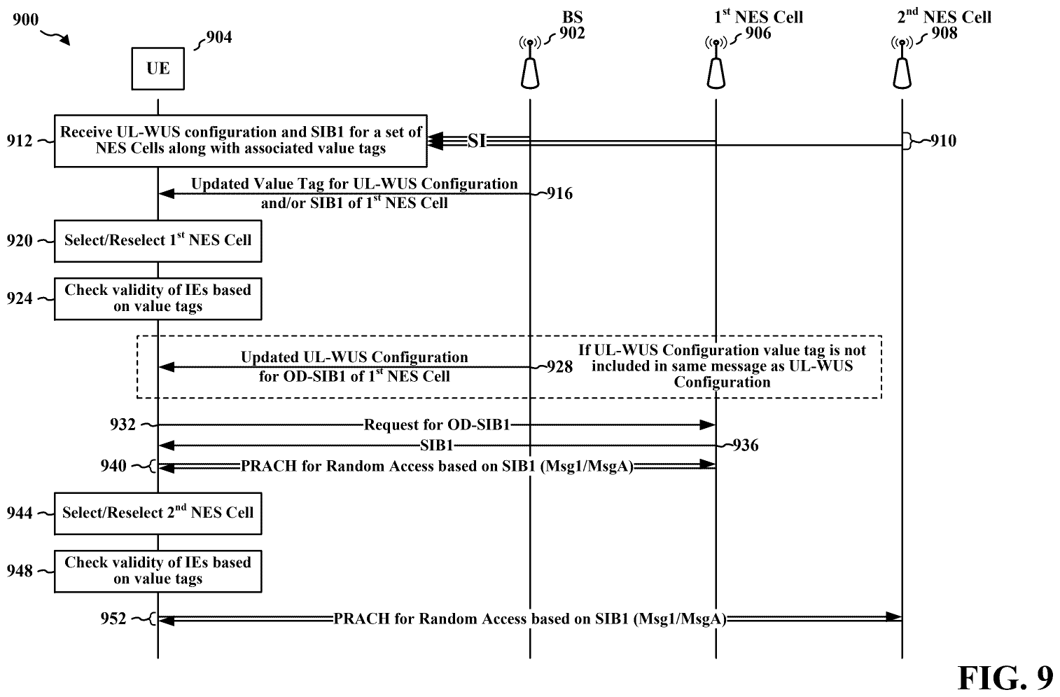

FIG. 9 is a call flow diagram 900 illustrating a method of wireless communication associated with value tags in accordance with some aspects of the disclosure. The method is illustrated in relation to a base station 902, a first NES cell 906, and a second NES cell 908 (e.g., as examples of network devices or network nodes that may include one or more components of a disaggregated base station) in communication with a UE 904 (e.g., as an example of a wireless device). The functions ascribed to the base station 902, the first NES cell 906, and the second NES cell 908, in some aspects, may be performed by one or more components of a network entity, a network node, or a network device (a single network entity/node/device or a disaggregated network entity/node/device as described above in relation to FIG. 1). Similarly, the functions ascribed to the UE 904, in some aspects, may be performed by one or more components of a wireless device supporting communication with a network entity/node/device. Accordingly, references to “transmitting” in the description below may be understood to refer to a first component of the base station 902, the first NES cell 906, or the second NES cell 908 (or the UE 904) outputting (or providing) an indication of the content of the transmission to be transmitted by a different component of the base station 902, the first NES cell 906, or the second NES cell 908 (or the UE 904). Similarly, references to “receiving” in the description below may be understood to refer to a first component of the base station 902, the first NES cell 906, or the second NES cell 908 (or the UE 904) receiving a transmitted signal and outputting (or providing) the received signal (or information based on the received signal) to a different component of the base station 902, the first NES cell 906, or the second NES cell 908 (or the UE 904).

The base station 902, the first NES cell 906, and/or the second NES cell 908 (along with other NES cells associated with the base station 902), in some aspects, may, over time, transmit SI 910 that may be received by the UE 904 at 912. The SI 910, in some aspects, may include a configuration for an OD-SIB1 for the NES cells (e.g., an UL-WUS configuration or UL-WUS configuration information associated with a PRACH request transmitted to acquire SIB1 in the absence of a periodic transmission of the SIB1 from a NES cell), and/or different SIBs including SIB1 (e.g., the OD-SIB1) from the NES cells and/or the base station 902. The SI 910, in some aspects, may include value tags associated with at least the UL-WUS configuration and the SIB1 associated with the NES cells and/or the base station 902. As discussed above, the value tags may be included in a same message as, or a different message than, a corresponding information element. The SI may include information regarding an association between different cells (e.g., that the base station 902 transmits SI for, or related to, the second NES cell 908). In some aspects, the SI may include an indication of a carrier frequency or PCI associated with one or more of the base station 902, the first NES cell 906, or the second NES cell 908.

The base station 902, in some aspects, may transmit the UL-WUS configuration via known resources, e.g., periodically via a first carrier frequency or set of frequency resources, while the NES cells (e.g., the first NES cell 906 and the second NES cell 908) may transmit their SIB1 upon receiving a request from a UE attempting to establish a connection (e.g., attempting to camp on the NES cell) or upon a change to the SIB1. In some aspects, the base station 902 may transmit, and the UE 904 may receive a set of updated value tags 916 for the UL-WUS configuration and/or SIB1 for the first NES cell 906. The set of updated value tags 916, in some aspects, may be current value tags that have not been updated since a last update to a set of associated information elements. In some aspects, the base station 902 transmits value tags (e.g., the value tag associated with the SIB1 of the first NES cell) even if the related information element is transmitted by an associated NES cell (e.g., even if the first NES cell 906 transmits the SIB1).

At 920, the UE 904 may select the first NES cell 906 to camp on while it is currently camped on a different cell such as the base station 902 or the second NES cell 908. Before it sends a PRACH request for the SIB1 (e.g., an OD-SIB1) from the first NES cell 906, the UE 904 may, at 924, check the validity of information elements related to the first NES cell 906 (e.g., a UL-WUS configuration for requesting SIB1 from the first NES cell 906 and/or SIB1 received from the first NES cell 906) and stored at the UE 904. The validity check, in some aspects, may be based on one or more value tags (e.g., the set of updated value tags 916). In some aspects, the validity check may include comparing a set of value tags associated with stored information elements to current value tags (e.g., the set of updated value tags 916) to determine if they are the same (e.g., if they match) and are still valid, or if they are different and the stored information element(s) is invalid. If the UE determines that the information element associated with the UL-WUS configuration is not valid (e.g., is not a latest and/or current information element associated with the UL-WUS configuration), the UE 904 may wait for the base station 902 to transmit, and for the UE 904 to receive, an updated UL-WUS configuration 928. In some aspects including value tags in a same message as the associated information element, the UE 904 may receive the UL-WUS configuration along with the set of updated value tags 916 if the value tag for the UL-WUS configuration is updated and the updated UL-WUS configuration 928 may not be transmitted (or may be considered to have been transmitted along with the set of updated value tags 916).

After determining that it has a valid UL-WUS configuration (whether stored or acquired in association with receiving the updated UL-WUS configuration 928), the UE 904 may transmit, and the first NES cell 906 may receive, a request for the OD-SIB1 932 (e.g., a PRACH message based on the UL-WUS configuration). In response to the request for the OD-SIB1 932, the first NES cell 906 may transmit, and the UE 904 may receive, SIB1 936. Based on the SIB1, the UE 904 may initiate an initial access (or RACH) procedure 940 by sending a PRACH message based on the SIB1 936 (e.g., a Msg1 or MsgA that is a first message in a RACH procedure). The UE 904, at 944, may select and/or reselect the second NES cell 908 to camp on while still camped on the first NES cell 906. At 948, the UE 904 may check the validity of information elements associated with the second NES cell 908 and determine that they are still valid and skip a transmission of a PRACH request for SIB1 from the second NES cell 908 and proceed directly to initiating the initial access (or RACH) procedure 952.

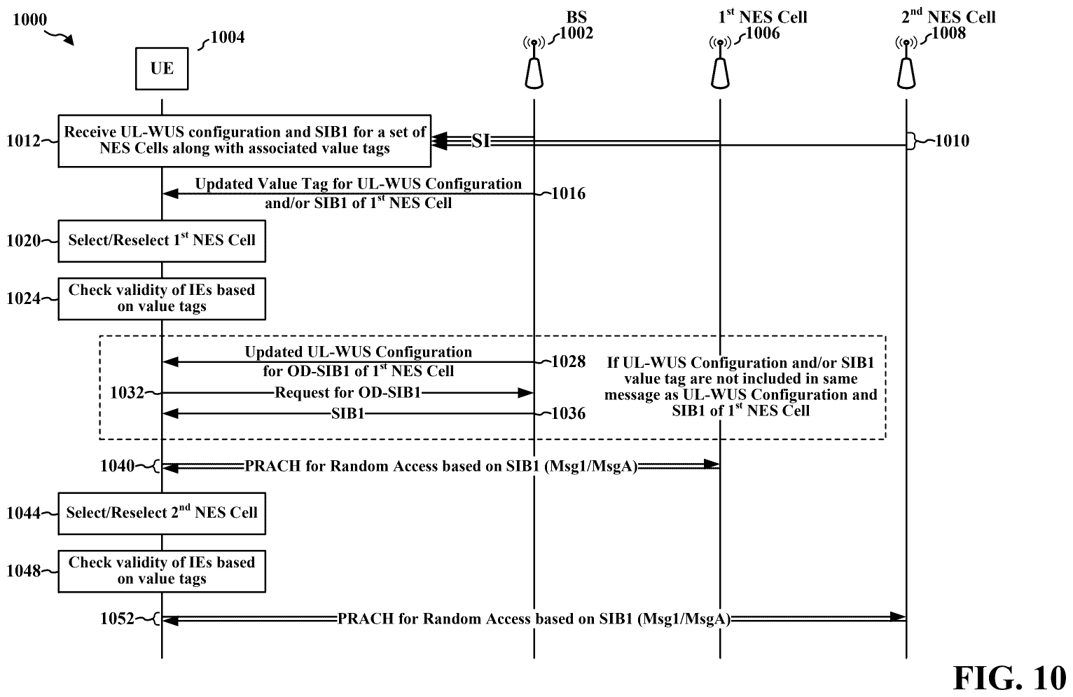

FIG. 10 is a call flow diagram 1000 illustrating a method of wireless communication associated with value tags in accordance with some aspects of the disclosure. The method is illustrated in relation to a base station 1002, a first NES cell 1006, and a second NES cell 1008 (e.g., as examples of network devices or network nodes that may include one or more components of a disaggregated base station) in communication with a UE 1004 (e.g., as an example of a wireless device). The functions ascribed to the base station 1002, the first NES cell 1006, and the second NES cell 1008, in some aspects, may be performed by one or more components of a network entity, a network node, or a network device (a single network entity/node/device or a disaggregated network entity/node/device as described above in relation to FIG. 1). Similarly, the functions ascribed to the UE 1004, in some aspects, may be performed by one or more components of a wireless device supporting communication with a network entity/node/device. Accordingly, references to “transmitting” in the description below may be understood to refer to a first component of the base station 1002, the first NES cell 1006, or the second NES cell 1008 (or the UE 1004) outputting (or providing) an indication of the content of the transmission to be transmitted by a different component of the base station 1002, the first NES cell 1006, or the second NES cell 1008 (or the UE 1004). Similarly, references to “receiving” in the description below may be understood to refer to a first component of the base station 1002, the first NES cell 1006, or the second NES cell 1008 (or the UE 1004) receiving a transmitted signal and outputting (or providing) the received signal (or information based on the received signal) to a different component of the base station 1002, the first NES cell 1006, or the second NES cell 1008 (or the UE 1004).

The base station 1002, the first NES cell 1006, and/or the second NES cell 1008 (along with other NES cells associated with the base station 1002), in some aspects, may over time transmit SI 1010 that may be received by the UE 1004 at 1012. The SI 1010, in some aspects, may include a configuration for an OD-SIB1 for the NES cells (e.g., an UL-WUS configuration or UL-WUS configuration information associated with a PRACH request transmitted to acquire SIB1 in the absence of a periodic transmission of the SIB1 from a NES cell) and/or different SIBs including SIB1 from the base station 1002. The SI 1010, in some aspects, may include value tags associated with at least the UL-WUS configuration and the SIB1 associated with the NES cells and/or the base station 1002. As discussed above, the value tags may be included in a same message as, or a different message than, a corresponding information element. The SI may include information regarding an association between different cells (e.g., that the base station 1002 transmits SI for, or related to, the second NES cell 1008). In some aspects, the SI may include an indication of a carrier frequency or PCI associated with one or more of the base station 1002, the first NES cell 1006, or the second NES cell 1008.

The base station 1002, in some aspects, may transmit the UL-WUS configuration via known resources, e.g., periodically via a first carrier frequency or set of frequency resources, and may transmit SIB1 for an associated set of NES cells (e.g., including the first NES cell 1006 and the second NES cell 1008) on an on-demand basis (e.g., upon receiving a request from a UE attempting to establish a connection with, or attempting to camp on, an NES cell) or upon a change to the SIB1. In some aspects, the base station 1002 may transmit, and the UE 1004 may receive a set of updated value tags 1016 for the UL-WUS configuration and/or SIB1 for the first NES cell 1006. The set of updated value tags 1016, in some aspects, may be current value tags that have not been updated since a last update to a set of associated information elements.

At 1020, the UE 1004 may select the first NES cell 1006 to camp on while it is currently camped on a different cell such as the base station 1002 or the second NES cell 1008. Before it sends a PRACH request for the SIB1 (e.g., an OD-SIB1) from the base station 1002, the UE 1004 may, at 1024, check the validity of information elements related to the first NES cell 1006 (e.g., a UL-WUS configuration for requesting SIB1 from the base station 1002 and/or SIB1 for the first NES cell 1006 received from the base station 1002) and stored at the UE 1004. The validity check, in some aspects, may be based on one or more value tags (e.g., the set of updated value tags 1016). In some aspects, the validity check may include comparing a set of value tags associated with stored information elements to current value tags (e.g., the set of updated value tags 1016) to determine if they are the same (e.g., if they match) and are still valid, or if they are different and the stored information element(s) is invalid. In some aspects, the value tags used to determine validity are value tags received within a current modification period and, if no value tags have been received in the current modification period, the UE may be unable to determine a validity of stored information elements. If the UE determines that the information element associated with the UL-WUS configuration is not valid (e.g., is not a latest and/or current information element associated with the UL-WUS configuration), the UE 1004 may wait for the base station 1002 to transmit, and the UE 1004 to receive, an updated UL-WUS configuration 1028. In some aspects including value tags in a same message as the associated information element, the UE 1004 may receive the UL-WUS configuration along with the set of updated value tags 1016 if the value tag for the UL-WUS configuration is updated and the updated UL-WUS configuration 1028 may not be transmitted (or may be considered to have been transmitted along with the set of updated value tags 1016).

After determining that it has a valid UL-WUS configuration (whether stored or acquired in association with receiving the updated UL-WUS configuration 1028), the UE 1004 may transmit, and the base station 1002 may receive, a request for the OD-SIB1 1032 (e.g., a PRACH message based on the UL-WUS configuration). In response to the request for the OD-SIB1 1032, the base station 1002 may transmit, and the UE 1004 may receive, SIB1 1036. Based on the SIB1, the UE 1004 may initiate an initial access (or RACH) procedure 1040 by sending a PRACH message based on the SIB1 1036 (e.g., a Msg1 or MsgA that is a first message in a RACH procedure). The UE 1004, at 1044, may select and/or reselect the second NES cell 1008 to camp on while still camped on the first NES cell 1006. At 1048, the UE 1004 may check the validity of information elements associated with the second NES cell 1008 and determine that they are still valid and skip a transmission of a PRACH request for SIB1 from the base station 1002 and proceed directly to initiating the initial access (or RACH) procedure 1052. As indicated in the description of FIG. 10, if no value tag is received within a current modification period, the UE may not be able to validate stored information elements, accordingly, some aspects introduce a cross-cell change indication.

In some aspects of wireless communication, a system information transmitted by a first cell may carry information for the first cell, but not for other cells. However, for some aspects of wireless communication supporting OD-SIB1, a system information transmitted by a first cell may carry information for another cell. For example, referring to FIG. 8A, e.g., a base station 802A may carry (or transmit a SIBx carrying) UL-WUS configuration and/or SIB1(s) for one or more NES cells (e.g., one or more of the NES cell 822, the NES cell 832, the NES cell 842, the NES cell 852, the NES cell 862, and the NES cell 872) or the base station 802A may carry (or transmit SIBx carrying) value tag(s) for the UL-WUS configuration and/or SIB1(s) for the one or more NES cells. In some aspects, a NES cell (e.g., the NES cell 822) may also carry (or transmit a SIBx carrying) SI for another NES cell (e.g., the NES cell 832). The SIBx will be known by a receiving UE to be related to a particular cell (or set of cells) where the particular cell may be (or the set of cells may include) a NES cell and/or a non-NES cells. In some aspects, a set of cells (e.g., including one or more neighboring NES cells and/or non-NES cells) may transmit, or be capable of transmitting, SI for a particular cell. For example, referring to FIG. 8B, the second set of neighbor NES cells may include the NES cell 832, the NES cell 842, and the NES cell 862 that may transmit SI for the NES cell 872.

Upon change of a system information (e.g., in a SIBx transmitted by a first cell but carrying information for a second cell), an associated value tag carried in SIB1 transmitted by, and related to, the first cell may also be changed. If the first cell is a non-NES cell, the first cell may transmit SIB1 (with the updated value tag for the SIBx carrying the information for the second cell) periodically and the behavior does not need to change. If the first cell is a NES cell (e.g., a cell supporting OD-SIB1), the first cell may not generally transmit a SIB1 periodically, but, based on, the change to the system information, the first (NES) cell maybe expected to transmit the updated SIB1 (with the updated value tag for the SIBx) and the updated SIBx starting from a next modification period after the SI change indication for at least one modification period. In some aspects, if a UE receives a SI change indication or a cross-cell change indication for SI transmitted by a first cell, the UE may retrieve at least the SIB1 of the first cell associated with the change indication to determine whether other SIBs have changed and when it will acquire the updated SI (either immediately or based on a selection and/or reselection of a related cell to camp on). In some aspects, the determination as to when to acquire the updated SI may be based on whether the updated SI transmitted by the first cell is related to an OD-SIB1 for a second NES cell and whether the second NES cell is configured to transmit the updated SI in a next modification period without a request e.g., based on (or triggered by) the change to the SI. If the UE determines to acquire the updated SI upon a selection and/or reselection, the UE may update a flag indicating to acquire the updated SI. In some aspects, the UE may be configured to retrieve SI for the cells associated with a SI change indication and/or a cross-cell change indication upon receiving the SI change indication and/or a cross-cell change indication. The UE may be configured to refrain from acquiring the SI associated with the SI change indication and/or a cross-cell change indication and update the flag indicating for the UE to acquire the SI upon reselection to one of the cells associated with the SI change indication and/or the cross-cell change indication.

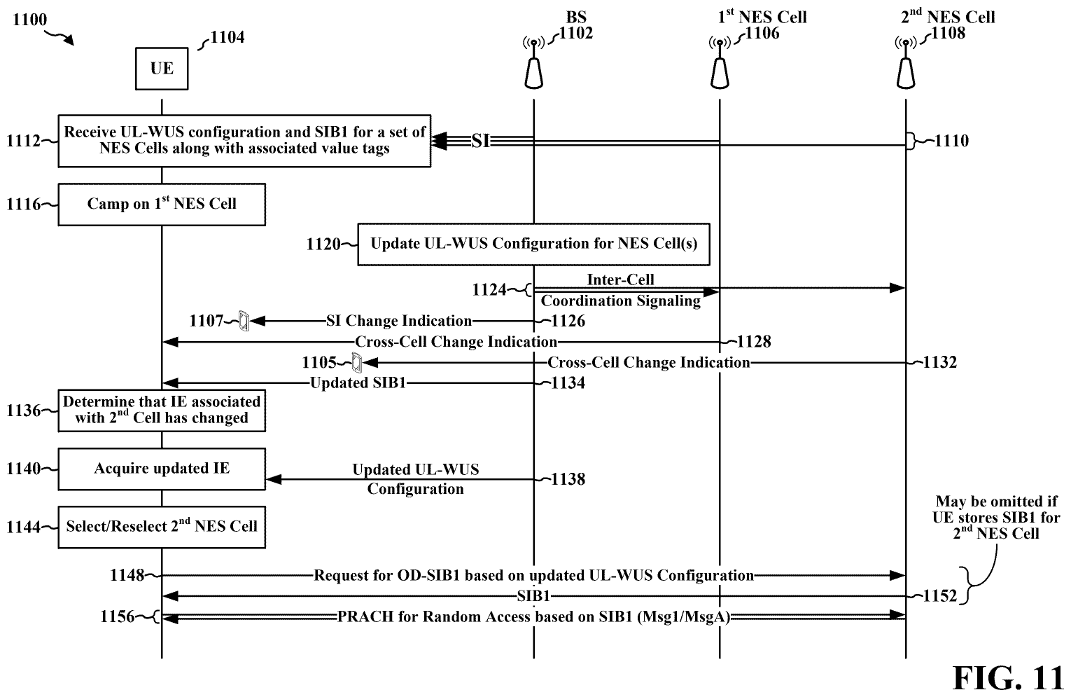

FIG. 11 is a call flow diagram 1100 illustrating a method of wireless communication associated with cross-cell change indications in accordance with some aspects of the disclosure. The method is illustrated in relation to a base station 1102, a first NES cell 1106, and a second NES cell 1108 (e.g., as examples of network devices or network nodes that may include one or more components of a disaggregated base station) in communication with a UE 1104 (e.g., as an example of a wireless device). The functions ascribed to the base station 1102, the first NES cell 1106, and the second NES cell 1108, in some aspects, may be performed by one or more components of a network entity, a network node, or a network device (a single network entity/node/device or a disaggregated network entity/node/device as described above in relation to FIG. 1). Similarly, the functions ascribed to the UE 1104, in some aspects, may be performed by one or more components of a wireless device supporting communication with a network entity/node/device. Accordingly, references to “transmitting” in the description below may be understood to refer to a first component of the base station 1102, the first NES cell 1106, or the second NES cell 1108 (or the UE 1104) outputting (or providing) an indication of the content of the transmission to be transmitted by a different component of the base station 1102, the first NES cell 1106, or the second NES cell 1108 (or the UE 1104). Similarly, references to “receiving” in the description below may be understood to refer to a first component of the base station 1102, the first NES cell 1106, or the second NES cell 1108 (or the UE 1104) receiving a transmitted signal and outputting (or providing) the received signal (or information based on the received signal) to a different component of the base station 1102, the first NES cell 1106, or the second NES cell 1108 (or the UE 1104).

The base station 1102, the first NES cell 1106, and/or the second NES cell 1108 (along with other NES cells associated with the base station 1102), in some aspects, may over time transmit SI 1110 that may be received by the UE 1104 at 1112. The SI 1110, in some aspects, may include a configuration for an OD-SIB1 for the NES cells (e.g., an UL-WUS configuration or UL-WUS configuration information associated with a PRACH request transmitted to acquire SIB1 in the absence of a periodic transmission of the SIB1 from a NES cell) and/or different SIBs including SIB1 from the NES cells and/or the base station 1102. The SI 1110, in some aspects, may include value tags associated with at least the UL-WUS configuration and the SIB1 associated with the NES cells and/or the base station 1102. As discussed above, the value tags may be included in a same message as, or a different message than, a corresponding information element. The SI may include information regarding an association between different cells (e.g., that the base station 1102 transmits SI for, or related to, the second NES cell 1108). In some aspects, the SI may include an indication of a carrier frequency or PCI associated with one or more of the base station 1102, the first NES cell 1106, or the second NES cell 1108.

The base station 1102, in some aspects, may transmit the UL-WUS configuration via known resources, e.g., periodically via a first carrier frequency or set of frequency resources, while the NES cells (e.g., the first NES cell 1106 and the second NES cell 1108) may transmit their SIB1 upon receiving a request from a UE attempting to establish a connection (e.g., attempting to camp on the NES cell) or upon a change to the SIB1. At 1116, the UE 1104 may camp on the first NES cell 1106. At 1120, the base station 1102 may determine to update an UL-WUS configuration for at least the second NES cell 1108 during a next modification period. The base station 1102, may, based on the determination made at 1120, transmit a set of inter-cell coordination signaling messages 1124 to a set of associated NES cells (and, in some aspects, other non-NES cells not shown) including the first NES cell 1106 on which the UE 1104 is camped and the second NES cell 1108. As well as transmitting the set of inter-cell coordination signaling messages 1124, in some aspects, the base station 1102 may transmit, and one or more UEs (e.g., including the UE 1107) camped on the base station 1102 may receive, a SI change indication 1126 indicating a change to an UL-WUS configuration for the OD-SIB1 for the second NES cell 1108. Based on the set of inter-cell coordination signaling messages 1124, the first NES cell 1106 may transmit, and the UE 1104 may receive (along with other UEs camped on the first NES cell 1106), cross-cell change indication 1128 indicating that system information associated with the base station 1102 and/or the second NES cell 1108 has changed. In some aspects, the cross-cell change indication 1128 may be transmitted when the change is indicated to relate to the OD-SIB1 (e.g., either the UL-WUS configuration or a SIB1 associated with a NES cell), while in other aspects, the cross-cell change indication 1128 may be transmitted for any SI change even if it may not affect the OD-SIB1. In some aspect, a cross-cell change indication may indicate an associated cell other than, or in addition to, the cell from which it was received.

The cross-cell change indication 1128 may be carried by a short message, which may reuse an existing SI change indication or may use a new indication (or indication format). In some aspects, the cross-cell change indication 1128 may indicate one or more target and/or associated cells. The one or more target and/or associated cells may include cells other than the first NES cell 1106 for which the first NES cell 1106 had previously transmitted information, e.g., in a SIBx, such as a carrier frequency (e.g., a carrierFreq) and physical layer cell ID (PCI). Based on (1) the identification of the one or more target or associated cells and (2) the SIB including information for the one or more target or associated cells transmitted by the first NES cell 1106, the UE 1104 may use the known information, (e.g., the carrierFreq and/or the PCI) to acquire, camp on, or retrieve information (e.g., value tags, or an SIB1) from, the one or more target and/or associated cells. In some aspects, the information, (e.g., the carrierFreq and/or the PCI) may be carried by a cross-cell change indication in the short message via PDCCH paging channel but may be limited by the smaller payload size of the short message. The second NES cell 1108 may similarly transmit, and a UE 1105 camped on the second NES cell 1108 may receive (along with other UEs camped on the second NES cell 1108), cross-cell change indication 1132 indicating that system information associated with the base station 1102 has changed.

At 1136, the UE 1104 may determine that an information element related to the second NES cell 1108 (and more specifically, an information element relating to an OD-SIB1 of the second NES cell 1108) has changed. In some aspects transmitting cross-cell change indications for information elements affecting the OD-SIB1 but not for other SI and/or information elements, the determination may be based on receiving the cross-cell change indication. If a cross-cell change indication may be transmitted based on changes to SI and/or information elements, the determination at 1136 may include a validity check as discussed above in relation to at least FIGS. 9 and 10 and where the receipt and/or acquisition of value tags are not shown in FIG. 11 as they may occur as described in relation to FIGS. 9 and 10.

In some aspects, determining that an information element related to the second NES cell 1108 (and more specifically, an information element relating to an OD-SIB1 of the second NES cell 1108) has changed at 1136, may include acquiring an updated SIB1 1134 transmitted by the base station 1102 and received at the UE 1104 including value tags for other SI transmitted by the base station 1102 at the next modification period after the SI change indication, where the SIB1 from the base station 1102 may be transmitted periodically. The other SI transmitted by the base station 1102, in some aspects, may include information regarding at least the second NES cell 1108 (e.g., value tags for the OD-SIB1 or the UL-WUS configuration).

Based on the determination at 1136 that the information element related to the second NES cell 1108 has changed (e.g., that the UL-WUS configuration for requesting OD-SIB1 from the second NES cell 1108 has changed), the UE 1104 may acquire, at 1140, an updated UL-WUS configuration 1138 by receiving it from the base station 1102. The UE 1104, at 1144, may select and/or reselect the second NES cell 1108 to camp on while still camped on the first NES cell 1106. In some aspects, the UE 1104 may skip checking the validity of the UL-WUS configuration as it already updated (e.g., at 1140) the UL-WUS configuration based on the cross-cell change indication 1128 and the related determination at 1136. If the UE 1104 did not have valid SIB1 for the second NES cell 1108 (e.g., based on a validity check as described above or based on not having stored SIB1 for the second NES cell 1108), the UE 1104 may transmit, and the second NES cell 1108, may receive, the request 1148 for the OD-SIB1 based on the updated UL-WUS configuration 1138. In response to the request 1148, the second NES cell 1108 may transmit, and the UE 1104 may receive, SIB1 1152. In some aspects, the UE 1104 may determine that it stores valid SIB1 for the second NES cell 1108 and may skip a transmission of a PRACH request for SIB1 from the second NES cell 1108 and proceed directly to initiating the initial access (or RACH) procedure 1156.

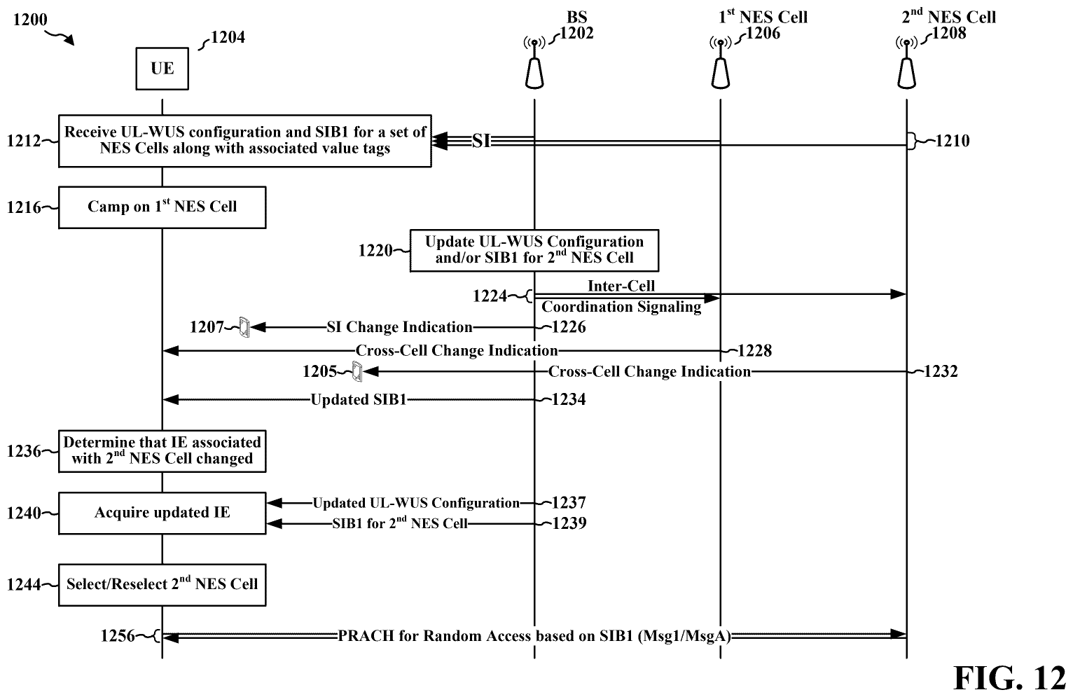

FIG. 12 is a call flow diagram 1200 illustrating a method of wireless communication associated with cross-cell change indications in accordance with some aspects of the disclosure. The method is illustrated in relation to a base station 1202, a first NES cell 1206, and a second NES cell 1208 (e.g., as examples of network devices or network nodes that may include one or more components of a disaggregated base station) in communication with a UE 1204 (e.g., as an example of a wireless device). The functions ascribed to the base station 1202, the first NES cell 1206, and the second NES cell 1208, in some aspects, may be performed by one or more components of a network entity, a network node, or a network device (a single network entity/node/device or a disaggregated network entity/node/device as described above in relation to FIG. 1). Similarly, the functions ascribed to the UE 1204, in some aspects, may be performed by one or more components of a wireless device supporting communication with a network entity/node/device. Accordingly, references to “transmitting” in the description below may be understood to refer to a first component of the base station 1202, the first NES cell 1206, or the second NES cell 1208 (or the UE 1204) outputting (or providing) an indication of the content of the transmission to be transmitted by a different component of the base station 1202, the first NES cell 1206, or the second NES cell 1208 (or the UE 1204). Similarly, references to “receiving” in the description below may be understood to refer to a first component of the base station 1202, the first NES cell 1206, or the second NES cell 1208 (or the UE 1204) receiving a transmitted signal and outputting (or providing) the received signal (or information based on the received signal) to a different component of the base station 1202, the first NES cell 1206, or the second NES cell 1208 (or the UE 1204).

The base station 1202, the first NES cell 1206, and/or the second NES cell 1208 (along with other NES cells associated with the base station 1202), in some aspects, may over time transmit SI 1210 that may be received by the UE 1204 at 1212. The SI 1210, in some aspects, may include a configuration for an OD-SIB1 for the NES cells (e.g., an UL-WUS configuration or UL-WUS configuration information associated with a PRACH request transmitted to acquire SIB1 in the absence of a periodic transmission of the SIB1 from a NES cell) and/or different SIBs including SIB1 from the NES cells and/or the base station 1202. The SI 1210, in some aspects, may include value tags associated with at least the UL-WUS configuration and the SIB1 associated with the NES cells and/or the base station 1202. As discussed above, the value tags may be included in a same message as, or a different message than, a corresponding information element. The SI may include information regarding an association between different cells (e.g., that the base station 1202 transmits SI for, or related to, the second NES cell 1208). In some aspects, the SI may include an indication of a carrier frequency or PCI associated with one or more of the base station 1202, the first NES cell 1206, or the second NES cell 1208.

The base station 1202, in some aspects, may transmit the UL-WUS configuration via known resources, e.g., periodically via a first carrier frequency or set of frequency resources, and may transmit SIB1 for an associated set of NES cells (e.g., including the first NES cell 1206 and the second NES cell 1208) on an on-demand basis (e.g., upon receiving a request from a UE attempting to establish a connection with, or attempting to camp on, an NES cell) or upon a change to the SIB1. At 1216, the UE 1204 may camp on the first NES cell 1206. At 1220, the base station 1202 may determine to update an UL-WUS configuration and/or a SIB1 for at least the second NES cell 1208 during a next modification period. The base station 1202, may, based on the determination made at 1220, transmit a set of inter-cell coordination signaling messages 1224 to a set of associated NES cells (and, in some aspects, other non-NES cells not shown) including the first NES cell 1206 on which the UE 1204 is camped and the second NES cell 1208. As well as transmitting the set of inter-cell coordination signaling messages 1224, in some aspects, the base station 1202 may transmit, and one or more UEs (e.g., including the UE 1207) camped on the base station 1202 may receive, a SI change indication 1226 indicating a change to an OD-SIB1 for the second NES cell 1208. Based on the set of inter-cell coordination signaling messages 1224, the first NES cell 1206 may transmit, and the UE 1204 may receive (along with other UEs camped on the first NES cell 1206), cross-cell change indication 1228 indicating that system information associated with the base station 1202 has changed. In some aspects, the cross-cell change indication 1228 may be transmitted when the change is indicated to relate to the OD-SIB1 (e.g., either the UL-WUS configuration or a SIB1 associated with a NES cell), while in other aspects, the cross-cell change indication 1228 may be transmitted for any SI change even if it may not affect the OD-SIB1. The second NES cell 1208 may similarly transmit, and a UE 1205 camped on the second NES cell 1208 may receive (along with other UEs camped on the second NES cell 1208), cross-cell change indication 1232 indicating that system information associated with the base station 1202 has changed.

At 1236, the UE 1204 may determine that an information element related to the second NES cell 1208 (and more specifically, an information element relating to an OD-SIB1 of the second NES cell 1208) has changed. In some aspects transmitting cross-cell change indications for information elements affecting the OD-SIB1 but not for other SI and/or information elements, the determination may be based on receiving the cross-cell change indication. If a cross-cell change indication may be transmitted based on changes to SI and/or information elements, the determination at 1236 may include a validity check as discussed above in relation to at least FIGS. 9 and 10 and where the receipt and/or acquisition of value tags are not shown in FIG. 12 as they may occur as described in relation to FIGS. 9 and 10.

In some aspects, determining that an information element related to the second NES cell 1208 (and more specifically, an information element relating to an OD-SIB1 of the second NES cell 1208) has changed at 1236, may include acquiring an updated SIB1 1234 transmitted by the base station 1202 and received at the UE 1204 including value tags for other SI transmitted by the base station 1202 at the next modification period after the SI change indication, where the SIB1 from the base station 1202 may be transmitted periodically. The other SI transmitted by the base station 1202, in some aspects, may include information regarding at least the second NES cell 1208 (e.g., value tags for the OD-SIB1 or the UL-WUS configuration).

Based on the determination at 1236 that the information element related to the second NES cell 1208 has changed (e.g., that one of the UL-WUS configuration for requesting OD-SIB1 from, or the SIB1 for, the second NES cell 1208 has changed), the UE 1204 may acquire, at 1240, an updated UL-WUS configuration 1237 and/or updated SIB1 1239 for the second NES cell 1208 by receiving it from the base station 1202. The base station 1202, in some aspects, may transmit the updated UL-WUS configuration 1237 and/or the updated SIB1 1239 for the second NES cell 1208 during a next modification period after transmitting the set of inter-cell coordination signaling messages 1224. The UE 1204, at 1244, may select and/or reselect the second NES cell 1208 to camp on while still camped on the first NES cell 1206. In some aspects, a request for OD-SIB1 may be omitted based on the transmission of the updated SIB1 1239 for the second NES cell 1208, during one or more modification periods after the change to the SIB1 and triggered by the change to the SIB1 of the second NES cell 1208. The UE 1204 may skip checking the validity of the UL-WUS configuration and/or the SIB1 as it already (e.g., at 1240) updated, or acquired updated SI for, the updated UL-WUS configuration 1237 and/or the updated SIB1 1239 based on the cross-cell change indication 1228 and the related determination at 1236. In some aspects, the UE 1204 may determine that it stores valid SIB1 for the second NES cell 1208 and may skip a transmission of a PRACH request for SIB1 from the second NES cell 1208 and proceed directly to initiating the initial access (or RACH) procedure 1256.

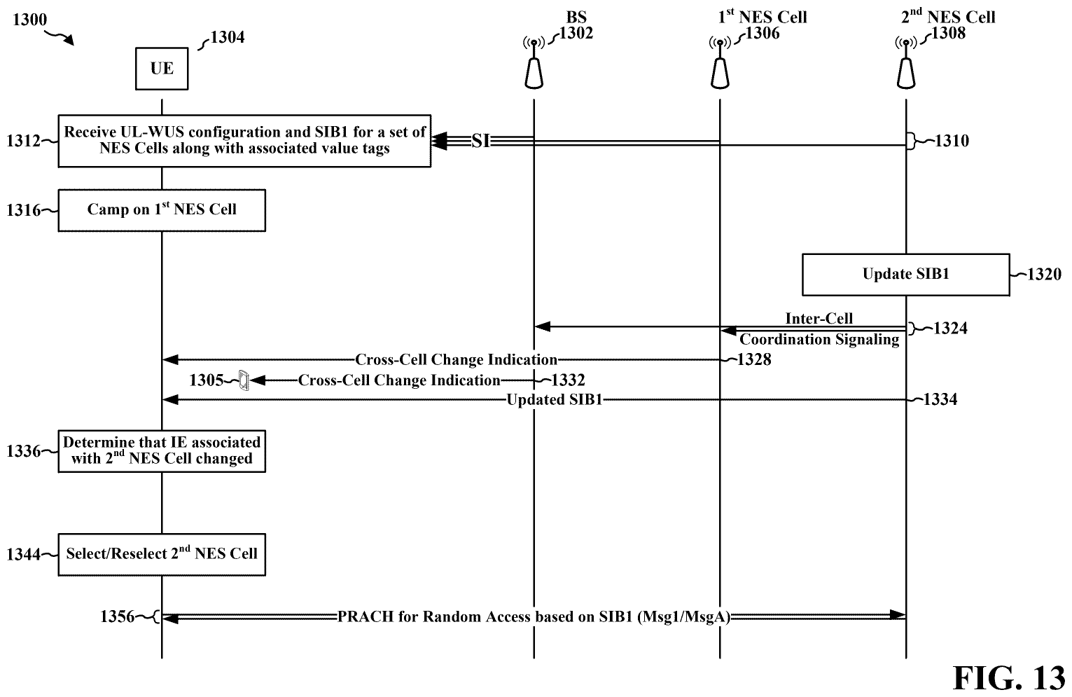

FIG. 13 is a call flow diagram 1300 illustrating a method of wireless communication associated with cross-cell change indications in accordance with some aspects of the disclosure. The method is illustrated in relation to a base station 1302, a first NES cell 1306, and a second NES cell 1308 (e.g., as examples of network devices or network nodes that may include one or more components of a disaggregated base station) in communication with a UE 1304 (e.g., as an example of a wireless device). The functions ascribed to the base station 1302, the first NES cell 1306, and the second NES cell 1308, in some aspects, may be performed by one or more components of a network entity, a network node, or a network device (a single network entity/node/device or a disaggregated network entity/node/device as described above in relation to FIG. 1). Similarly, the functions ascribed to the UE 1304, in some aspects, may be performed by one or more components of a wireless device supporting communication with a network entity/node/device. Accordingly, references to “transmitting” in the description below may be understood to refer to a first component of the base station 1302, the first NES cell 1306, or the second NES cell 1308 (or the UE 1304) outputting (or providing) an indication of the content of the transmission to be transmitted by a different component of the base station 1302, the first NES cell 1306, or the second NES cell 1308 (or the UE 1304). Similarly, references to “receiving” in the description below may be understood to refer to a first component of the base station 1302, the first NES cell 1306, or the second NES cell 1308 (or the UE 1304) receiving a transmitted signal and outputting (or providing) the received signal (or information based on the received signal) to a different component of the base station 1302, the first NES cell 1306, or the second NES cell 1308 (or the UE 1304).

The base station 1302, the first NES cell 1306, and/or the second NES cell 1308 (along with other NES cells associated with the base station 1302), in some aspects, may over time transmit SI 1310 that may be received by the UE 1304 at 1312. The SI 1310, in some aspects, may include a configuration for an OD-SIB1 for the NES cells (e.g., an UL-WUS configuration or UL-WUS configuration information associated with a PRACH request transmitted to acquire SIB1 in the absence of a periodic transmission of the SIB1 from a NES cell) and/or different SIBs including SIB1 from the NES cells and/or the base station 1302. The SI 1310, in some aspects, may include value tags associated with at least the UL-WUS configuration and the SIB1 associated with the NES cells and/or the base station 1302. As discussed above, the value tags may be included in a same message as, or a different message than, a corresponding information element. The SI may include information regarding an association between different cells (e.g., that the base station 1302 transmits SI for, or related to, the second NES cell 1308). In some aspects, the SI may include an indication of a carrier frequency or PCI associated with one or more of the base station 1302, the first NES cell 1306, or the second NES cell 1308.

The base station 1302, in some aspects, may transmit the UL-WUS configuration via known resources, e.g., periodically via a first carrier frequency or set of frequency resources, while the NES cells (e.g., the first NES cell 1306 and the second NES cell 1308) may transmit their SIB1 upon receiving a request from a UE attempting to establish a connection (e.g., attempting to camp on the NES cell) or upon a change to the SIB1. At 1316, the UE 1304 may camp on the first NES cell 1306. At 1320, the second NES cell 1308 may determine to update SIB1 for the second NES cell 1308 during a next modification period. The second NES cell 1308, may, based on the determination made at 1320, transmit a set of inter-cell coordination signaling messages 1324 to a set of associated cells (including the base station 1302 and the first NES cell 1306 on which the UE 1304 is camped and, in some aspects, other non-NES cells not shown). In turn, the first NES cell 1306 may transmit, and the UE 1304 may receive (along with other UEs camped on the first NES cell 1306), cross-cell change indication 1328 indicating that system information associated with the second NES cell 1308 has changed. In some aspects, the cross-cell change indication 1328 may be transmitted when the change is indicated to relate to the OD-SIB1 (e.g., either the UL-WUS configuration or a SIB1 associated with a NES cell), while in other aspects, the cross-cell change indication 1328 may be transmitted for any SI change even if it may not affect the OD-SIB1. The base station 1302 may similarly transmit, and a UE 1305 camped on the base station 1302 may receive (along with other UEs camped on the base station 1302), cross-cell change indication 1332 indicating that system information associated with the second NES cell 1308 has changed.

In some aspects, the UE may acquire an updated SIB1 1334 transmitted by the second NES cell 1308 (without a PRACH based on the updated SIB1) and received at the UE 1304 including value tags for other SI transmitted by the second NES cell 1308 at the next modification period after the SI change indication, where the SIB1 from the second NES cell 1308 may be transmitted for a configured number of modification periods including at least a first modification period after the indication of a change.

The UE 1304, at 1344, may select and/or reselect the second NES cell 1308 to camp on while still camped on the first NES cell 1306. The UE 1304 may skip checking the validity of the UL-WUS configuration and the SIB1 as it has already received the updated SIB1 1334 based on the cross-cell change indication 1328 and/or the SI change determined at 1320 and may skip a transmission of a PRACH request for SIB1 from the second NES cell 1308 and proceed directly to initiating the initial access (or RACH) procedure 1356.

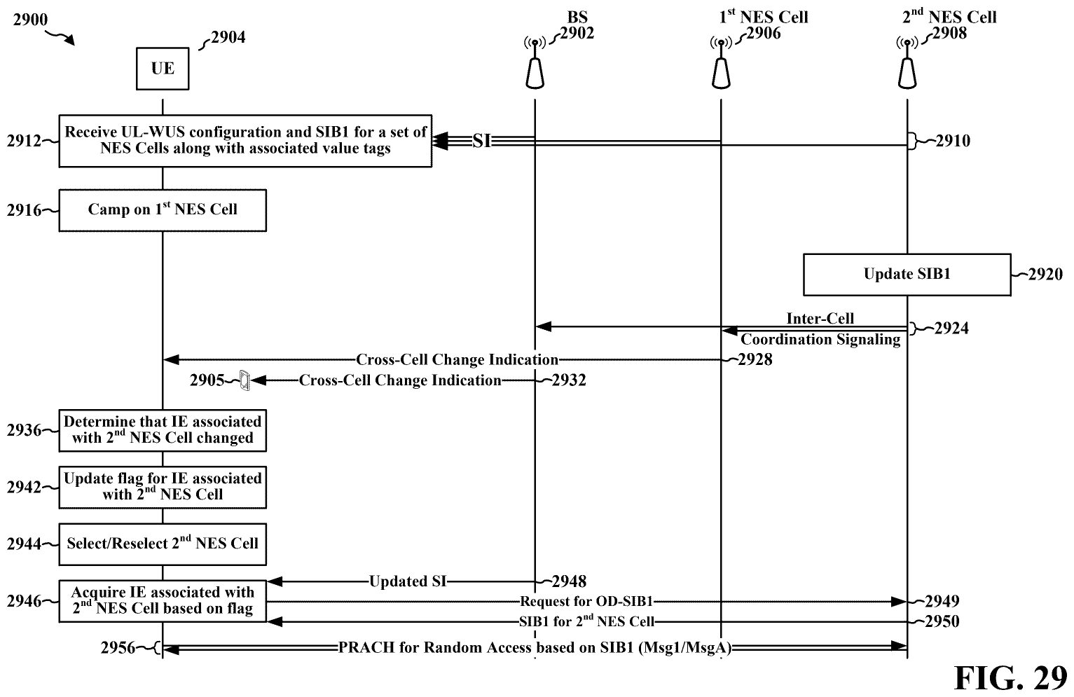

FIG. 29 is a call flow diagram 2900 illustrating a method of wireless communication associated with cross-cell change indications in accordance with some aspects of the disclosure. The method is illustrated in relation to a base station 2902, a first NES cell 2906, and a second NES cell 2908 (e.g., as examples of network devices or network nodes that may include one or more components of a disaggregated base station) in communication with a UE 2904 (e.g., as an example of a wireless device). The functions ascribed to the base station 2902, the first NES cell 2906, and the second NES cell 2908, in some aspects, may be performed by one or more components of a network entity, a network node, or a network device (a single network entity/node/device or a disaggregated network entity/node/device as described above in relation to FIG. 1). Similarly, the functions ascribed to the UE 2904, in some aspects, may be performed by one or more components of a wireless device supporting communication with a network entity/node/device. Accordingly, references to “transmitting” in the description below may be understood to refer to a first component of the base station 2902, the first NES cell 2906, or the second NES cell 2908 (or the UE 2904) outputting (or providing) an indication of the content of the transmission to be transmitted by a different component of the base station 2902, the first NES cell 2906, or the second NES cell 2908 (or the UE 2904). Similarly, references to “receiving” in the description below may be understood to refer to a first component of the base station 2902, the first NES cell 2906, or the second NES cell 2908 (or the UE 2904) receiving a transmitted signal and outputting (or providing) the received signal (or information based on the received signal) to a different component of the base station 2902, the first NES cell 2906, or the second NES cell 2908 (or the UE 2904).

The base station 2902, the first NES cell 2906, and/or the second NES cell 2908 (along with other NES cells associated with the base station 2902), in some aspects, may over time transmit SI 2910 that may be received by the UE 2904 at 2912. The SI 2910, in some aspects, may include a configuration for an OD-SIB1 for the NES cells (e.g., an UL-WUS configuration or UL-WUS configuration information associated with a PRACH request transmitted to acquire SIB1 in the absence of a periodic transmission of the SIB1 from a NES cell) and/or different SIBs including SIB1 from the NES cells and/or the base station 2902. The SI 2910, in some aspects, may include value tags associated with at least the UL-WUS configuration and the SIB1 associated with the NES cells and/or the base station 2902. As discussed above, the value tags may be included in a same message as, or a different message than, a corresponding information element. The SI may include information regarding an association between different cells (e.g., that the base station 2902 transmits SI for, or related to, the second NES cell 2908). In some aspects, the SI may include an indication of a carrier frequency or PCI associated with one or more of the base station 2902, the first NES cell 2906, or the second NES cell 2908.

The base station 2902, in some aspects, may transmit the UL-WUS configuration via known resources, e.g., periodically via a first carrier frequency or set of frequency resources, while the NES cells (e.g., the first NES cell 2906 and the second NES cell 2908) may transmit their SIB1 upon receiving a request from a UE attempting to establish a connection (e.g., attempting to camp on the NES cell) or upon a change to the SIB1. At 2916, the UE 2904 may camp on the first NES cell 2906. At 2920, the second NES cell 2908 may determine to update SIB1 for the second NES cell 2908 during a next modification period. The second NES cell 2908, may, based on the determination made at 2920, transmit a set of inter-cell coordination signaling messages 2924 to a set of associated cells (including the base station 2902 and the first NES cell 2906 on which the UE 2904 is camped and, in some aspects, other non-NES cells not shown). In turn, the first NES cell 2906 may transmit, and the UE 2904 may receive (along with other UEs camped on the first NES cell 2906), cross-cell change indication 2928 indicating that system information associated with the second NES cell 2908 has changed. In some aspects, the cross-cell change indication 2928 may be transmitted when the change is indicated to relate to the OD-SIB1 (e.g., either the UL-WUS configuration or a SIB1 associated with a NES cell), while in other aspects, the cross-cell change indication 2928 may be transmitted for any SI change even if it may not affect the OD-SIB1. The base station 2902 may similarly transmit, and a UE 2905 camped on the base station 2902 may receive (along with other UEs camped on the base station 2902), cross-cell change indication 2932 indicating that system information associated with the second NES cell 2908 has changed.

Based on the cross-cell change indication 2932, the UE 2904 may determine at 2936 that system information (e.g., the OD-SIB1) associated with the second NES cell 2908 has changed. The UE 2904 may, at 2942, update a flag associated with an information element associated with the second NES cell 2908. At 2944, the UE 2904 may select and/or reselect the second NES cell 2908 to camp on, and based on the updated flag, may acquire the information element indicated to be invalid by the updated flag, e.g., as shown at 2946. For example, the UE 2904 may acquire, updated SI 2948 (e.g., an UL-WUS configuration for OD-SIB1 of the second NES cell 2908 transmitted by the base station 2902). The updated SI 2948, in some aspects, may include an updated SIB1 of the base station 2902 transmitted periodically, indicating one or more additional SIBs (e.g., SIBx) including SI (and related information elements) for the second NES cell 2908 where acquiring the updated SI 2948 includes acquiring the indicated one or more additional SIBs including SI for the second NES cell 2908. Based on receiving the cross-cell change indication the UE 2904 may refrain from checking a validity of stored SI (e.g., SIB1) for the second NES cell 2908 as it may be assumed to be invalid. In some aspects, the UE 2904 may use the updated SI 2948 to transmit, to the second NES cell 2908, a request 2949 for an OD-SIB1 for the second NES cell 2908. The UE 2904 may receive, and the second NES cell 2908 may transmit, the SIB1 2950 (e.g., an updated OD-SIB1). Based on the acquired information element(s), e.g., the information element(s) included in the SIB1 2950, the UE 2904 may then proceed to initiating the initial access (or RACH) procedure 2956. In some aspects, FIG. 29 may differ from FIG. 13 in that where the UE 1304 updates a SIB1 for the second NES cell 1308 upon receiving the cross-cell change indication 1328, the UE 2904 may update a flag indicating for the UE to acquire the SIB1 for the second NES cell 2908 upon selecting and/or reselecting the second NES cell 2908 to camp on. In some aspects, the difference may be based on whether the UE (e.g., the UE 1304 or the UE 2904) expects to be within a coverage area of the second NES cell. For example, the UE may update the SIB1 upon receiving the cross-cell change indication if the UE expects to be within the coverage area of the second NES cell (e.g., to be able to receive the SIB1 transmitted by the second NES cell based on the indicated change) and the UE may update the flag if the UE expects to be outside the coverage area of the second NES cell (e.g., to be unable to receive the SIB1 transmitted by the second NES cell based on the indicated change).

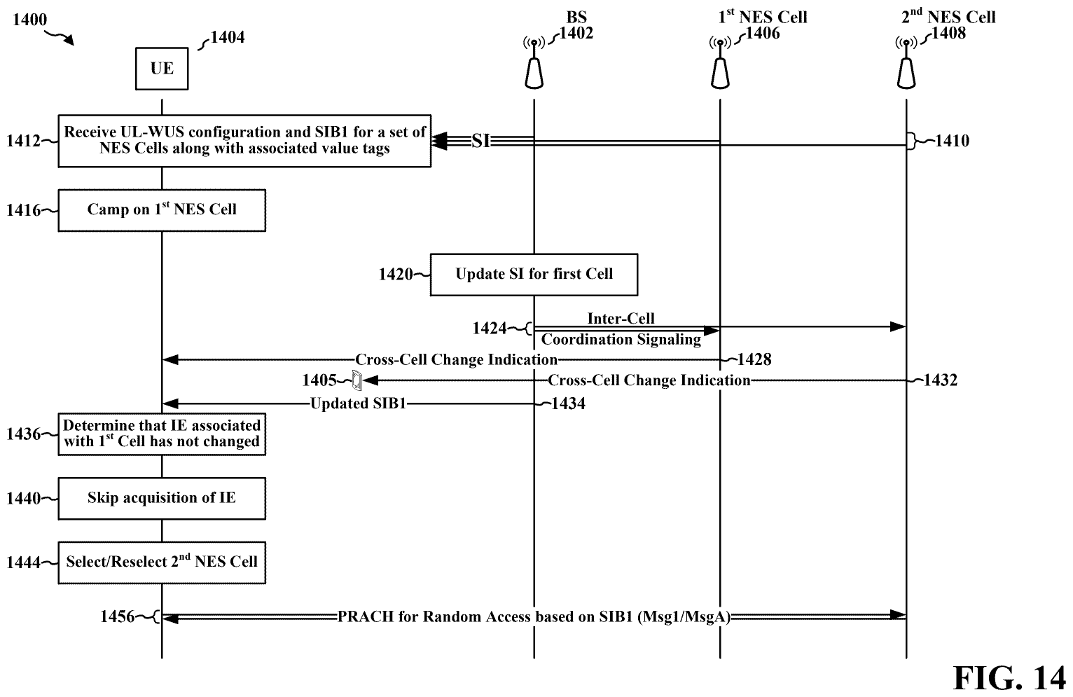

FIG. 14 is a call flow diagram 1400 illustrating a method of wireless communication associated with cross-cell change indications in accordance with some aspects of the disclosure. The method is illustrated in relation to a base station 1402, a first NES cell 1406, and a second NES cell 1408 (e.g., as examples of network devices or network nodes that may include one or more components of a disaggregated base station) in communication with a UE 1404 (e.g., as an example of a wireless device). The functions ascribed to the base station 1402, the first NES cell 1406, and the second NES cell 1408, in some aspects, may be performed by one or more components of a network entity, a network node, or a network device (a single network entity/node/device or a disaggregated network entity/node/device as described above in relation to FIG. 1). Similarly, the functions ascribed to the UE 1404, in some aspects, may be performed by one or more components of a wireless device supporting communication with a network entity/node/device. Accordingly, references to “transmitting” in the description below may be understood to refer to a first component of the base station 1402, the first NES cell 1406, or the second NES cell 1408 (or the UE 1404) outputting (or providing) an indication of the content of the transmission to be transmitted by a different component of the base station 1402, the first NES cell 1406, or the second NES cell 1408 (or the UE 1404). Similarly, references to “receiving” in the description below may be understood to refer to a first component of the base station 1402, the first NES cell 1406, or the second NES cell 1408 (or the UE 1404) receiving a transmitted signal and outputting (or providing) the received signal (or information based on the received signal) to a different component of the base station 1402, the first NES cell 1406, or the second NES cell 1408 (or the UE 1404).

The base station 1402, the first NES cell 1406, and/or the second NES cell 1408 (along with other NES cells associated with the base station 1402), in some aspects, may over time transmit SI 1410 that may be received by the UE 1404 at 1412. The SI 1410, in some aspects, may include a configuration for an OD-SIB1 for the NES cells (e.g., an UL-WUS configuration or UL-WUS configuration information associated with a PRACH request transmitted to acquire SIB1 in the absence of a periodic transmission of the SIB1 from a NES cell) and/or different SIBs including SIB1 from the NES cells and/or the base station 1402. The SI 1410, in some aspects, may include value tags associated with at least the UL-WUS configuration and the SIB1 associated with the NES cells and/or the base station 1402. As discussed above, the value tags may be included in a same message as, or a different message than, a corresponding information element. The SI may include information regarding an association between different cells (e.g., that the base station 1402 transmits SI for, or related to, the second NES cell 1408). In some aspects, the SI may include an indication of a carrier frequency or PCI associated with one or more of the base station 1402, the first NES cell 1406, or the second NES cell 1408.

The base station 1402, in some aspects, may transmit the UL-WUS configuration via known resources, e.g., periodically via a first carrier frequency or set of frequency resources, while the NES cells (e.g., the first NES cell 1406 and the second NES cell 1408) may transmit their SIB1 upon receiving a request from a UE attempting to establish a connection (e.g., attempting to camp on the NES cell) or upon a change to the SIB1. At 1416, the UE 1404 may camp on the first NES cell 1406. At 1420, the base station 1402 may determine to update SI for the base station 1402 during a next modification period. The base station 1402, may, based on the determination made at 1420, transmit a set of inter-cell coordination signaling messages 1424 to a set of associated NES cells (and, in some aspects, other non-NES cells not shown) including the first NES cell 1406 on which the UE 1404 is camped and the second NES cell 1408. In turn, the first NES cell 1406 may transmit, and the UE 1404 may receive (along with other UEs camped on the first NES cell 1406), cross-cell change indication 1428 indicating that system information associated with the base station 1402 has changed. In some aspects, the cross-cell change indication 1428 may be transmitted for any SI change even if it may not affect the OD-SIB1. The second NES cell 1408 may similarly transmit, and a UE 1405 camped on the second NES cell 1408 may receive (along with other UEs camped on the second NES cell 1408), cross-cell change indication 1432 indicating that system information associated with the base station 1402 has changed.

At 1436 the UE 1404 may determine that an information element related to the base station 1402 (and more specifically, an information element relating to an UL-WUS configuration or OD-SIB1 transmitted by the base station 1402 for one or more of the first NES cell 1406 or the second NES cell 1408) has not changed. Since the cross-cell change indication, in some aspects, may be transmitted based on changes to SI and/or information elements not affecting the OD-SIB1, the determination at 1436 may include a validity check as discussed above in relation to at least FIGS. 9 and 10 and where the receipt and/or acquisition of value tags are not shown in FIG. 14 as they may occur as described in relation to FIGS. 9 and 10.

In some aspects, determining that an information element related to the second NES cell 1408 (and more specifically, an information element relating to an OD-SIB1 of the second NES cell 1408) has not changed at 1436, may include acquiring an updated SIB1 1434 transmitted by the base station 1402 and received at the UE 1404 including value tags for other SI transmitted by the base station 1402 at the next modification period after the SI change indication, where the SIB1 from the base station 1402 may be transmitted periodically. The other SI transmitted by the base station 1402, in some aspects, may include information regarding at least the second NES cell 1408 (e.g., value tags for the OD-SIB1 or the UL-WUS configuration).

Based on the determination at 1436 that the information element related to the base station 1402 has not changed (e.g., that the UL-WUS configuration or OD-SIB1 transmitted by the base station 1402 for one or more of the first NES cell 1406 or the second NES cell 1408 has not changed), the UE 1404 may skip, at 1440, an acquisition of an updated UL-WUS configuration or SIB1. The UE 1404, at 1444, may select and/or reselect the second NES cell 1408 to camp on while still camped on the first NES cell 1406. After selecting and/or reselecting the second NES cell 1408 at 1444, the UE 1404 may skip checking the validity of the UL-WUS configuration and/or the OD-SIB1 as it has not received any cross-cell change indications determined to relate to a change in either of those values. Based on determining, at 1436, that the UL-WUS configuration or OD-SIB1 transmitted by the base station 1402 for the second NES cell 1408 has not changed, the UE 1404 may determine that a stored SIB1 for the second NES cell 1408 is valid and the UE 1404 may proceed directly to initiating the initial access (or RACH) procedure 1456.

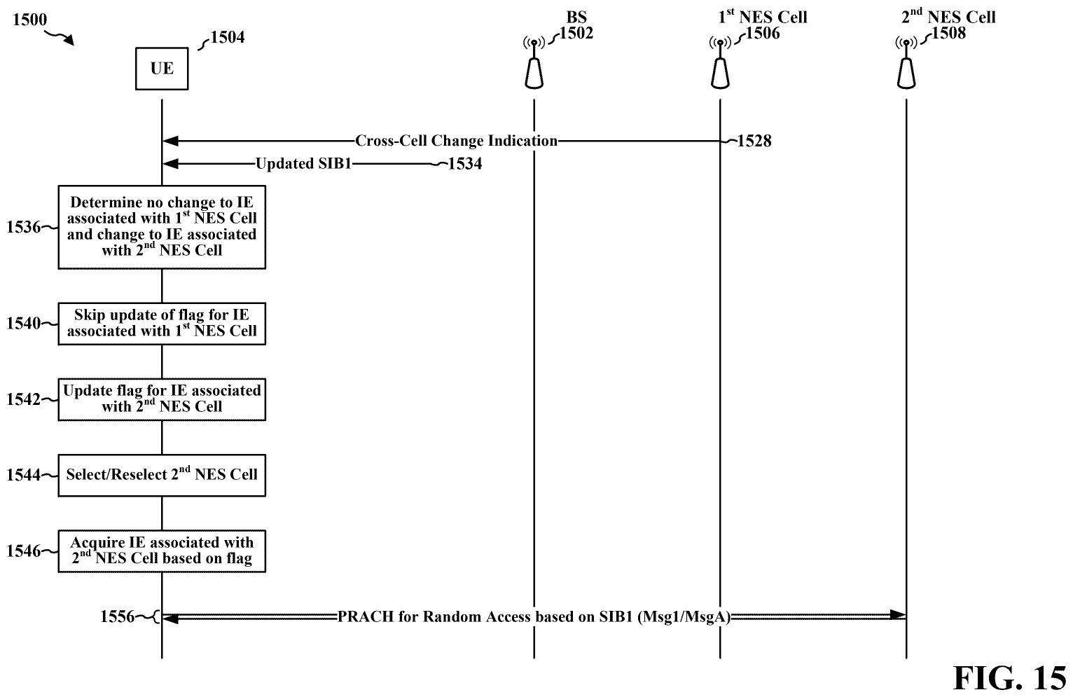

FIG. 15 is a call flow diagram 1500 illustrating a method of wireless communication associated with cross-cell change indications in accordance with some aspects of the disclosure. The method is illustrated in relation to a base station 1502, a first NES cell 1506, and a second NES cell 1508 (e.g., as examples of network devices or network nodes that may include one or more components of a disaggregated base station) in communication with a UE 1504 (e.g., as an example of a wireless device). The functions ascribed to the base station 1502, the first NES cell 1506, and the second NES cell 1508, in some aspects, may be performed by one or more components of a network entity, a network node, or a network device (a single network entity/node/device or a disaggregated network entity/node/device as described above in relation to FIG. 1). Similarly, the functions ascribed to the UE 1504, in some aspects, may be performed by one or more components of a wireless device supporting communication with a network entity/node/device. Accordingly, references to “transmitting” in the description below may be understood to refer to a first component of the base station 1502, the first NES cell 1506, or the second NES cell 1508 (or the UE 1504) outputting (or providing) an indication of the content of the transmission to be transmitted by a different component of the base station 1502, the first NES cell 1506, or the second NES cell 1508 (or the UE 1504). Similarly, references to “receiving” in the description below may be understood to refer to a first component of the base station 1502, the first NES cell 1506, or the second NES cell 1508 (or the UE 1504) receiving a transmitted signal and outputting (or providing) the received signal (or information based on the received signal) to a different component of the base station 1502, the first NES cell 1506, or the second NES cell 1508 (or the UE 1504).

The base station 1502, the first NES cell 1506, and/or the second NES cell 1508 (along with other NES cells associated with the base station 1502), in some aspects, may over time transmit SI that may be received by the UE 1504. The SI, in some aspects, may include a configuration for an OD-SIB1 for the NES cells (e.g., an UL-WUS configuration or UL-WUS configuration information associated with a PRACH request transmitted to acquire SIB1 in the absence of a periodic transmission of the SIB1 from a NES cell) and/or different SIBs including SIB1 from the NES cells and/or the base station 1502. The SI, in some aspects, may include value tags associated with at least the UL-WUS configuration and the SIB1 associated with the NES cells and/or the base station 1502. As discussed above, the value tags may be included in a same message as, or a different message than, a corresponding information element. The SI may include information regarding an association between different cells (e.g., that the base station 1502 transmits SI for, or related to, the second NES cell 1508). In some aspects, the SI may include an indication of a carrier frequency or PCI associated with one or more of the base station 1502, the first NES cell 1506, or the second NES cell 1508.

The base station 1502, in some aspects, may transmit the UL-WUS configuration via known resources, e.g., periodically via a first carrier frequency or set of frequency resources, while one of the base station 1502 or the NES cells (e.g., the first NES cell 1506 and the second NES cell 1508) may transmit SIB1 for the NES cells upon receiving a request from a UE attempting to establish a connection (e.g., attempting to camp on the NES cell) or upon a change to the SIB1. In some aspects, the UE 1504 may camp on the first NES cell 1506. Based on inter-cell coordination signaling sent by one of the base station 1502 (or the second NES cell 1508) indicating a change to SI (e.g., the UL-WUS configuration for the first NES cell 1506 and/or the second NES cell 1508 transmitted by the base station 1502, OD-SIB1 for the first NES cell 1506 and/or the second NES cell 1508 transmitted by the base station 1502, OD-SIB1 transmitted by the second NES cell 1508, or other SI) during a next modification period, the first NES cell 1506 may transmit, and the UE 1504 may receive (along with other UEs camped on the first NES cell 1506), cross-cell change indication 1528 indicating that system information associated with the base station 1502 has changed. In some aspects, the cross-cell change indication 1528 may be transmitted for any SI change even if it may not affect the OD-SIB1.

At 1536 the UE 1504 may determine that an information element related to the first NES cell 1506 (and more specifically, an information element relating to an OD-SIB1 of the first NES cell 1506 transmitted by one of the base station 1502 or the second NES cell 1508) has not changed and determine that an information element related to the second NES cell 1508 (and more specifically, an information element relating to an OD-SIB1 of the second NES cell 1508 transmitted by one of the base station 1502) has changed. Since the cross-cell change indication, in some aspects, may be transmitted based on changes to SI and/or information elements not affecting the OD-SIB1, the determination at 1536 may include a validity check as discussed above in relation to at least FIGS. 9 and 10 and where the receipt and/or acquisition of value tags are not shown in FIG. 15 as they may occur as described in relation to FIGS. 9 and 10. In some aspects, the determination at 1536 may include acquiring an SIB1 from a base station 1502, the first NES cell 1506, or the second NES cell 1508 transmitting the changed SI to determine if value tags included in the SIB1 for other SI have changed.

In some aspects, determining that an information element related to the first NES cell 1506 has not changed and determining that an information element related to the second NES cell 1508 has changed, may include acquiring an updated SIB1 1534 transmitted by one or more of the base station 1502, the first NES cell 1506, or the second NES cell 1508 and received at the UE 1504 including value tags for other SI transmitted by the one or more of the base station 1502, the first NES cell 1506, or the second NES cell 1508 at the next modification period after the SI change indication, where the SIB1 from the one or more of the base station 1502, the first NES cell 1506, or the second NES cell 1508 may be transmitted periodically (or at the next modification period after the SI change indication, where the SIB1 from one of the first NES cell 1506 or the second NES cell 1508 may be transmitted for a configured number of modification periods including at least a first modification period after the indication of a change). The other SI transmitted by the base station 1502, in some aspects, may include information regarding at least one of the first NES cell 1506 or the second NES cell 1508 (e.g., value tags for the OD-SIB1 or the UL-WUS configuration).

Based on the determination at 1536 that the information element related to the first NES cell 1506 has not changed (e.g., that the UL-WUS configuration for requesting OD-SIB1 from the first NES cell 1506 has not changed), the UE 1504 may skip, at 1540, updating a flag for an information element associated with the first NES cell 1506. In some aspects, the flag may indicate that the information element is valid until the flag is updated when a UE receives an indication that the information element has changed, where the updated flag indicates for the UE to acquire the related information element upon a selection of a related cell (e.g., a NES cell associated with the flag and/or the information element identified as having changed by the associated flag). Based on the determination at 1536 that the information element related to the second NES cell 1508 has changed (e.g., that the UL-WUS configuration for requesting OD-SIB1 from the second NES cell 1508 or other SI supporting OD-SIB1 from the second NES cell 1508 has changed), the UE 1504 may, at 1542, update a flag associated with an information element associated with the second NES cell 1508. At 1544, the UE 1504 may select and/or reselect the second NES cell 1508 to camp on, and based on the updated flag, may acquire the information element indicated to be invalid by the updated flag. For example, the UE 1504 may acquire, an updated SIB1 (e.g., by transmitting a request for OD-SIB1 for the second NES cell 1508 to the second NES cell 1508 or to the base station 1502 and receiving the SIB1 from the second NES cell 1508 or from the base station 1502). In some aspects, before acquiring the updated SIB1 for the second NES cell 1508, the UE 1504 may acquire an SIB1 for a cell transmitting SI supporting the OD-SIB1 from the second NES cell 1508, e.g., one of the base station 1502 (e.g., via a periodic SIB1 transmission from the base station 1502) or the first NES cell 1506 (e.g., via a request for OD-SIB1 from the first NES cell 1506). Based on the acquired information element(s), e.g., the information element(s) included in the SIB1, the UE 1504 may then proceed to initiating the initial access (or RACH) procedure 1556.

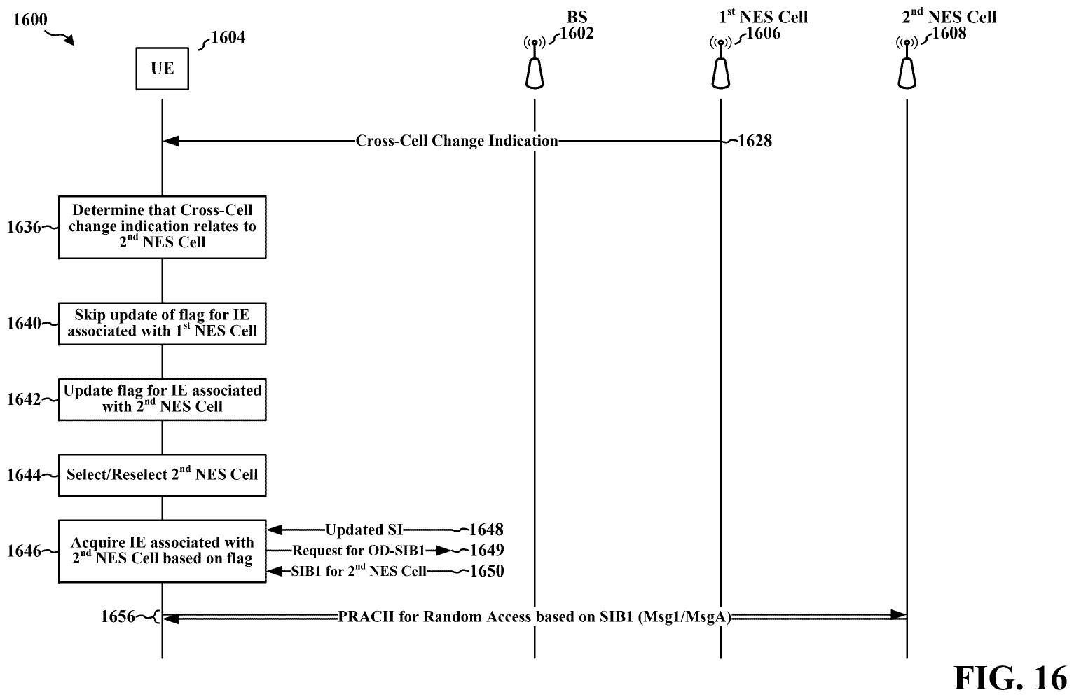

FIG. 16 is a call flow diagram 1600 illustrating a method of wireless communication associated with cross-cell change indications in accordance with some aspects of the disclosure. The method is illustrated in relation to a base station 1602, a first NES cell 1606, and a second NES cell 1608 (e.g., as examples of network devices or network nodes that may include one or more components of a disaggregated base station) in communication with a UE 1604 (e.g., as an example of a wireless device). The functions ascribed to the base station 1602, the first NES cell 1606, and the second NES cell 1608, in some aspects, may be performed by one or more components of a network entity, a network node, or a network device (a single network entity/node/device or a disaggregated network entity/node/device as described above in relation to FIG. 1). Similarly, the functions ascribed to the UE 1604, in some aspects, may be performed by one or more components of a wireless device supporting communication with a network entity/node/device. Accordingly, references to “transmitting” in the description below may be understood to refer to a first component of the base station 1602, the first NES cell 1606, or the second NES cell 1608 (or the UE 1604) outputting (or providing) an indication of the content of the transmission to be transmitted by a different component of the base station 1602, the first NES cell 1606, or the second NES cell 1608 (or the UE 1604). Similarly, references to “receiving” in the description below may be understood to refer to a first component of the base station 1602, the first NES cell 1606, or the second NES cell 1608 (or the UE 1604) receiving a transmitted signal and outputting (or providing) the received signal (or information based on the received signal) to a different component of the base station 1602, the first NES cell 1606, or the second NES cell 1608 (or the UE 1604).

The base station 1602, the first NES cell 1606, and/or the second NES cell 1608 (along with other NES cells associated with the base station 1602), in some aspects, may over time transmit SI that may be received by the UE 1604. The SI, in some aspects, may include a configuration for an OD-SIB1 for the NES cells (e.g., an UL-WUS configuration or UL-WUS configuration information associated with a PRACH request transmitted to acquire SIB1 in the absence of a periodic transmission of the SIB1 from a NES cell) and/or different SIBs including SIB1 from the NES cells and/or the base station 1602. The SI, in some aspects, may include value tags associated with at least the UL-WUS configuration and the SIB1 associated with the NES cells and/or the base station 1602. As discussed above, the value tags may be included in a same message as, or a different message than, a corresponding information element. The SI may include information regarding an association between different cells (e.g., that the base station 1602 transmits SI for, or related to, the second NES cell 1608). In some aspects, the SI may include an indication of a carrier frequency or PCI associated with one or more of the base station 1602, the first NES cell 1606, or the second NES cell 1608.

The base station 1602, in some aspects, may transmit the UL-WUS configuration via known resources, e.g., periodically via a first carrier frequency or set of frequency resources, while one of the base station 1602 or the NES cells (e.g., the first NES cell 1606 and the second NES cell 1608) may transmit SIB1 for the NES cells upon receiving a request from a UE attempting to establish a connection (e.g., attempting to camp on the NES cell) or upon a change to the SIB1. In some aspects, the UE 1604 may camp on the first NES cell 1606. Based on inter-cell coordination signaling sent by one of the base station 1602 (or the second NES cell 1608) indicating a change to SI (e.g., the UL-WUS configuration for the first NES cell 1606 and/or the second NES cell 1608 transmitted by the base station 1602, OD-SIB1 for the first NES cell 1606 and/or the second NES cell 1608 transmitted by the base station 1602, OD-SIB1 transmitted by the second NES cell 1608, or other SI) during a next modification period, the first NES cell 1606 may transmit, and the UE 1604 may receive (along with other UEs camped on the first NES cell 1606), cross-cell change indication 1628 indicating that system information associated with the base station 1602 has changed. In some aspects, the cross-cell change indication 1628 may be transmitted for any SI change even if it may not affect the OD-SIB1.

At 1636 the UE 1604 may determine that the cross-cell change indication 1628 relates at least to the second NES cell 1608 (and possibly to the base station 1602 if the cross-cell change indication is related to SI for the second NES cell 1608 transmitted by the base station 1602), but does not relate to the first NES cell 1606. The determination, in some aspects, may be based on information included in the cross-cell change indication 1628 (e.g., in one or more bits of a short message including the cross-cell change indication 1628) or based on other SI provided by the first NES cell 1606 (or previously provided by one of the base station 1602 or the second NES cell 1608) to associate the base station 1602 with the second NES cell 1608. Based on the determination at 1636 that the cross-cell change indication 1628 does not relate to the first NES cell 1606, the UE 1604 may skip, at 1640, updating a flag for an information element associated with the first NES cell 1606. In some aspects, a default state of the flag (entered after receiving an update to the related SI) may indicate that the information element is valid until the flag is updated to an “invalid” state when a UE receives an indication that the information element has changed, where the updated flag indicates for the UE 1604 to acquire the related information element upon a selection of a related cell (e.g., a NES cell associated with the flag and/or the information element identified as having changed by the associated flag).

Based on the determination at 1636 that the cross-cell change indication 1628 relates to the second NES cell 1608, the UE 1604 may, at 1642, update a flag associated with the second NES cell 1608. Similarly, if the cross-cell change indication is determined to be related to the base station 1602, the UE may, at 1642, update an additional flag associated with the base station 1602. At 1644, the UE 1604 may select and/or reselect the second NES cell 1608 to camp on, and based on the updated flag(s), may acquire the SI for the second NES cell 1608, e.g., at 1646. For example, the UE 1604 may acquire, updated SI 1648 (e.g., SI for the second NES cell 1608 transmitted by the base station 1602). The updated SI 1648, in some aspects, may include an updated SIB1 of the base station 1602 transmitted periodically, indicating one or more additional SIBs (e.g., SIBx) including SI (and related information elements) for the second NES cell 1608 where acquiring the updated SI 1648 includes acquiring the indicated one or more additional SIBs including SI for the second NES cell 1608. If the updated SI 1648 includes the SIB1 for the second NES cell 1608 or indicates that a stored SIB1 for the second NES cell 1608 is valid, the UE 1604 may proceed to initiate the initial access (or RACH) procedure 1656. Alternatively, if the updated SI 1648 indicates the UL-WUS configuration for the OD-SIB1 of the second NES cell 1608 but not the SIB1 or that the SI (or related information elements) is no longer valid (e.g., that a stored value tag for the SIB1 of the second NES cell 1608 does not match the value tag included in the updated SI 1648) the UE 1604 may use the updated SI 1648 to transmit the request 1649 for an OD-SIB1 for the second NES cell 1608 from one of the base station 1602 or the second NES cell 1608. Based on the acquired information element(s), e.g., the information element(s) included in the SIB1 1650, the UE 1604 may then proceed to initiating the initial access (or RACH) procedure 1656.

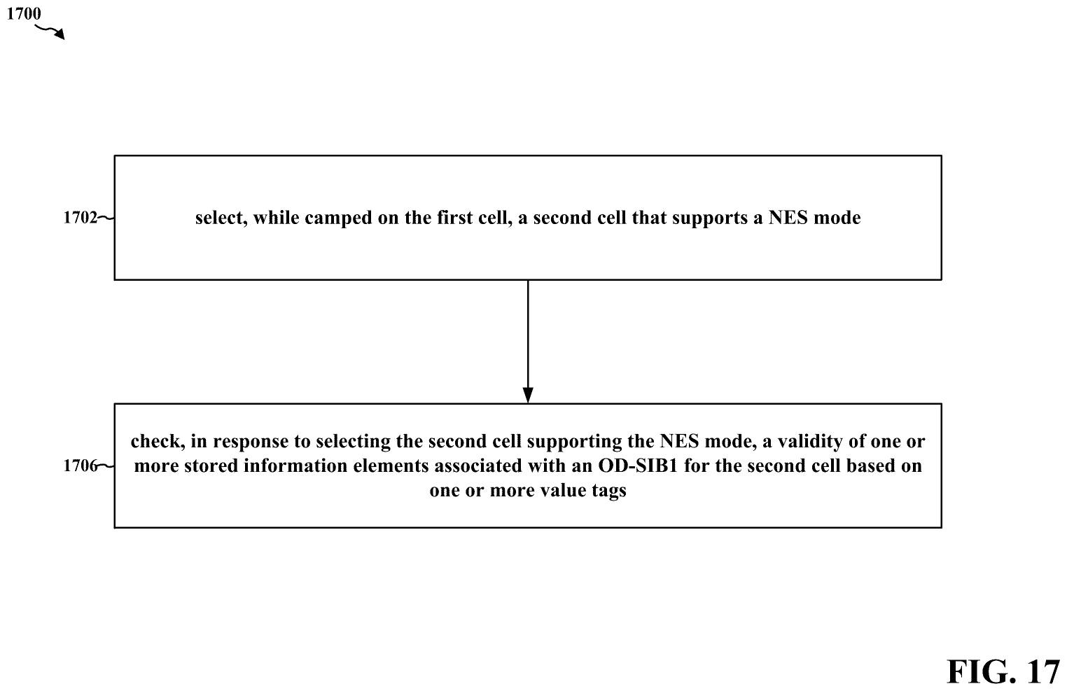

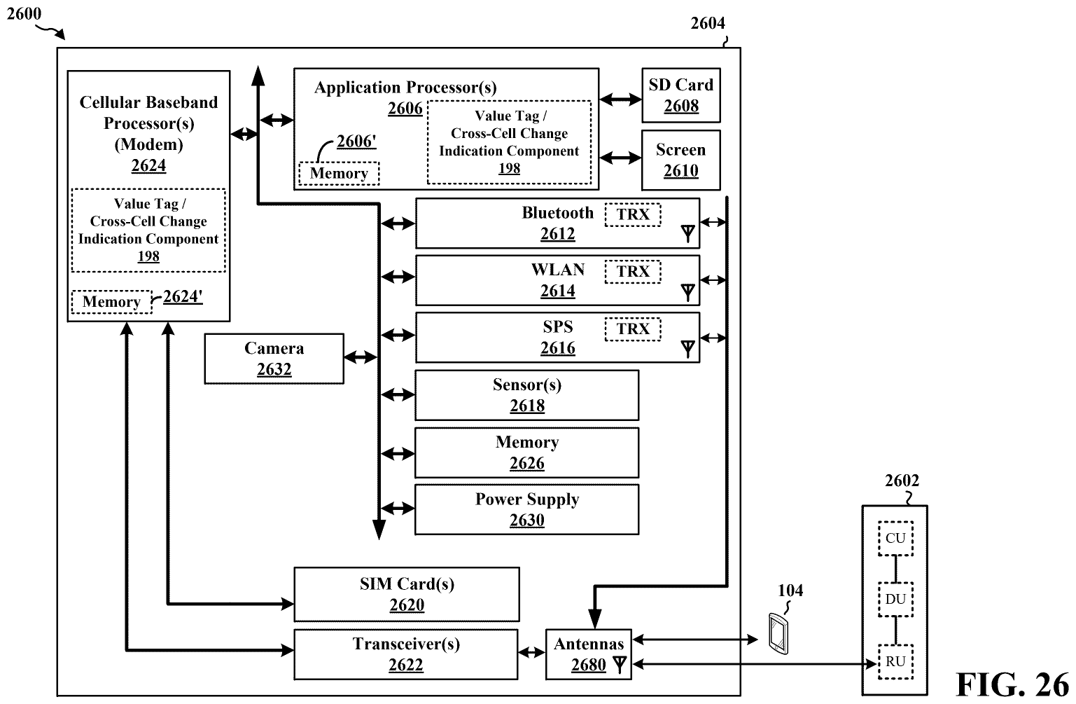

FIG. 17 is a flowchart 1700 of a method of wireless communication. The method may be performed by a UE (e.g., the UE 104, 604, 605, 606, 704, 804, 805, 904, 1004, 1104, 1204, 1304, 1404, 1504, 1604; the apparatus 2604). At 1702, the UE may select, while camped on a first cell, a second cell that supports a NES mode (e.g., a NES cell). For example, 1702 may be performed by application processor(s) 2606, cellular baseband processor(s) 2624, transceiver(s) 2622, antenna(s) 2680, and/or value tag/cross-cell change indication component 198 of FIG. 26. In some aspects, the first cell may be one of a NES cell or a non-NES cell (e.g., a cell not operating in a NES mode). For example, referring to FIGS. 9 and 10, the UE 904 (or the UE 1004), may, at 920 (or at 1020), select the first NES cell 906 (or the first NES cell 1006) to camp on while it is currently camped on a different cell such as the base station 902 (or the base station 1002) and/or, while camped on the first NES cell 906 (or the first NES cell 1006), may select and/or reselect the second NES cell 908 (or the second NES cell 1008) at 944 (or at 1044).

In some aspects, the UE may receive one or more value tags from the first cell. In some aspects, the first cell may be another cell that supports the NES mode (e.g., an NES cell) or a cell not operating in a NES mode (e.g., a non-NES cell). In some aspects, the one or more value tags may be included in one or more of a periodic SIB1 from the first cell, a SIB from the first cell, a RRC release message from the first cell, or a MIB from the second cell. In some aspects, the one or more value tags may be associated with (corresponding) one or more information elements associated with an OD-SIB1 for the second cell. For example, the one or more information elements may include one or more of a first UL-WUS configuration for the OD-SIB1 of the second cell, a second UL-WUS configuration for a set of cells that support the NES mode (where the second cell is one of the set of cells), a SIB1 of the second cell, or multiple SIB1s for the set of cells that support the NES mode (where the second cell is one of the set of cells). The one or more value tags, in some aspects, may be included in a same message as the (corresponding) one or more information elements. In some aspects, the one or more value tags may be included in a different message than the (corresponding) one or more information elements. For example, a SIB1 of the second cell may include a value tag for the SIB1 or the value tag for the SIB1 of the second cell may be included in a separate message transmitted by the first cell or a non-NES cell with coverage overlapping the coverage of the second cell. Similarly, other information elements of the one or more information elements may be included in a same message as a corresponding value tag or may be included in different messages than messages including the corresponding value tags. For example, referring to FIGS. 9 and 10, the UE 904 (or the UE 1004), may, receive a set of updated value tags 916 (or the set of updated value tags 1016).

At 1706, the UE may, in response to selecting the second cell supporting the NES mode, check a validity of the one or more information elements associated with the OD-SIB1 for the second cell based on one or more value tags. For example, 1706 may be performed by application processor(s) 2606, cellular baseband processor(s) 2624, transceiver(s) 2622, antenna(s) 2680, and/or value tag/cross-cell change indication component 198 of FIG. 26. In some aspects the one or more information elements may be stored by the UE and may be associated with a corresponding stored value tag. Checking the validity of a particular information element, in some aspects, may include comparing a value tag in the received one or more value tags corresponding to the information element with a stored value tag also corresponding to the information element. For example, referring to FIGS. 9-15, the UE 904 (or the UE 1004 or the UE 1504), may, at 924 (or at 1024 or at 1536) check the validity of information elements related to the first NES cell 906 (or the first NES cell 1006 or the first NES cell 1506) and stored at the UE 904 (or the UE 1004 or the UE 1504) and/or the UE 904 (or the UE 1004, the UE 1104, the UE 1204, the UE 1304, the UE 1404, or the UE 1504), may, at 948 (or at 1048, 1136, 1236, 1336, 1444, or 1536) check the validity of information elements related to the second NES cell 908 (or the second NES cell 1008, the second NES cell 1108, the second NES cell 1208, the second NES cell 1308, the second NES cell 1408, or the second NES cell 1508).

If the UE determines at 1706 that at least a SIB1 (or OD-SIB1) for the second cell is invalid, the UE, may, in some aspects, transmit a PRACH transmission to request the OD-SIB1 based on the one or more value tags indicating a change in the one or more information elements for the OD-SIB1, in some aspects, the one or more value tags may indicate the change if the one or more value tags do not match the value (e.g., a stored value tag) for the one or more information elements. To transmit the PRACH transmission, in some aspects, the UE may use information indicated in a UL-WUS configuration. Accordingly, if the change in the one or more information elements for the OD-SIB1 includes a change to the UL-WUS configuration for the OD-SIB1 of the second cell, the UE may acquire a current and/or latest UL-WUS configuration before transmitting the PRACH transmission. For example, referring to FIGS. 9, 10, 12, 13, and 15, the UE 904 (or the UE 1004, the UE 1204, the UE 1304, or the UE 1504), may, at 924 (or at 1024, at 1236, at 1336, or at 1536) check the validity of (and determine an invalidity of) information elements related to the first NES cell 906 (or the first NES cell 1006) (or determine that an information element associated with the second NES cell 1208, the second NES cell 1308, or the second NES cell 1508 has changed) and transmit the request for the OD-SIB1 932 (or the request for the OD-SIB1 1032, or a request associated with acquiring the information element at 1546).

If the UE determines at 1706 that at least a SIB1 (or OD-SIB1) for the second cell is valid, the UE, may, in some aspects, skip a PRACH transmission to request the OD-SIB1 based on the one or more value tags indicating no change in the one or more information elements for the OD-SIB1. In some aspects, the one or more value tags may indicate no change if the one or more value tags match a value (e.g., a stored value tag) for the one or more information elements. The UE may then use the stored OD-SIB1 to transmit a PRACH message for a random access and/or initial access procedure (e.g., to transmit a Msg1 or a MsgA). For example, referring to FIGS. 9-14, the UE 904 (or the UE 1004, the UE 1104, the UE 1204, the UE 1304, or the UE 1404), may, at 924 (or at 1024, 1144, 1244, 1344, or 1436/1444) check the validity of information elements (and more specifically, an information element relating to an OD-SIB1) related to the second NES cell 908 (or the second NES cell 1008) (or determine that information elements associated with the second NES cell 1108, the second NES cell 1208, the second NES cell 1308, or the base station 1402/the second NES cell 1408 has not changed, e.g., based on a validity check or based on having recently updated the information element) and omit transmit the request for the OD-SIB1 and proceed to initiating the initial access (or RACH) procedure 952, 1052, 1156, 1256, 1356, or 1456.

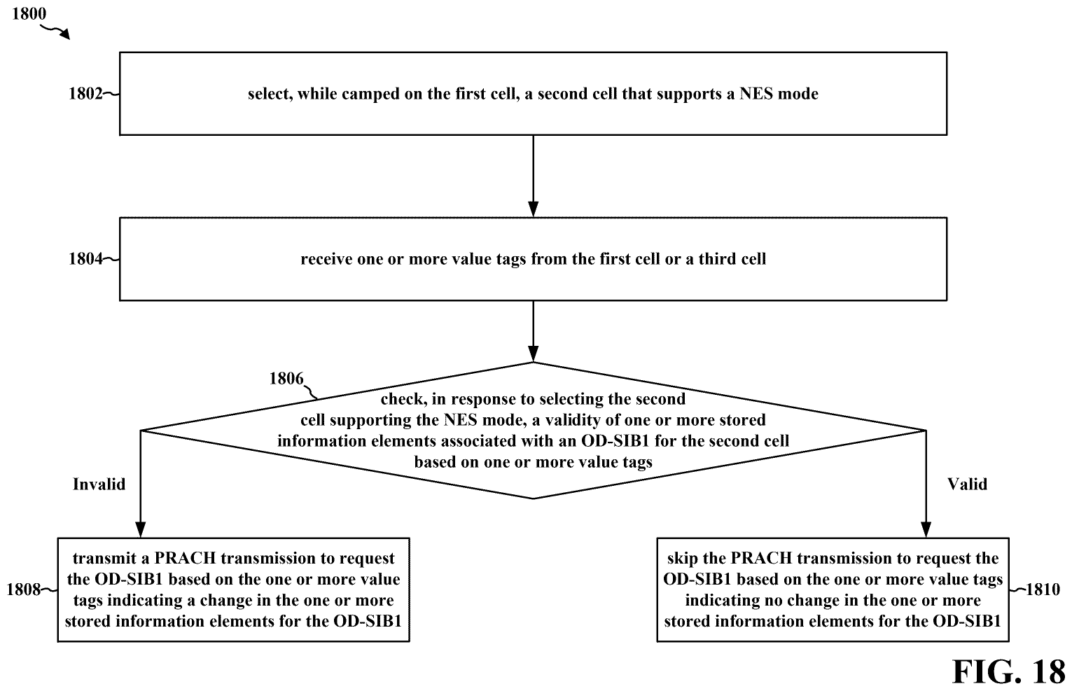

FIG. 18 is a flowchart 1800 of a method of wireless communication. The method may be performed by a UE (e.g., the UE 104, 604, 605, 606, 704, 804, 805, 904, 1004, 1104, 1204, 1304, 1404, 1504, 1604; the apparatus 2604). At 1802, the UE may select, while camped on a first cell, a second cell that supports a NES mode (e.g., a NES cell). For example, 1802 may be performed by application processor(s) 2606, cellular baseband processor(s) 2624, transceiver(s) 2622, antenna(s) 2680, and/or value tag/cross-cell change indication component 198 of FIG. 26. In some aspects, the first cell may be one of a NES cell or a non-NES cell (e.g., a cell not operating in a NES mode). For example, referring to FIGS. 9 and 10, the UE 904 (or the UE 1004), may, at 920 (or at 1020), select the first NES cell 906 (or the first NES cell 1006) to camp on while it is currently camped on a different cell such as the base station 902 (or the base station 1002) and/or, while camped on the first NES cell 906 (or the first NES cell 1006), may select and/or reselect the second NES cell 908 (or the second NES cell 1008) at 944 (or at 1044).

At 1804, the UE may receive one or more value tags from the first cell or a third cell. In some aspects, the first cell may be another cell that supports the NES mode (e.g., an NES cell) or a cell not operating in a NES mode (e.g., a non-NES cell). In some aspects, the one or more value tags may be included in one or more of a periodic SIB1 from the first cell or the third cell, a SIB from the first cell or the third cell, a RRC release message from the first cell or a third cell, or a MIB from the second cell. In some aspects, receiving the one or more value tags at 1804 may include receiving the one or more value tags in a periodically transmitted message. For example, 1804 may be performed by application processor(s) 2606, cellular baseband processor(s) 2624, transceiver(s) 2622, antenna(s) 2680, and/or value tag/cross-cell change indication component 198 of FIG. 26. In some aspects, the one or more value tags may be associated with (corresponding) one or more information elements associated with an OD-SIB1 for the second cell. For example, the one or more information elements may include one or more of a first UL-WUS configuration for the OD-SIB1 of the second cell, a second UL-WUS configuration for a set of cells that support the NES mode (where the second cell is one of the set of cells), a SIB1 of the second cell, or multiple SIBs for the set of cells that support the NES mode (where the second cell is one of the set of cells). The one or more value tags, in some aspects, may be included in a same message as the (corresponding) one or more information elements. In some aspects, the one or more value tags may be included in a different message than the (corresponding) one or more information elements. For example, a SIB1 of the second cell may include a value tag for the SIB1 or the value tag for the SIB1 of the second cell may be included in a separate message transmitted by the first cell or a non-NES cell with coverage overlapping the coverage of the second cell. Similarly, other information elements of the one or more information elements may be included in a same message as a corresponding value tag or may be included in different messages than messages including the corresponding value tags. For example, referring to FIGS. 9 and 10, the UE 904 (or the UE 1004), may, receive a set of updated value tags 916 (or the set of updated value tags 1016).

At 1806, the UE may, in response to selecting the second cell supporting the NES mode, check a validity of the one or more information elements associated with the OD-SIB1 for the second cell based on one or more value tags. For example, 1806 may be performed by application processor(s) 2606, cellular baseband processor(s) 2624, transceiver(s) 2622, antenna(s) 2680, and/or value tag/cross-cell change indication component 198 of FIG. 26. In some aspects the one or more information elements may be stored by the UE and may be associated with a corresponding stored value tag (or value). Checking the validity of a particular information element, in some aspects, may include comparing a value tag in the received one or more value tags corresponding to the information element with a stored value tag also corresponding to the information element. For example, referring to FIGS. 9-15, the UE 904 (or the UE 1004 or the UE 1504), may, at 924 (or at 1024 or at 1536) check the validity of information elements related to the first NES cell 906 (or the first NES cell 1006 or the first NES cell 1506) and stored at the UE 904 (or the UE 1004 or the UE 1504) and/or the UE 904 (or the UE 1004, the UE 1104, the UE 1204, the UE 1304, the UE 1404, or the UE 1504), may, at 948 (or at 1048, 1136, 1236, 1336, 1444, or 1536) check the validity of information elements related to the second NES cell 908 (or the second NES cell 1008, the second NES cell 1108, the second NES cell 1208, the second NES cell 1308, the second NES cell 1408, or the second NES cell 1508).

If the UE determines at 1806 that at least a SIB1 (or OD-SIB1) for the second cell is invalid, the UE may, at 1808, transmit a PRACH transmission to request the OD-SIB1 based on the one or more value tags indicating a change (or that there has been a change) in, or to, the one or more information elements for the OD-SIB1. For example, 1808 may be performed by application processor(s) 2606, cellular baseband processor(s) 2624, transceiver(s) 2622, antenna(s) 2680, and/or value tag/cross-cell change indication component 198 of FIG. 26. In some aspects, the one or more value tags may indicate the change if the one or more value tags do not match the value (e.g., a stored value tag) for the one or more information elements. For example, the one or more value tags may indicate that there has been a change to the one or more information elements if the one or more value tags (or one or more values associated with the one or more value tags) do not match one or more stored value tags (or one or more values associated with the one or more stored value tags) for the one or more information elements. To transmit the PRACH transmission at 1808, in some aspects, the UE may use information indicated in a UL-WUS configuration. Accordingly, if the change in the one or more information elements for the OD-SIB1 includes a change to the UL-WUS configuration for the OD-SIB1 of the second cell, the UE may acquire a current and/or latest UL-WUS configuration before transmitting the PRACH transmission at 1808. For example, referring to FIGS. 9 and 10, the UE 904 (or the UE 1004), may, at 924 (or at 1024) check the validity of (and determine an invalidity of) information elements related to the first NES cell 906 (or the first NES cell 1006) and transmit the request for the OD-SIB1 932 (or the request for the OD-SIB1 1032).

If the UE determines at 1806 that at least a SIB1 (or OD-SIB1) for the second cell is valid, the UE may, at 1810, skip a PRACH transmission to request the OD-SIB1 based on the one or more value tags indicating no change in the one or more information elements for the OD-SIB1 (e.g., indicating that there has been no change to the one or more information elements). For example, 1810 may be performed by application processor(s) 2606, cellular baseband processor(s) 2624, transceiver(s) 2622, antenna(s) 2680, and/or value tag/cross-cell change indication component 198 of FIG. 26. In some aspects, the one or more value tags may indicate no change if the one or more value tags match a value (e.g., a stored value tag) for the one or more information elements. For example, the one or more value tags for the one or more information elements may indicate that there has been no change to one or more corresponding information elements if the one or more value tags (or one or more values associated with the one or more value tags) match one or more stored value tags (or one or more values associated with the one or more stored value tags). The UE may then use the stored OD-SIB1 to transmit a PRACH message for a random access and/or initial access procedure (e.g., to transmit a Msg1 or a MsgA). For example, referring to FIGS. 9-14, the UE 904 (or the UE 1004, the UE 1104, the UE 1204, the UE 1304, or the UE 1404), may, at 924 (or at 1024, 1144, 1244, 1344, or 1436/1444) check the validity of information elements (and more specifically, an information element relating to an OD-SIB1) related to the second NES cell 908 (or the second NES cell 1008) (or determine that information elements associated with the second NES cell 1108, the second NES cell 1208, the second NES cell 1308, or the base station 1402/the second NES cell 1408 has not changed, e.g., based on a validity check or based on having recently updated the information element) and omit transmit the request for the OD-SIB1 and proceed to initiating the initial access (or RACH) procedure 952, 1052, 1156, 1256, 1356, or 1456.

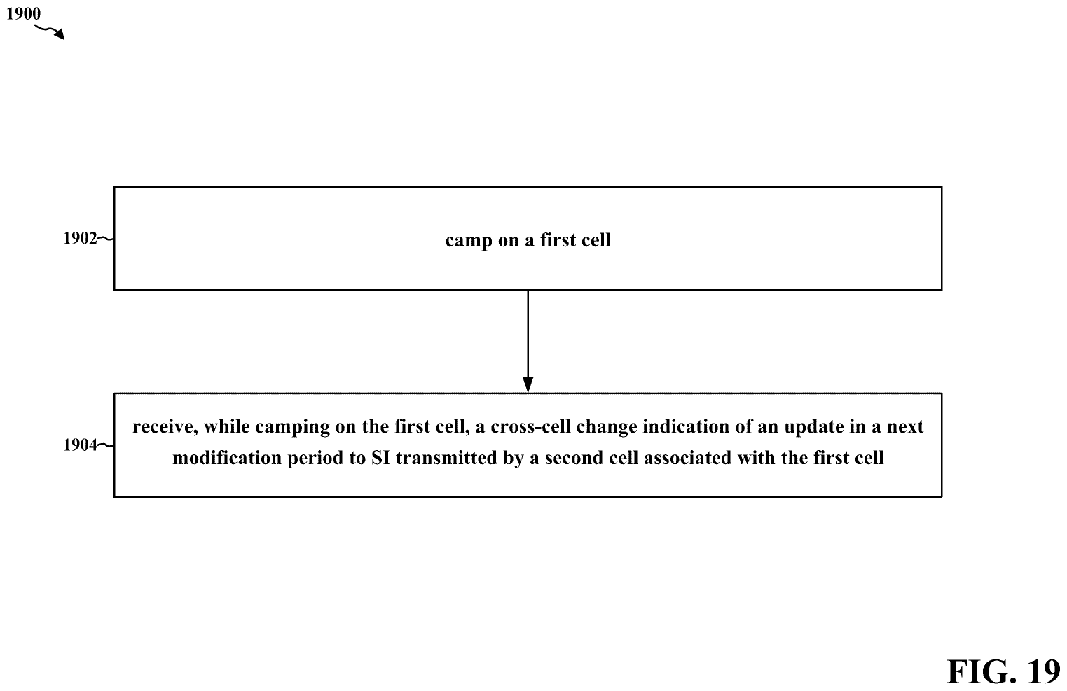

FIG. 19 is a flowchart 1900 of a method of wireless communication. The method may be performed by a UE (e.g., the UE 104, 604, 605, 606, 704, 804, 805, 904, 1004, 1104, 1204, 1304, 1404, 1504, 1604; the apparatus 2604). At 1902, the UE may camp on a first cell. For example, 1902 may be performed by application processor(s) 2606, cellular baseband processor(s) 2624, transceiver(s) 2622, antenna(s) 2680, and/or value tag/cross-cell change indication component 198 of FIG. 26. In some aspects, the first cell may be one of a NES cell or a non-NES cell (e.g., a cell not operating in a NES mode). For example, referring to FIGS. 11-16, the UE 1104 (or the UE 1204, the UE 1304, the UE 1404, the UE 1504, or the UE 1604), may, at 1116 (or at 1216, 1316, 1416, 1516, or 1616), select and camp on a first NES cell 1106 (or the first NES cell 1206, the first NES cell 1306, the first NES cell 1406, the first NES cell 1506, or the first NES cell 1606).

At 1904, the UE may receive, while camping on the first cell, a cross-cell change indication of an update in a next modification period to SI transmitted by a second cell associated with the first cell. For example, the second cell, in some aspects, may be associated with the first cell and the second cell may transmit updated SI in the next modification period. The SI transmitted by the second cell, in some aspects, may include one or more information elements for a third cell that supports the NES mode. For example, 1904 may be performed by application processor(s) 2606, cellular baseband processor(s) 2624, transceiver(s) 2622, antenna(s) 2680, and/or value tag/cross-cell change indication component 198 of FIG. 26. The third cell, in some aspects, may be included in a group of cells. In some aspects, the group of cells may be a group of cells that support the NES mode, and the group of cells may include at least the first cell, and the group of cells may be associated with the second cell that does not operate in a NES mode. The cross-cell change indication, in some aspects, indicates the SI update for a cell that is not in the NES mode and is associated with at least the first cell that supports the NES mode. In some aspects, the cross-cell change indication may be included in a short message. The cross-cell change indication, in some aspects, may be indicated in one of a set of reserved bits in the short message or a repurposed field in the short message. The short message, in some aspects, may indicate that there has been a change to one or more information elements related to an OD-SIB1 or to at least one SI that may, or may not, relate to the OD-SIB1. In some aspects, the short message may also indicate a cell associated with the indicated change to the SI. The cross-cell change, in some aspects, may relate to one or more of an UL-WUS configuration for an OD-SIB1 of the third cell, the OD-SIB1 of the third cell, a first value tag for the OD-SIB1 of the third cell, or a second value tag for the UL-WUS configuration for the OD-SIB1 of the third cell. For example, referring to FIGS. 11-15, the UE 1104 (or the UE 1204, the UE 1304, the UE 1404, the UE 1504, or the UE 1604), may receive the cross-cell change indication 1128 (or the cross-cell change indication 1228, the cross-cell change indication 1328, the cross-cell change indication 1428, or the cross-cell change indication 1528), indicating that system information associated with a cell other than the cell from which the cross-cell change indication is received will be changed and/or updated in a next modification period.

In some aspects, the UE may determine, in response to the cross-cell change indication, whether there is a change in one or more information elements associated with the second cell. In some aspects, determining whether there is a change in the one or more information elements associated with the second cell may include determining that the cross-cell change indication is related to one of the second cell (or a third cell where the second cell transmits SI for the third cell). Determining whether there is a change in one or more information elements associated with the second cell, in some aspects, may include checking a validity of the one or more information elements associated with the second cell based on one or more value tags. In some aspects, determining whether there is a change in the one or more information elements may include acquiring a SIB1 transmitted by the second cell based on the update to the SI in the next modification period, where the SIB1 includes one or more value tags corresponding to the one or more information elements. Based on acquiring the SIB1 including the value tags, the UE may determine, based on the SIB1 transmitted by the second cell indicating a change in the one or more information elements related to the OD-SIB1, a change in the one or more information elements, that the change in the one or more information elements includes a change to the at least one information element, or no change in the one or more information elements. In some aspects the one or more information elements may be stored by the UE and may be associated with a corresponding stored value tag. Checking the validity of a particular information element, in some aspects, may include comparing a value tag in the received one or more value tags corresponding to the information element with a stored value tag also corresponding to the information element. In some aspects, the one or more information elements associated with the second cell are information elements related to an OD-SIB1 for one of the second cell or the third cell. For example, referring to FIGS. 11-16, the UE 1104 (or the UE 1204, the UE 1304, the UE 1404, the UE 1504, or the UE 1604), may, at 1136 (or at 1236, 1336, 1436, 1536, or 1636) check the validity of information elements related to the second NES cell 1108 (or the second NES cell 1208, the second NES cell 1308, the second NES cell 1408, the second NES cell 1508, or the second NES cell 1608).

If the UE determines that there is a change in one or more information elements associated with the second cell, the UE may update at least one of a flag indicating a change to the one or more information elements or the one or more information elements during the next modification period when the change is determined. In some aspects, updating the one or more information elements may include acquiring updates to the one or more information elements from the second cell during the next modification period. The updated flag may be for the second cell and/or the third cell. In some aspects, updating the flag for the second cell and/or the third cell may be based on receiving the cross-cell change indication indicating that it is associated with the second cell and/or the third cell (e.g., without acquiring additional SI). Updating the flag indicating a change to the one or more information elements may be based on determining, based on the SIB1 transmitted by the second cell indicating a change in the one or more information elements related to the OD-SIB1, the change in the one or more information elements includes a change to the at least one information element (e.g., at least one information element related to the OD-SIB1 for the third cell). Updating the one or more information elements, in some aspects, includes acquiring updates to the one or more information elements from the second cell during the next modification period based on one or more value tags included in the SIB1 indicating that the one or more information elements have changed. In some aspects, the one or more value tags may indicate the change if the one or more value tags do not match the value (e.g., a stored value tag) for the one or more information elements. If the change in the one or more information elements for the OD-SIB1 includes a change to the UL-WUS configuration for the OD-SIB1 of at least one of the second cell or the third cell, the UE may acquire a current and/or latest UL-WUS configuration. If the change in the one or more information elements for the OD-SIB1 includes a change to the OD-SIB1 of at least one of the second cell or the third cell, the UE may acquire a current and/or latest OD-SIB1 of the at least one of the second cell or the third cell which may, in some aspects, be based on first acquiring an updated UL-WUS configuration for the OD-SIB1 of the at least one of the second cell or the third cell. For example, referring to FIGS. 11-13 and 15, the UE 1104 (or the UE 1204, the UE 1304, or the UE 1504), may, at 1136 (or at 1236, 1336, or 1536) determine that an information element associated with the second NES cell 1108 (or the second NES cell 1208, the second NES cell 1308, or the second NES cell 1508) has changed and, at 1140 (or at 1240) acquire an updated information element or at 1542 update a flag associated with an information element associated with the second NES cell 1508.

If the UE determines that there is no change in one or more information elements associated with the second cell, the UE may skip updating the flag or the one or more information elements when no change is determined. In some aspects, the one or more value tags may indicate no change if the one or more value tags match a value (e.g., a stored value tag) for the one or more information elements. The UE may then use the stored OD-SIB1 to transmit a PRACH message for a random access and/or initial access procedure (e.g., to transmit a Msg1 or a MsgA). For example, referring to FIGS. 14 and 15, the UE 1404 (or the UE 1504), may, at 1436 (or at 1536) determine that there has been no change to an information element (and more specifically, an information element relating to an OD-SIB1) related to the base station 1402 (or the first NES cell 1506) and skip acquiring the information element at 1440 or skip updating a flag for the information element at 1540.

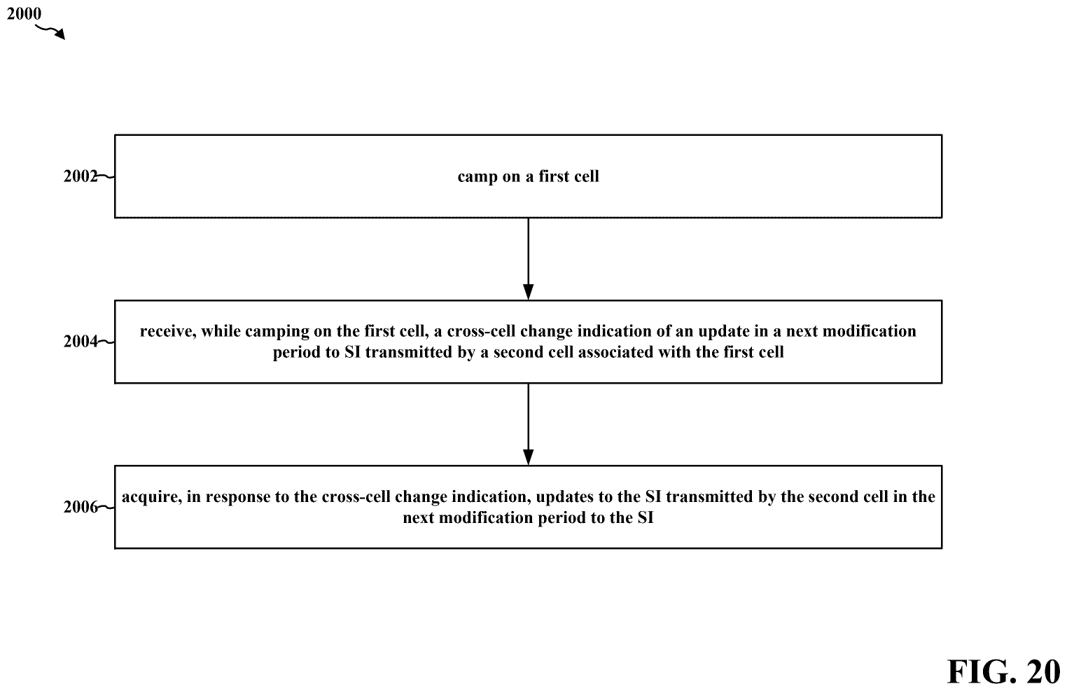

FIG. 20 is a flowchart 2000 of a method of wireless communication. The method may be performed by a UE (e.g., the UE 104, 604, 605, 606, 704, 804, 805, 904, 1004, 1104, 1204, 1304, 1404, 1504, 1604; the apparatus 2604). At 2002, the UE may camp on a first cell. For example, 2002 may be performed by application processor(s) 2606, cellular baseband processor(s) 2624, transceiver(s) 2622, antenna(s) 2680, and/or value tag/cross-cell change indication component 198 of FIG. 26. In some aspects, the first cell may be one of a NES cell or a non-NES cell (e.g., a cell not operating in a NES mode). For example, referring to FIGS. 11-14, the UE 1104 (or the UE 1204, the UE 1304, or the UE 1404), may, at 1116 (or at 1216, 1316, or 1416), select and camp on a first NES cell 1106 (or the first NES cell 1206, the first NES cell 1306, or the first NES cell 1406).

At 2004, the UE may receive, while camping on the first cell, a cross-cell change indication of an update in a next modification period to SI transmitted by a second cell associated with the first cell. For example, the second cell, in some aspects, may be associated with the first cell and the second cell may transmit updated SI in the next modification period as indicated by the cross-cell change indication. The SI transmitted by the second cell, in some aspects, may include one or more information elements for a third cell that supports the NES mode. For example, 2004 may be performed by application processor(s) 2606, cellular baseband processor(s) 2624, transceiver(s) 2622, antenna(s) 2680, and/or value tag/cross-cell change indication component 198 of FIG. 26. The third cell, in some aspects, may be included in a group of cells. In some aspects, the group of cells may be a group of cells that support the NES mode, and the group of cells may include at least the first cell, and the group of cells may be associated with the second cell that does not operate in a NES mode. The cross-cell change indication, in some aspects, indicates the SI update for a cell that is not in the NES mode and is associated with at least the first cell that supports the NES mode. In some aspects, the cross-cell change indication may be included in a short message. The cross-cell change indication, in some aspects, may be indicated in one of a set of reserved bits in the short message or a repurposed field in the short message. The short message, in some aspects, may indicate that there has been a change to one or more information elements related to an OD-SIB1 or to at least one SI that may, or may not, relate to the OD-SIB1. In some aspects, the short message may also indicate a cell (or set of cells) associated with the indicated change to the SI. The cross-cell change, in some aspects, may relate to one or more of an UL-WUS configuration for an OD-SIB1 of the third cell, the OD-SIB1 of the third cell, a first value tag for the OD-SIB1 of the third cell, or a second value tag for the UL-WUS configuration for the OD-SIB1 of the third cell. For example, referring to FIGS. 11-14, the UE 1104 (or the UE 1204, the UE 1304, or the UE 1404), may receive the cross-cell change indication 1128 (or the cross-cell change indication 1228, the cross-cell change indication 1328, or the cross-cell change indication 1428), indicating that system information associated with a cell other than the cell from which the cross-cell change indication is received will be changed and/or updated in a next modification period.

At 2006, the UE may acquire updates to the SI transmitted by the second cell during the next modification period. For example, 2006 may be performed by application processor(s) 2606, cellular baseband processor(s) 2624, transceiver(s) 2622, antenna(s) 2680, and/or value tag/cross-cell change indication component 198 of FIG. 26. In some aspects, acquiring the updates to the SI transmitted by the second cell may include acquiring a SIB1 from the second cell. The SIB1 acquired from the second cell, in some aspects, may be used to acquire additional SI (and/or information elements) related to the second cell. In some aspects, the second cell and a third cell may be identified in the cross-cell change indication as being associated with the changed SI (or the cross-cell change indication) and acquiring updates to the SI at 2006 may include acquiring additional SI related to the third cell, such as one of an UL-WUS configuration for an OD-SIB1 of the third cell, the OD-SIB1 of the third cell, a first value tag for the OD-SIB1 of the third cell, or a second value tag for the UL-WUS configuration for the OD-SIB1 of the third cell. For example, referring to FIGS. 11-14, the UE 1104 (or the UE 1204, the UE 1304, or the UE 1404), may receive the cross-cell change indication 1128 (or the cross-cell change indication 1228, the cross-cell change indication 1328, or the cross-cell change indication 1428) indicating that system information associated with a cell other than the cell from which the cross-cell change indication is received will be changed and/or updated in a next modification period and acquire the updated SIB1 1134 (or the updated SIB1 1234, the updated SIB1 1334, or the updated SIB1 1434) during the next modification period.

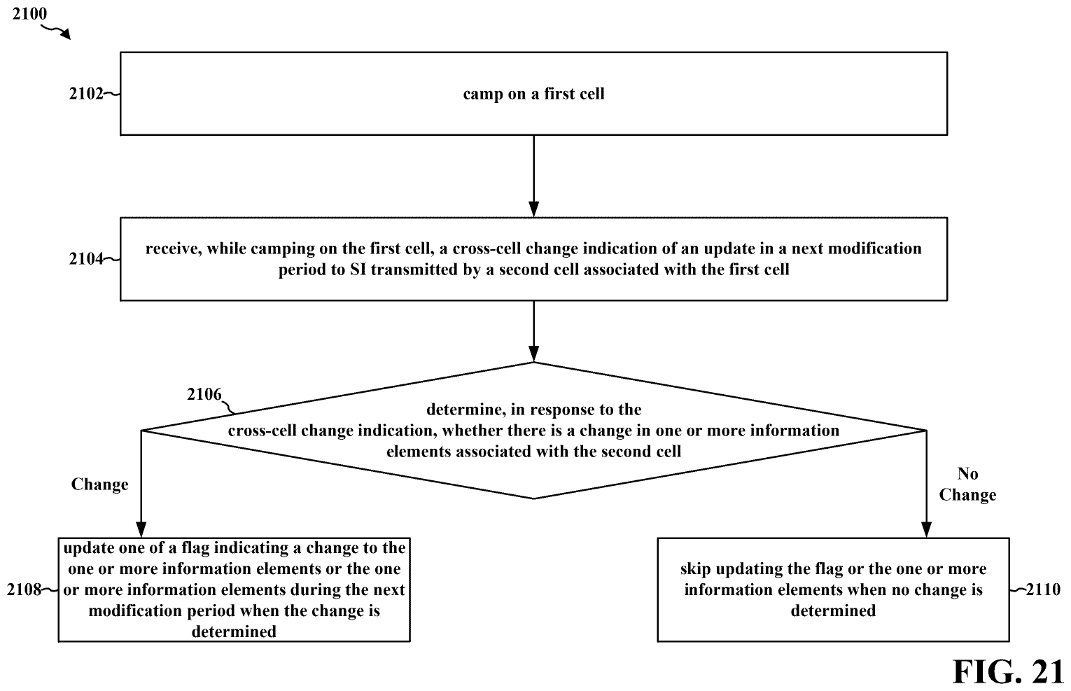

FIG. 21 is a flowchart 2100 of a method of wireless communication. The method may be performed by a UE (e.g., the UE 104, 604, 605, 606, 704, 804, 805, 904, 1004, 1104, 1204, 1304, 1404, 1504, 1604; the apparatus 2604). At 2102, the UE may camp on a first cell. For example, 2102 may be performed by application processor(s) 2606, cellular baseband processor(s) 2624, transceiver(s) 2622, antenna(s) 2680, and/or value tag/cross-cell change indication component 198 of FIG. 26. In some aspects, the first cell may be one of a NES cell or a non-NES cell (e.g., a cell not operating in a NES mode). For example, referring to FIGS. 11-15, the UE 1104 (or the UE 1204, the UE 1304, the UE 1404, or the UE 1504), may, at 1116 (or at 1216, 1316, 1416, or 1516), select and camp on a first NES cell 1106 (or the first NES cell 1206, the first NES cell 1306, the first NES cell 1406, or the first NES cell 1506).

At 2104, the UE may receive, while camping on the first cell, a cross-cell change indication of an update in a next modification period to SI transmitted by a second cell associated with the first cell. For example, the second cell, in some aspects, may be associated with the first cell and the second cell may transmit updated SI in the next modification period. The SI transmitted by the second cell, in some aspects, may include one or more information elements for a third cell that supports the NES mode. For example, 2104 may be performed by application processor(s) 2606, cellular baseband processor(s) 2624, transceiver(s) 2622, antenna(s) 2680, and/or value tag/cross-cell change indication component 198 of FIG. 26. The third cell, in some aspects, may be included in a group of cells. In some aspects, the group of cells may be a group of cells that support the NES mode, and the group of cells may include at least the first cell, and the group of cells may be associated with the second cell that does not operate in a NES mode. The cross-cell change indication, in some aspects, indicates the SI update for a cell that is not in the NES mode and is associated with at least the first cell that supports the NES mode. In some aspects, the cross-cell change indication may be included in a short message. The cross-cell change indication, in some aspects, may be indicated in one of a set of reserved bits in the short message or a repurposed field in the short message. The short message, in some aspects, may indicate that there has been a change to one or more information elements related to an OD-SIB1 or to at least one SI that may, or may not, relate to the OD-SIB1. In some aspects, the short message may also indicate a cell associated with the indicated change to the SI. The cross-cell change, in some aspects, may relate to one or more of an UL-WUS configuration for an OD-SIB1 of the third cell, the OD-SIB1 of the third cell, a first value tag for the OD-SIB1 of the third cell, or a second value tag for the UL-WUS configuration for the OD-SIB1 of the third cell. For example, referring to FIGS. 11-15, the UE 1104 (or the UE 1204, the UE 1304, the UE 1404, or the UE 1504), may receive the cross-cell change indication 1128 (or the cross-cell change indication 1228, the cross-cell change indication 1328, the cross-cell change indication 1428, or the cross-cell change indication 1528), indicating that system information associated with a cell other than the cell from which the cross-cell change indication is received will be changed and/or updated in a next modification period.

At 2106, the UE may determine, in response to the cross-cell change indication, whether there is a change in one or more information elements associated with the second cell. For example, 2106 may be performed by application processor(s) 2606, cellular baseband processor(s) 2624, transceiver(s) 2622, antenna(s) 2680, and/or value tag/cross-cell change indication component 198 of FIG. 26. In some aspects, determining whether there is (or whether there has been) a change in, or to, the one or more information elements associated with the second cell may include determining that the cross-cell change indication is related to one of the second cell (or a third cell where the second cell transmits SI for the third cell). Determining whether there is a change in one or more information elements associated with the second cell, in some aspects, may include checking a validity of the one or more information elements associated with the second cell based on one or more value tags. In some aspects, determining whether there is a change in the one or more information elements may include acquiring a SIB1 transmitted by the second cell based on the update in the next modification period to the SI, where the SIB1 includes one or more value tags corresponding to the one or more information elements. Based on acquiring the SIB1 including the value tags, the UE may determine, based on the SIB1 transmitted by the second cell indicating a change in the one or more information elements related to the OD-SIB1 (e.g., indicating whether there has been a change to the one or more information elements related to the OD-SIB1 since a last acquisition of the one or more information elements), a change (or that there has been a change) in the one or more information elements, that the change in the one or more information elements includes a change to the at least one information element, or that there has been no change in the one or more information elements (e.g., that the one or more information elements and/or the at least one information element is still valid). In some aspects the one or more information elements may be stored by the UE and may be associated with a corresponding stored value tag. Checking the validity of a particular information element, in some aspects, may include comparing a value tag in the received one or more value tags corresponding to the information element with a stored value tag also corresponding to the information element. In some aspects, the one or more information elements associated with the second cell are information elements related to an OD-SIB1 for one of the second cell or the third cell. For example, referring to FIGS. 11-15, the UE 1104 (or the UE 1204, the UE 1304, the UE 1404, or the UE 1504), may, at 1136 (or at 1236, 1336, 1436, or 1536) check the validity of information elements related to the second NES cell 1108 (or the second NES cell 1208, the second NES cell 1308, the second NES cell 1408, or the second NES cell 1508).

If the UE determines at 2106 that there is (or has been) a change in one or more information elements associated with the second cell, the UE may, at 2108, update at least one of a flag indicating, or used to indicate, a change to (1) the one or more information elements or (2) the one or more information elements during the next modification period when the change is determined (e.g., based on a determined change or a determination that there has been a change). In some aspects, updating the one or more information elements may include acquiring updates to the one or more information elements from the second cell during the next modification period. The updated flag may be for the second cell and/or the third cell. In some aspects, updating the flag for the second cell and/or the third cell may be based on receiving the cross-cell change indication indicating that it is associated with the second cell and/or the third cell (e.g., without acquiring additional SI). Updating the flag indicating, or used to indicate, a change to the one or more information elements may be based on determining, based on the SIB1 transmitted by the second cell indicating a change in the one or more information elements related to the OD-SIB1, that the change in the one or more information elements includes a change to the at least one information element (e.g., at least one information element related to the OD-SIB1 for the third cell). For example, 2108 may be performed by application processor(s) 2606, cellular baseband processor(s) 2624, transceiver(s) 2622, antenna(s) 2680, and/or value tag/cross-cell change indication component 198 of FIG. 26. Updating the one or more information elements, in some aspects, includes acquiring updates to the one or more information elements from the second cell during the next modification period based on one or more value tags included in the SIB1 (e.g., SIB1 acquired to make the determination at 2106) indicating that the one or more information elements have changed (e.g., that there has been a change to the one or more information elements since a last acquisition of the one or more information elements). In some aspects, the one or more value tags may indicate the change if the one or more value tags (e.g., one or more values associated with the one or more value tags) do not match the value (e.g., a stored value tag) for the one or more information elements. If the change in the one or more information elements for the OD-SIB1 includes a change to the UL-WUS configuration for the OD-SIB1 of at least one of the second cell or the third cell, the UE may acquire a current and/or latest UL-WUS configuration. If the change in the one or more information elements for the OD-SIB1 includes a change to the OD-SIB1 of at least one of the second cell or the third cell, the UE may acquire a current and/or latest OD-SIB1 of the at least one of the second cell or the third cell which may, in some aspects, be based on first acquiring an updated UL-WUS configuration for the OD-SIB1 of the at least one of the second cell or the third cell. For example, referring to FIGS. 11-13 and 15, the UE 1104 (or the UE 1204, the UE 1304, or the UE 1504), may, at 1136 (or at 1236, 1336, or 1536) determine that an information element associated with the second NES cell 1108 (or the second NES cell 1208, the second NES cell 1308, or the second NES cell 1508) has changed and, at 1140 (or at 1240) acquire an updated information element or at 1542 update a flag associated with an information element associated with the second NES cell 1508.

If the UE determines at 2106 that there is (or that there has been) no change in one or more information elements associated with the second cell, the UE may, at 2110, skip updating the flag or the one or more information elements when no change is determined (e.g., the UE may skip updating the flag or the one or more information elements based on a determination that there has been no change in, or to, the one or more information elements). For example, 2110 may be performed by application processor(s) 2606, cellular baseband processor(s) 2624, transceiver(s) 2622, antenna(s) 2680, and/or value tag/cross-cell change indication component 198 of FIG. 26. In some aspects, the one or more value tags may indicate no change if the one or more value tags match a value (e.g., a stored value tag) for the one or more information elements. For example, the one or more value tags for the one or more information elements may indicate no change (e.g., may indicate that there has been no change to one or more corresponding information elements) if the one or more value tags (or one or more values associated with the one or more value tags) match one or more stored value tags (or one or more values associated with the one or more stored value tags). The UE may then use the stored OD-SIB1 to transmit a PRACH message for a random access and/or initial access procedure (e.g., to transmit a Msg1 or a MsgA). For example, referring to FIGS. 14 and 15, the UE 1404 (or the UE 1504), may, at 1436 (or at 1536) determine that there has been no change to an information element (and more specifically, an information element relating to an OD-SIB1) related to the base station 1402 (or the first NES cell 1506) and skip acquiring the information element at 1440 or skip updating a flag for the information element at 1540.

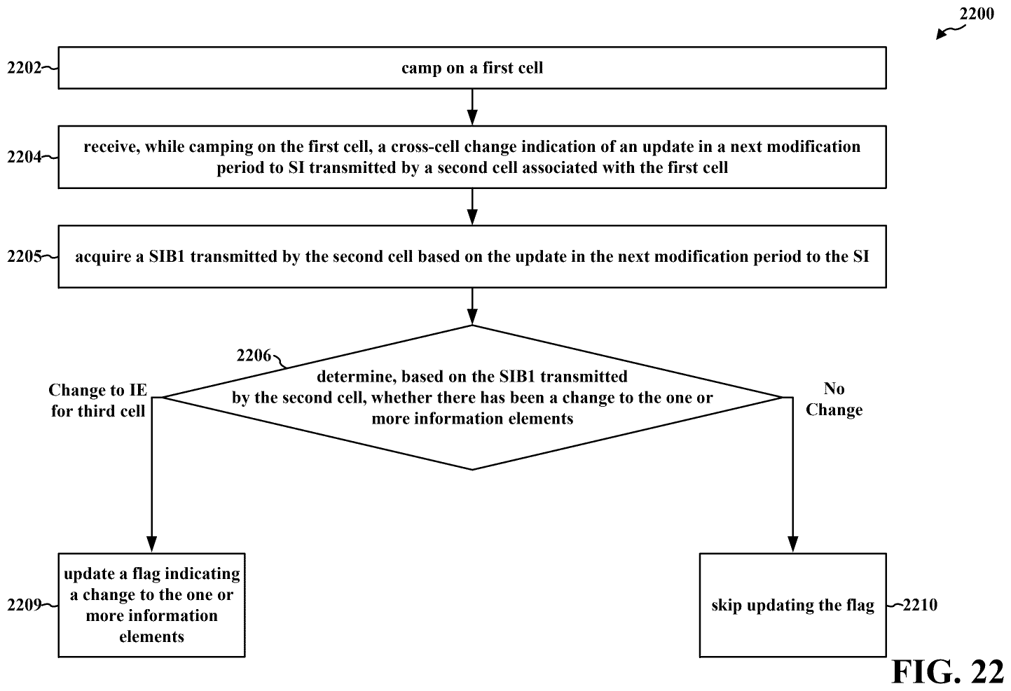

FIG. 22 is a flowchart 2200 of a method of wireless communication. The method may be performed by a UE (e.g., the UE 104, 604, 605, 606, 704, 804, 805, 904, 1004, 1104, 1204, 1304, 1404, 1504, 1604; the apparatus 2604). At 2202, the UE may camp on a first cell. For example, 2202 may be performed by application processor(s) 2606, cellular baseband processor(s) 2624, transceiver(s) 2622, antenna(s) 2680, and/or value tag/cross-cell change indication component 198 of FIG. 26. In some aspects, the first cell may be one of a NES cell or a non-NES cell (e.g., a cell not operating in a NES mode). For example, referring to FIGS. 11-15, the UE 1104 (or the UE 1204, the UE 1304, the UE 1404, or the UE 1504), may, at 1116 (or at 1216, 1316, 1416, or 1516), select and camp on a first NES cell 1106 (or the first NES cell 1206, the first NES cell 1306, the first NES cell 1406, or the first NES cell 1506).

At 2204, the UE may receive, while camping on the first cell, a cross-cell change indication of an update in a next modification period to SI transmitted by a second cell associated with the first cell. For example, the second cell, in some aspects, may be associated with the first cell and the second cell may transmit updated SI in the next modification period. In some aspects, the association between the first cell and the second cell is indicated in at least one of first SI transmitted by the first cell or in second SI transmitted by the second cell. The SI transmitted by the second cell, in some aspects, may include one or more information elements for a third cell that supports the NES mode. For example, 2204 may be performed by application processor(s) 2606, cellular baseband processor(s) 2624, transceiver(s) 2622, antenna(s) 2680, and/or value tag/cross-cell change indication component 198 of FIG. 26. The third cell, in some aspects, may be included in a group of cells. In some aspects, the group of cells may be a group of cells that support the NES mode, and the group of cells may include at least the first cell, and the group of cells may be associated with the second cell that does not operate in a NES mode. The cross-cell change indication, in some aspects, indicates the SI update for a cell that is not in the NES mode and is associated with at least the first cell that supports the NES mode. In some aspects, the cross-cell change indication may be included in a short message. The cross-cell change indication, in some aspects, may be indicated in one of a set of reserved bits in the short message or a repurposed field in the short message. The short message, in some aspects, may indicate that there has been a change to one or more information elements related to an OD-SIB1 or to at least one SI that may, or may not, relate to the OD-SIB1. In some aspects, the short message may also indicate a cell associated with the indicated change to the SI. The cross-cell change, in some aspects, may relate to one or more of an UL-WUS configuration for an OD-SIB1 of the third cell, the OD-SIB1 of the third cell, a first value tag for the OD-SIB1 of the third cell, or a second value tag for the UL-WUS configuration for the OD-SIB1 of the third cell. For example, referring to FIGS. 11-15, the UE 1104 (or the UE 1204, the UE 1304, the UE 1404, or the UE 1504), may receive the cross-cell change indication 1128 (or the cross-cell change indication 1228, the cross-cell change indication 1328, the cross-cell change indication 1428, or the cross-cell change indication 1528), indicating that system information associated with a cell other than the cell from which the cross-cell change indication is received will be changed and/or updated in a next modification period.

At 2205, the UE may acquire a SIB1 transmitted by the second cell based on the update in the next modification period to the SI. In some aspects, the SIB1 may include one or more value tags corresponding to one or more information elements associated with SI transmitted by the second cell. For example, 2205 may be performed by application processor(s) 2606, cellular baseband processor(s) 2624, transceiver(s) 2622, antenna(s) 2680, and/or value tag/cross-cell change indication component 198 of FIG. 26. The one or more information elements associated with the second cell, in some aspects, may be information elements related to an OD-SIB1 for a third cell. In some aspects, the SIB1 may include one or more value tags corresponding to the one or more information elements. Acquiring the SIB1 transmitted by the second cell, in some aspects, may include acquiring the SIB1 from the second cell during the next modification period based on a periodic transmission of the SIB1 or a transmission of the SIB1 triggered by the change to the SI. In some aspects, the one or more value tags included in the SIB1 may indicate a change to a related information element if the one or more value tags do not match the value (e.g., a stored value tag) for the one or more information elements. For example, referring to FIG. 15, the UE 1504 may receive the updated SIB1 1534 (e.g., from the base station 1502) including updated information elements and/or value tags for information elements related to an OD-SIB1 for the second NES cell 1508 (e.g., the third cell).

At 2206, the UE may determine, in response to the cross-cell change indication, whether there is a change in one or more information elements (or SI) associated with the third cell. For example, 2206 may be performed by application processor(s) 2606, cellular baseband processor(s) 2624, transceiver(s) 2622, antenna(s) 2680, and/or value tag/cross-cell change indication component 198 of FIG. 26. Determining whether there is a change in one or more information elements associated with the third cell, in some aspects, may include checking a validity of the one or more information elements associated with the third cell based on one or more value tags. For example, referring to FIG. 15, the UE 1504, may, at 1536 check the validity of information elements related to the second NES cell 1508 based on the updated SIB1 1534 including updated information elements and/or value tags for information elements related to an OD-SIB1 for the second NES cell 1508 (e.g., the third cell).

In some aspects, the UE may determine, at 2206, based on the SIB1 transmitted by the second cell indicating a change in the one or more information elements related to the OD-SIB1, the change in the one or more information elements. If the UE determines, at 2206, based on the SIB1 transmitted by the second cell indicating a change in the one or more information elements related to the OD-SIB1 (or other SI or information elements for, or of, the third cell), that the change in the one or more information elements includes a change to at least one information element related to the OD-SIB1 for the third cell, the UE may, at 2209, update a flag indicating a change to the one or more information elements (e.g., information elements and/or SI related to the third cell). The flag, in a default state may indicate that SI for the third cell (e.g., an UL-WUS configuration for the OD-SIB1 of the third cell, or the SIB1 of the third cell) is valid, while an updated flag may indicate that the SI for the third cell is invalid and for the UE, before attempting to camp on the third cell, to acquire the SI from the second cell (e.g., a SIB1 or SIBx including the information element indicated to have changed if not already acquired at 2205) and/or the third cell (e.g., an OD-SIB1 based on an UL-WUS configuration for the OD-SIB1 of the third cell acquired from the second cell). The UE, in some aspects, may determine, at 2206, based on the SIB1 transmitted by the second cell indicating no change in the one or more information elements related to the OD-SIB1, no change in the one or more information elements and may, at 2210, skip updating the flag related to the third cell. For example, 2209 and 2210 may be performed by application processor(s) 2606, cellular baseband processor(s) 2624, transceiver(s) 2622, antenna(s) 2680, and/or value tag/cross-cell change indication component 198 of FIG. 26. Referring to FIG. 15, for example, the UE 1504 may, at 1536 check the validity of information elements related to the second NES cell 1508 (e.g., a third cell for a cross-cell change indication associated with SI transmitted by the base station 1502) based on the updated SIB1 1534 including updated information elements and/or value tags for information elements related to an OD-SIB1 for the second NES cell 1508 (e.g., the third cell).

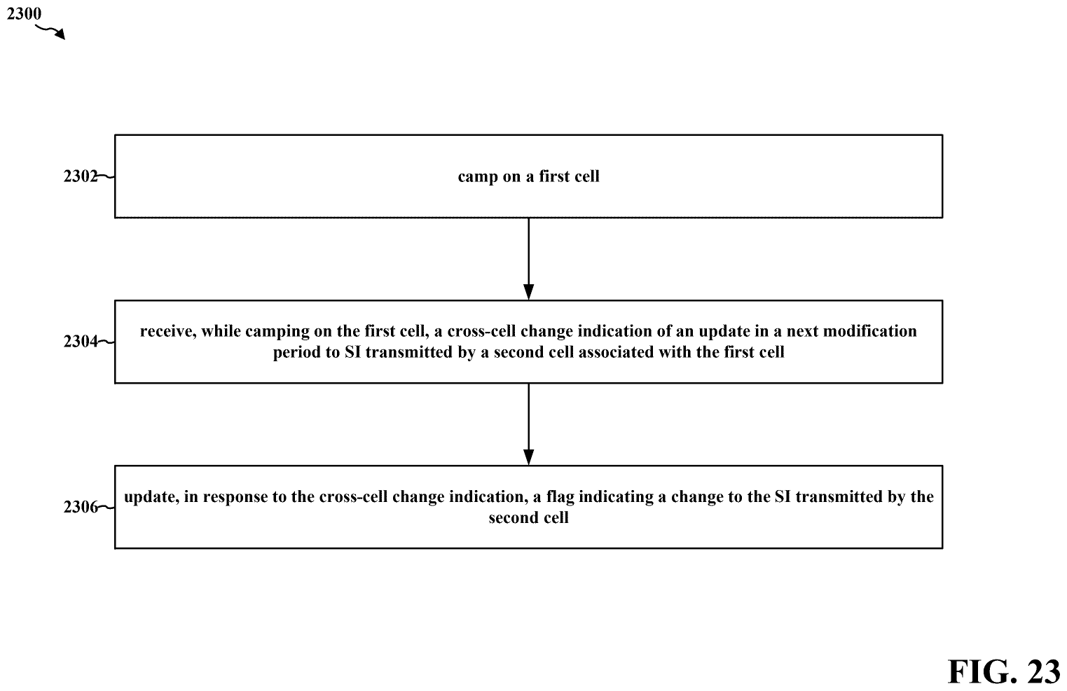

FIG. 23 is a flowchart 2300 of a method of wireless communication. The method may be performed by a UE (e.g., the UE 104, 604, 605, 606, 704, 804, 805, 904, 1004, 1104, 1204, 1304, 1404, 1504, 1604; the apparatus 2604). At 2302, the UE may camp on a first cell. For example, 2302 may be performed by application processor(s) 2606, cellular baseband processor(s) 2624, transceiver(s) 2622, antenna(s) 2680, and/or value tag/cross-cell change indication component 198 of FIG. 26. In some aspects, the first cell may be one of a NES cell or a non-NES cell (e.g., a cell not operating in a NES mode). For example, referring to FIGS. 11-14, the UE 1104 (or the UE 1204, the UE 1304, or the UE 1404), may, at 1116 (or at 1216, 1316, or 1416), select and camp on a first NES cell 1106 (or the first NES cell 1206, the first NES cell 1306, or the first NES cell 1406).

At 2304, the UE may receive, while camping on the first cell, a cross-cell change indication of an update in a next modification period to SI transmitted by a second cell associated with the first cell. For example, the second cell, in some aspects, may be associated with the first cell and the second cell may transmit updated SI in the next modification period as indicated by the cross-cell change indication. The SI transmitted by the second cell, in some aspects, may include one or more information elements for a third cell that supports the NES mode. For example, 2304 may be performed by application processor(s) 2606, cellular baseband processor(s) 2624, transceiver(s) 2622, antenna(s) 2680, and/or value tag/cross-cell change indication component 198 of FIG. 26. The third cell, in some aspects, may be included in a group of cells. In some aspects, the group of cells may be a group of cells that support the NES mode, and the group of cells may include at least the first cell, and the group of cells may be associated with the second cell that does not operate in a NES mode. The cross-cell change indication, in some aspects, indicates the SI update for a cell that is not in the NES mode and is associated with at least the first cell that supports the NES mode. In some aspects, the cross-cell change indication may be included in a short message. The cross-cell change indication, in some aspects, may be indicated in one of a set of reserved bits in the short message or a repurposed field in the short message. The short message, in some aspects, may indicate that there has been a change to one or more information elements related to an OD-SIB1 or to at least one SI that may, or may not, relate to the OD-SIB1. In some aspects, the short message may also indicate a cell (or set of cells) associated with the indicated change to the SI. The cross-cell change, in some aspects, may relate to one or more of an UL-WUS configuration for an OD-SIB1 of the third cell, the OD-SIB1 of the third cell, a first value tag for the OD-SIB1 of the third cell, or a second value tag for the UL-WUS configuration for the OD-SIB1 of the third cell. For example, referring to FIG. 16, the UE 1604 may receive the cross-cell change indication 1628 indicating that system information associated with a cell other than the cell from which the cross-cell change indication is received will be changed and/or updated in a next modification period.

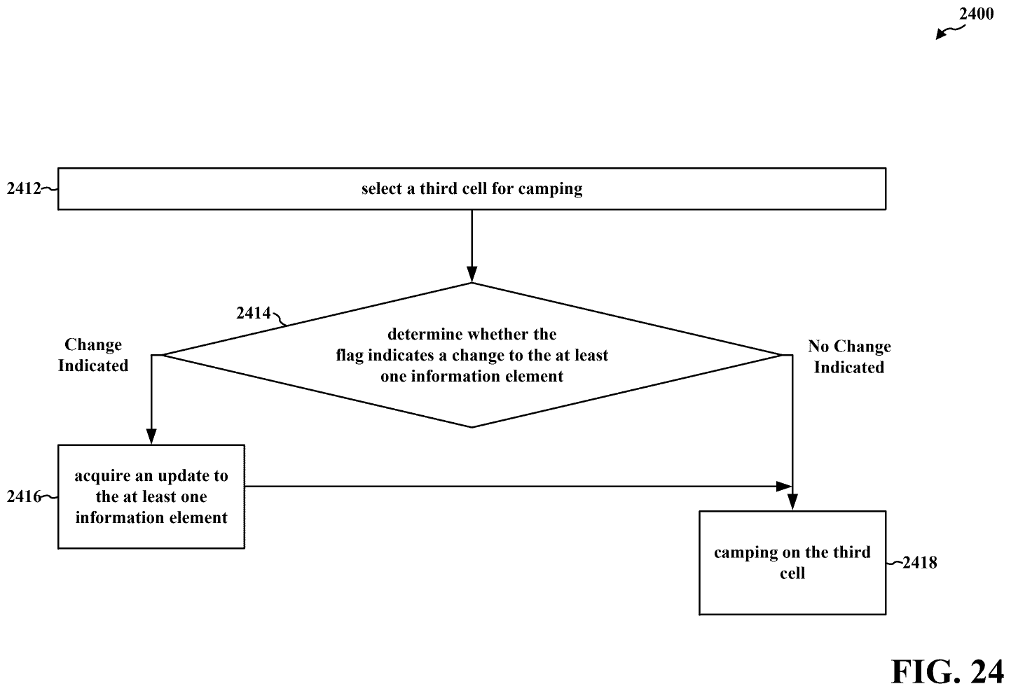

At 2306, the UE may, in response to the cross-cell change indication, update a flag indicating a change to the SI transmitted by the second cell. For example, 2306 may be performed by application processor(s) 2606, cellular baseband processor(s) 2624, transceiver(s) 2622, antenna(s) 2680, and/or value tag/cross-cell change indication component 198 of FIG. 26. In some aspects, the second cell and a third cell may be identified in the cross-cell change indication (and/or based on configuration information known to the UE) as being associated with the changed SI (or the cross-cell change indication). In some aspects, a default state of the flag (entered after receiving an update to the related SI) may indicate that the information element is valid until the flag is updated to an “invalid” state when a UE receives an indication (e.g., the cross-cell change indication) that the information element has changed, where the updated flag indicates to reacquire the related information element upon a selection of a related cell (e.g., a NES cell associated with the flag and/or the information element identified as having changed by the associated flag). Updating the flag, in some aspects, may include updating a first flag for the second cell and a second flag for the third cell. As described below in relation to FIG. 24, the flag may indicate for the UE to acquire SI (e.g., at 2416) for the “flagged” cell (e.g., the second cell and/or the third cell) upon selection and/or reselection of the flagged cell (e.g., a selection of the third cell at 2402). For example, referring to FIG. 16, the UE 1604 may, in response to the cross-cell change indication 1628, update a flag for at least the second NES cell 1608 indicating for the UE 1604 to retrieve and/or acquire the SI for the second NES cell 1608 if the second NES cell 1608 is selected and/or reselected. FIG. 24 is a flowchart 2400 of a method of wireless communication. The method may be performed by a UE (e.g., the UE 104, 604, 605, 606, 704, 804, 805, 904, 1004, 1104, 1204, 1304, 1404, 1504, 1604; the apparatus 2604). The method of flowchart 2400, in some aspects, may be related to the method of FIGS. 22 and 23. At 2412, the UE may select the third cell for camping. For example, 2412 may be performed by application processor(s) 2606, cellular baseband processor(s) 2624, transceiver(s) 2622, antenna(s) 2680, and/or value tag/cross-cell change indication component 198 of FIG. 26. In some aspects, the third cell may be a NES cell. For example, referring to FIGS. 15 and 16, the UE 1504 (or the UE 1604) may, at 1544 (o at 1644) select and/or reselect the second NES cell 1508 (or the second NES cell 1608) to camp on.

At 2414, the UE may determine, in response to the third cell being selected, whether the flag indicating the change to the one or more information elements indicates a change to the at least one information element. For example, 2414 may be performed by application processor(s) 2606, cellular baseband processor(s) 2624, transceiver(s) 2622, antenna(s) 2680, and/or value tag/cross-cell change indication component 198 of FIG. 26. In some aspects, if the flag (e.g., based on the update at 2209 of FIG. 22 or the update at 2306 of FIG. 23) indicates the change to the at least one information element or SI associated with the third cell, the UE may, at 2416, acquire an update to the at least one information element. The update to the at least one information element, in some aspects, may be acquired from the second cell or from the third cell. In some aspects, to acquire the information element from the third cell, the UE may acquire configuration information (e.g., an UL-WUS configuration for an OD-SIB1 of the third cell) from the second cell (via a SIB1 or a SIBx transmitted by the second cell including the configuration information for the third cell). For example, the UE may acquire the SIB1 of the second cell to determine how to acquire the SIB1 of the third cell (either directly from the second cell or from the third cell based on an UL-WUS configuration acquired from the second cell for the OD-SIB1 of the third cell). In some aspects, acquiring an update to the at least one information element may include acquiring an updated SIB1 of the third cell. After acquiring the updated at least one information element (e.g., the SIB1 of the third cell), or if the flag indicates no change to the at least one information element, the UE may, at 2418, camp on the third cell without acquiring (for a second time) an update to the at least one information element from the second cell or the third cell. In some aspects, if the flag is updated based on an association of a cross-cell change indication with the third cell without a determination that SI for the third cell has changed, the UE may acquire one or more value tags, e.g., from the second cell, and determine whether the at least one information element is still valid (has not changed), and may use a stored SI and/or information element if the stored value is determined to be valid without acquiring additional SI from either the second cell or the third cell before camping on the third cell at 2418. For example, 2414-2418 may be performed by application processor(s) 2606, cellular baseband processor(s) 2624, transceiver(s) 2622, antenna(s) 2680, and/or value tag/cross-cell change indication component 198 of FIG. 26. Referring, for example, to FIGS. 15 and 16, the UE 1504 (or the UE 1604) may at 1544 (or at 1644) select and/or reselect the second NES cell 1508 (or the second NES cell 1608) to camp on and, based on the updated flag, may acquire the information element indicated to be invalid by the updated flag. Based on the acquired information element(s), e.g., the information element(s) included in the SIB1, the UE 1504 (or the UE 1604) may then proceed to initiating the initial access (or RACH) procedure 1556 (or 1656), where the process when selecting the first NES cell 1506 (or the first NES cell 1606) for camping would skip acquiring the information based on the determination not to update the flag based on the determination at 1536 (or at 1636) that the information element had not changed.

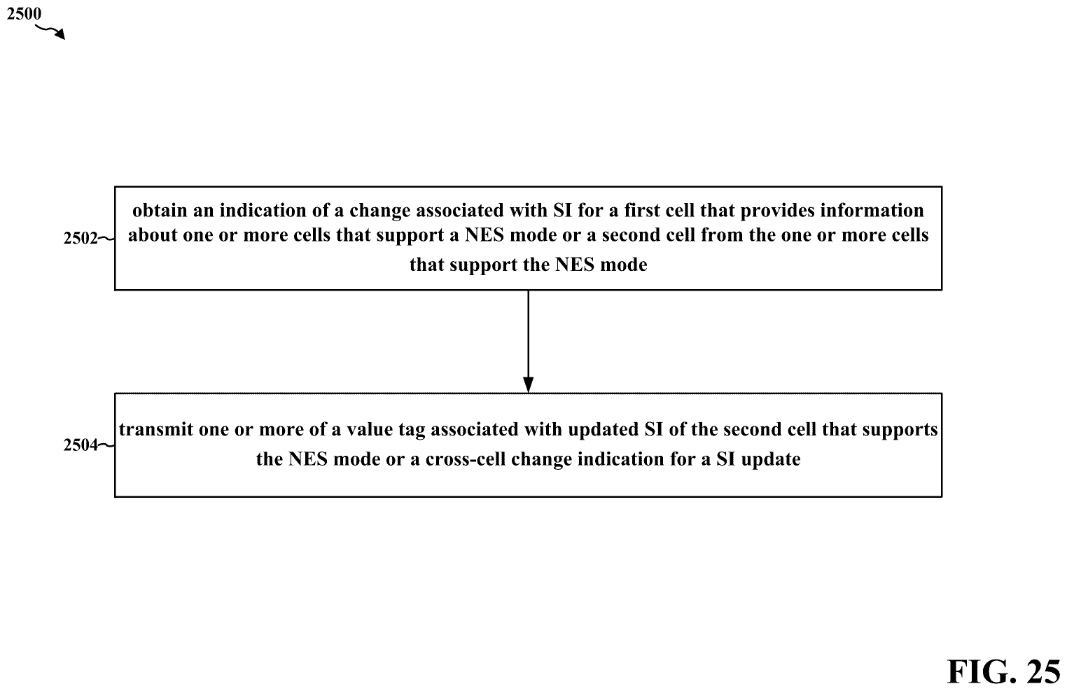

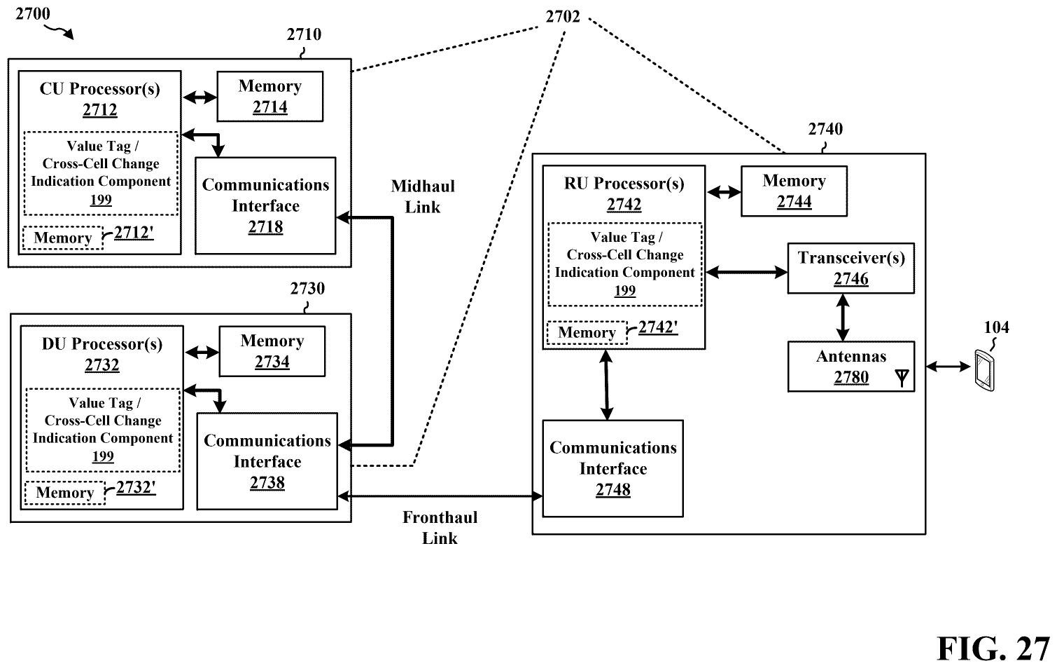

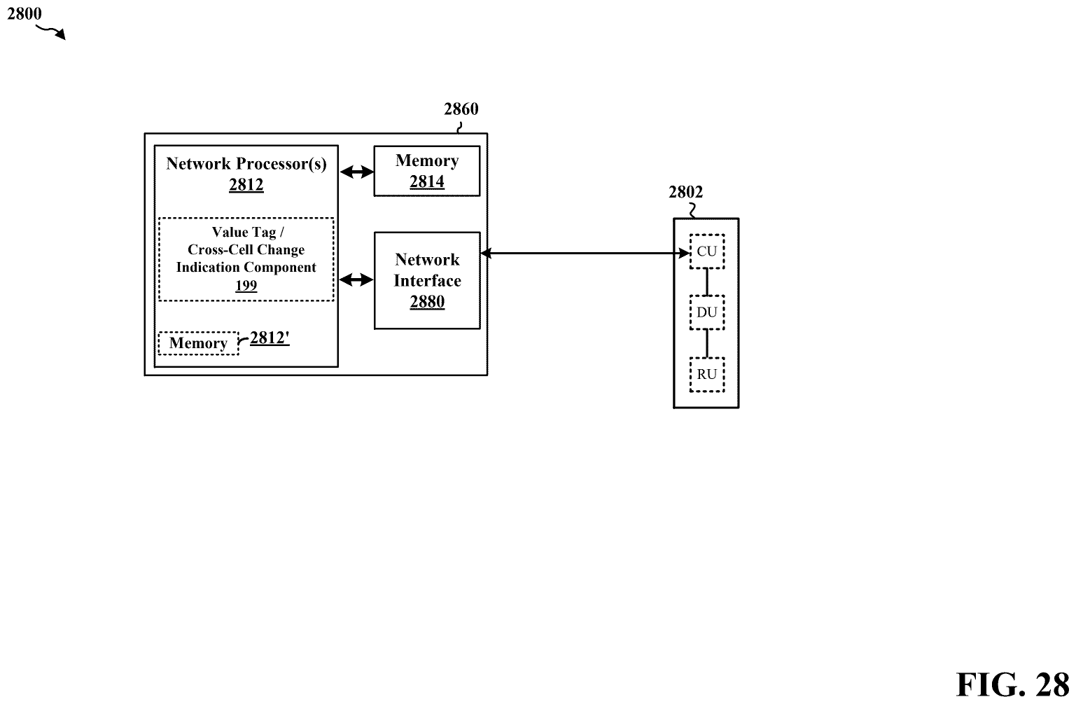

FIG. 25 is a flowchart 2500 of a method of wireless communication. The method may be performed by a cell, such as a base station or NES cell (e.g., the base station 102, 402, 502, 602, 802A, 802B, 902, 1002, 1102, 1202, 1302, 1402, 1502, 1602; a NES cell 822, 832, 842, 852, 862, 872, 882, 892; the first NES cell 906, 1006, 1106, 1206, 1306, 1406, 1506, 1606; the second NES cell 908, 1008, 1108, 1208, 1308, 1408, 1508, 1608; the network entity 2602, 2702, 2860). At 2502, the base station may obtain an indication of a change associated with system information for a first cell that provides information about a second cell that supports a NES mode or for the second cell. For example, 2502 may be performed by CU processor(s) 2712, DU processor(s) 2732, RU processor(s) 2742, transceiver(s) 2746, antenna(s) 2780, network processor 2812, network interface 2880, and/or value tag/cross-cell change indication component 199 of FIGS. 27 and 28. In some aspects, the base station may be the first cell and obtaining the indication of the change may include determining to change the system information for the first cell that provides information about the second cell or to change the system information for the second cell provided by the first cell. The base station, in some aspects may be the second cell and obtaining the indication of the change may include receiving the indication of the change from the first cell that provides information about the second cell. For example, referring to FIGS. 11-15, the first NES cell 1106 (or the first NES cell 1206, the first NES cell 1306, the first NES cell 1406, or the first NES cell 1506), may receive an inter-cell coordination signaling message in the set of inter-cell coordination signaling messages 1124 (or the set of inter-cell coordination signaling messages 1224, the set of inter-cell coordination signaling messages 1324, the set of inter-cell coordination signaling messages 1424, or a set of inter-cell coordination signaling messages triggering the cross-cell change indication 1528), or the base station 1102 (or the base station 1202) may determine to update SI for at least the second NES cell 1108 (or the second NES cell 1208).

At 2504, the base station may, based on the indication, transmit one or more of a value tag associated with updated system information of the second cell that supports the NES mode or a cross-cell change indication for a system information update. For example, 2504 may be performed by CU processor(s) 2712, DU processor(s) 2732, RU processor(s) 2742, transceiver(s) 2746, antenna(s) 2780, network processor 2812, network interface 2880, and/or value tag/cross-cell change indication component 199 of FIGS. 27 and 28. In some aspects, transmitting includes transmitting the value tag indicating a change for one or more of a first uplink wake up signal (UL-WUS) configuration for the OD-SIB1 of the second cell, a second UL-WUS configuration for a set of cells that support the NES mode (where the second cell is one of the set of cells), a SIB1 of the second cell, or multiple SIB1s for the set of cells that support the NES mode (where the second cell is one of the set of cells). The one or more value tags, in some aspects, may be included in one or more of a periodic SIB1 from the first cell, a SIB from the first cell, a RRC release message from the first cell, or a MIB from the second cell. In some aspects, transmitting the one or more of the value tag associated with the updated system information of the second cell that supports the NES mode or the cross-cell change indication for the system information update, may include transmitting the one or more of the value tag associated with the updated system information of the second cell that supports the NES mode or the cross-cell change indication for the system information update to one or more cells that support the NES mode that are associated with at least one of the first cell or the second cell. For example, referring to FIGS. 9-15, the base station 902 (or the base station 1002) may transmit a set of updated value tags 916 (or a set of updated value tags 1016) based on a change to one of the UL-WUS configuration and/or the SIB1 for the first NES cell 906 (or to one of the UL-WUS configuration and/or the SIB1 for the first NES cell 1006) or the first NES cell 1106 (or the first NES cell 1206, the first NES cell 1306, the first NES cell 1406, or the first NES cell 1506), may transmit a cross-cell change indication 1128 (or the cross-cell change indication 1228, the cross-cell change indication 1328, the cross-cell change indication 1428, or the cross-cell change indication 1528) based on receiving an inter-cell coordination signaling message in the set of inter-cell coordination signaling messages 1124 (or the set of inter-cell coordination signaling messages 1224, the set of inter-cell coordination signaling messages 1324, the set of inter-cell coordination signaling messages 1424, or a set of inter-cell coordination signaling messages triggering the cross-cell change indication 1528), or the base station 1102 (or the base station 1202) may transmit the SI change indication 1126 (or the SI change indication 1226) based on determining to change SI related to another cell.

FIG. 26 is a diagram 2600 illustrating an example of a hardware implementation for an apparatus 2604. The apparatus 2604 may be a UE, a component of a UE, or may implement UE functionality. In some aspects, the apparatus 2604 may include at least one cellular baseband processor 2624 (also referred to as a modem) coupled to one or more transceivers 2622 (e.g., cellular RF transceiver). The cellular baseband processor(s) 2624 may include at least one on-chip memory 2624′. In some aspects, the apparatus 2604 may further include one or more subscriber identity modules (SIM) cards 2620 and at least one application processor 2606 coupled to a secure digital (SD) card 2608 and a screen 2610. The application processor(s) 2606 may include on-chip memory 2606′. In some aspects, the apparatus 2604 may further include a Bluetooth module 2612, a WLAN module 2614, an SPS module 2616 (e.g., GNSS module), one or more sensor modules 2618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2626, a power supply 2630, and/or a camera 2632. The Bluetooth module 2612, the WLAN module 2614, and the SPS module 2616 may include an on-chip transceiver (TRX) (or in some cases, just a receiver (RX)). The Bluetooth module 2612, the WLAN module 2614, and the SPS module 2616 may include their own dedicated antennas and/or utilize one or more antennas 2680 for communication. The cellular baseband processor(s) 2624 communicates through the transceiver(s) 2622 via the one or more antennas 2680 with the UE 104 and/or with an RU associated with a network entity 2602. The cellular baseband processor(s) 2624 and the application processor(s) 2606 may each include a computer-readable medium/memory 2624′, 2606′, respectively. The additional memory modules 2626 may also be considered a computer-readable medium/memory. Each computer-readable medium/memory 2624′, 2606′, 2626 may be non-transitory. The cellular baseband processor(s) 2624 and the application processor(s) 2606 are each responsible for general processing, including the execution of software stored on the computer-readable medium/memory. The software, when executed by the cellular baseband processor(s) 2624/application processor(s) 2606, causes the cellular baseband processor(s) 2624/application processor(s) 2606 to perform the various functions described supra. The computer-readable medium/memory may also be used for storing data that is manipulated by the cellular baseband processor(s) 2624/application processor(s) 2606 when executing software. The cellular baseband processor(s) 2624/application processor(s) 2606 may be a component of the UE 350 and may include the at least one memory 360 and/or at least one of the TX processor 368, the RX processor 356, and the controller/processor 359. In one configuration, the apparatus 2604 may be at least one processor chip (modem and/or application) and include just the cellular baseband processor(s) 2624 and/or the application processor(s) 2606, and in another configuration, the apparatus 2604 may be the entire UE (e.g., see UE 350 of FIG. 3) and include the additional modules of the apparatus 2604.

As discussed supra, the value tag/cross-cell change indication component 198 may be configured to select, while camped on a first cell, a second cell that supports a NES mode and check, in response to selecting the second cell supporting the NES mode, a validity of one or more information elements associated with an OD-SIB1 for the second cell based on one or more value tags. The value tag/cross-cell change indication component 198, in some aspects, may be configured to camp on a first cell and receive, while camping on the first cell, a cross-cell change indication of an update in a next modification period to system information (SI) transmitted by a second cell associated with the first cell. The value tag/cross-cell change indication component 198 may be within the cellular baseband processor(s) 2624, the application processor(s) 2606, or both the cellular baseband processor(s) 2624 and the application processor(s) 2606. The value tag/cross-cell change indication component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 2604 may include a variety of components configured for various functions. In one configuration, the apparatus 2604, and in particular the cellular baseband processor(s) 2624 and/or the application processor(s) 2606, may include means for selecting, while camped on a first cell, a second cell that supports a network energy saving (NES) mode. The apparatus 2604, and in particular the cellular baseband processor(s) 2624 and/or the application processor(s) 2606, may include means for checking, in response to selecting the second cell supporting the NES mode, a validity of one or more information elements associated with an on demand system information block 1 (OD-SIB1) for the second cell based on one or more value tags. The apparatus 2604, and in particular the cellular baseband processor(s) 2624 and/or the application processor(s) 2606, may include means for transmitting a PRACH transmission to request the OD-SIB1 based on the one or more value tags indicating a change in the one or more information elements for the OD-SIB1. The apparatus 2604, and in particular the cellular baseband processor(s) 2624 and/or the application processor(s) 2606, may include means for skipping the PRACH transmission to request the OD-SIB1 based on the one or more value tags indicating no change in the one or more information elements for the OD-SIB1. The apparatus 2604, and in particular the cellular baseband processor(s) 2624 and/or the application processor(s) 2606, may include means for receiving the one or more value tags from the first cell. The apparatus 2604, and in particular the cellular baseband processor(s) 2624 and/or the application processor(s) 2606, may include means for selecting a first cell. The apparatus 2604, and in particular the cellular baseband processor(s) 2624 and/or the application processor(s) 2606, may include means for receiving, from the first cell, a cross-cell change indication for a system information (SI) update in a next modification period for one or more different cells. The apparatus 2604, and in particular the cellular baseband processor(s) 2624 and/or the application processor(s) 2606, may include means for camping on a first cell. The apparatus 2604, and in particular the cellular baseband processor(s) 2624 and/or the application processor(s) 2606, may include means for receiving, while camping on the first cell, a cross-cell change indication of an update in a next modification period to system information (SI) transmitted by a second cell associated with the first cell. The apparatus 2604, and in particular the cellular baseband processor(s) 2624 and/or the application processor(s) 2606, may include means for updating a flag indicating a change to the SI transmitted by the second cell. The apparatus 2604, and in particular the cellular baseband processor(s) 2624 and/or the application processor(s) 2606, may include means for determining, in response to the cross-cell change indication, whether there is a change in one or more information elements associated with the second cell. The apparatus 2604, and in particular the cellular baseband processor(s) 2624 and/or the application processor(s) 2606, may include means updating at least one of a flag indicating a change to the one or more information elements or the one or more information elements during the next modification period when the change is determined. The apparatus 2604, and in particular the cellular baseband processor(s) 2624 and/or the application processor(s) 2606, may include means acquiring updates to the one or more information elements from the second cell during the next modification period. The apparatus 2604, and in particular the cellular baseband processor(s) 2624 and/or the application processor(s) 2606, may include means for acquiring updated information from the at least one of the one or more different cells in a modification period if the change is determined. The apparatus 2604, and in particular the cellular baseband processor(s) 2624 and/or the application processor(s) 2606, may include means for updating a flag if the change is determined. The apparatus 2604, and in particular the cellular baseband processor(s) 2624 and/or the application processor(s) 2606, may include means for skipping updating the flag or the one or more information elements when no change is determined. The apparatus 2604, and in particular the cellular baseband processor(s) 2624 and/or the application processor(s) 2606, may include means for selecting the third cell for camping. The apparatus 2604, and in particular the cellular baseband processor(s) 2624 and/or the application processor(s) 2606, may include means for determining, in response to the third cell being selected, whether the flag indicating the change to the one or more information elements indicates a change to the at least one information element. The apparatus 2604, and in particular the cellular baseband processor(s) 2624 and/or the application processor(s) 2606, may include means for acquiring an update to the at least one information element from the second cell when the flag indicates the change to the at least one information element. The apparatus 2604, and in particular the cellular baseband processor(s) 2624 and/or the application processor(s) 2606, may include means for camping on the third cell without acquiring an update to the at least one information element from the second cell when the flag indicates no change to the at least one information element. The apparatus 2604, and in particular the cellular baseband processor(s) 2624 and/or the application processor(s) 2606, may include means for acquiring a SIB1 transmitted by the second cell based on the update in the next modification period to the SI. The apparatus 2604, and in particular the cellular baseband processor(s) 2624 and/or the application processor(s) 2606, may include means for determining, based on the SIB1 transmitted by the second cell indicating a change in the one or more information elements related to the OD-SIB1, the change in the one or more information elements. The apparatus 2604, and in particular the cellular baseband processor(s) 2624 and/or the application processor(s) 2606, may include means for acquiring updates to the one or more information elements from the second cell during the next modification period. The apparatus 2604, and in particular the cellular baseband processor(s) 2624 and/or the application processor(s) 2606, may include means for determining, based on the SIB1 transmitted by the second cell indicating a change in the one or more information elements related to the OD-SIB1, the change in the one or more information elements includes a change to the at least one information element. The apparatus 2604, and in particular the cellular baseband processor(s) 2624 and/or the application processor(s) 2606, may include means for updating the flag when the change is determined for the at least one information element relating to the OD-SIB1 for the third cell. The apparatus 2604, and in particular the cellular baseband processor(s) 2624 and/or the application processor(s) 2606, may include means for determining, based on the SIB1 transmitted by the second cell indicating no change in the one or more information elements related to the OD-SIB1, no change in the one or more information elements. The apparatus 2604 may further include means for performing any of the aspects described in connection with the flowcharts in FIGS. 17-24, and/or performed by the UE in the communication flow of FIGS. 11-16. The means may be the value tag/cross-cell change indication component 198 of the apparatus 2604 configured to perform the functions recited by the means. As described supra, the apparatus 2604 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 27 is a diagram 2700 illustrating an example of a hardware implementation for a network entity 2702. The network entity 2702 may be a BS, a component of a BS, or may implement BS functionality. The network entity 2702 may include at least one of a CU 2710, a DU 2730, or an RU 2740. For example, depending on the layer functionality handled by the value tag/cross-cell change indication component 199, the network entity 2702 may include the CU 2710; both the CU 2710 and the DU 2730; each of the CU 2710, the DU 2730, and the RU 2740; the DU 2730; both the DU 2730 and the RU 2740; or the RU 2740. The CU 2710 may include at least one CU processor 2712. The CU processor(s) 2712 may include on-chip memory 2712′. In some aspects, the CU 2710 may further include additional memory modules 2714 and a communications interface 2718. The CU 2710 communicates with the DU 2730 through a midhaul link, such as an F1 interface. The DU 2730 may include at least one DU processor 2732. The DU processor(s) 2732 may include on-chip memory 2732′. In some aspects, the DU 2730 may further include additional memory modules 2734 and a communications interface 2738. The DU 2730 communicates with the RU 2740 through a fronthaul link. The RU 2740 may include at least one RU processor 2742. The RU processor(s) 2742 may include on-chip memory 2742′. In some aspects, the RU 2740 may further include additional memory modules 2744, one or more transceivers 2746, one or more antennas 2780, and a communications interface 2748. The RU 2740 communicates with the UE 104. The on-chip memory 2712′, 2732′, 2742′ and the additional memory modules 2714, 2734, 2744 may each be considered a computer-readable medium/memory. Each computer-readable medium/memory may be non-transitory. Each of the processors 2712, 2732, 2742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the value tag/cross-cell change indication component 199 may be configured to obtain an indication of a change associated with system information for a first cell that provides information about a second cell that supports a NES mode or for the second cell and transmit, based on the indication, one or more of a value tag associated with updated system information of the second cell that supports the NES mode or a cross-cell change indication for a system information update. The value tag/cross-cell change indication component 199 may be within one or more processors of one or more of the CU 2710, DU 2730, and the RU 2740. The value tag/cross-cell change indication component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2702 may include a variety of components configured for various functions. In one configuration, the network entity 2702 may include means for obtaining an indication of a change associated with system information for a first cell that provides information about a second cell that supports a network energy saving (NES) mode or for the second cell. The network entity 2702 may include means for transmitting, based on the indication, one or more of a value tag associated with updated system information of the second cell that supports the NES mode or a cross-cell change indication for a system information update. The network entity 2702 may include means for transmitting the value tag indicating a change for one or more of: a first uplink wake up signal (UL-WUS) configuration for the OD-SIB1 of the second cell, a second UL-WUS configuration for a set of cells that support the NES mode, wherein the second cell is one of the set of cells, a SIB1 of the second cell, or multiple SIB1s for the set of cells that support the NES mode, wherein the second cell is one of the set of cells. The network entity 2702 may include means for receiving the indication at the second cell from the first cell that provides information about the second cell. The network entity 2702 may include means for determining to change the system information for the first cell that provides information about the second cell or to change the system information for the second cell provided by the first cell. The network entity 2702 may further include means for performing any of the aspects described in connection with the flowcharts in FIG. 25, and/or performed by the base station in the communication flow of FIGS. 9-15. The means may be the value tag/cross-cell change indication component 199 of the network entity 2702 configured to perform the functions recited by the means. As described supra, the network entity 2702 may include the TX processor 316, the RX processor 370, and the controller/processor 375. As such, in one configuration, the means may be the TX processor 316, the RX processor 370, and/or the controller/processor 375 configured to perform the functions recited by the means or as described in relation to FIGS. 9-15 and 20.

FIG. 28 is a diagram 2800 illustrating an example of a hardware implementation for a network entity 2860. In one example, the network entity 2860 may be within the core network 120. The network entity 2860 may include at least one network processor 2812. The network processor(s) 2812 may include on-chip memory 2812′. In some aspects, the network entity 2860 may further include additional memory modules 2814. The network entity 2860 communicates via the network interface 2880 directly (e.g., backhaul link) or indirectly (e.g., through a RIC) with the CU 2802. The on-chip memory 2812′ and the additional memory modules 2814 may each be considered a computer-readable medium/memory. Each computer-readable medium/memory may be non-transitory. The network processor(s) 2812 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the value tag/cross-cell change indication component 199 may be configured to obtain an indication of a change associated with system information for a first cell that provides information about a second cell that supports a NES mode or for the second cell and transmit, based on the indication, one or more of a value tag associated with updated system information of the second cell that supports the NES mode or a cross-cell change indication for a system information update. The value tag/cross-cell change indication component 199 may be within the network processor(s) 2812. The value tag/cross-cell change indication component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2860 may include a variety of components configured for various functions. In one configuration, the network entity 2860 may include means for obtaining an indication of a change associated with system information for a first cell that provides information about a second cell that supports a network energy saving (NES) mode or for the second cell. The network entity 2860 may include means for transmitting, based on the indication, one or more of a value tag associated with updated system information of the second cell that supports the NES mode or a cross-cell change indication for a system information update. The network entity 2860 may include means for transmitting the value tag indicating a change for one or more of: a first uplink wake up signal (UL-WUS) configuration for the OD-SIB1 of the second cell, a second UL-WUS configuration for a set of cells that support the NES mode, wherein the second cell is one of the set of cells, a SIB1 of the second cell, or multiple SIB1s for the set of cells that support the NES mode, wherein the second cell is one of the set of cells. The network entity 2860 may include means for receiving the indication at the second cell from the first cell that provides information about the second cell. The network entity 2860 may include means for determining to change the system information for the first cell that provides information about the second cell or to change the system information for the second cell provided by the first cell. The means may be the value tag/cross-cell change indication component 199 of the network entity 2860 configured to perform any of the aspects described in connection with the flowcharts in FIG. 25, and/or performed by the base station in the communication flow of FIGS. 9-15.

Various aspects relate generally to improving cell selection and/or cell reselection procedures. In some aspects, the improvements may be related to cell selection and/or reselection involving one or more NES cells associated with one or more non-NES cells (e.g., a cellA). Some aspects more specifically relate to validating stored system information and/or configuration information using value tags. Additional aspects, specifically relate to a cross-cell change indication received from a first cell (e.g., a first NES cell or non-NES cell) regarding a SI change (e.g., a change to one or more information elements) associated with a second cell (e.g., a second NES cell or non-NES cell). In some examples, a wireless device may be configured to select, while camped on a first cell, a second cell that supports a NES mode and check a validity of one or more information elements associated with an OD-SIB1 for the second cell based on one or more value tags, in response to selecting the second cell supporting the NES mode. In some examples, a wireless device may be configured to select a second cell that supports a NES mode and receive, from the second cell, a cross-cell change indication for a SI update in a next modification period for one or more different cells. A network entity, in some aspects, may be configured to obtain an indication of a change associated with system information for a first cell that provides information about one or more cells that support a NES mode or a second cell from the one or more cells that support the NES mode and transmit one or more of a value tag associated with updated system information of the second cell that supports the NES mode or a cross-cell change indication for a system information update.

Particular aspects of the subject matter described in this disclosure can be implemented to realize one or more of the following potential advantages. In some examples, by validating stored information and/or by receiving cross-cell SI change indications, the described techniques can be used to reduce a latency and/or power consumption associated with cell selection and/or cell reselection.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at user equipment (UE), comprising: selecting, while camped on a first cell, a second cell that supports a network energy saving (NES) mode; and checking, in response to selecting the second cell supporting the NES mode, a validity of one or more information elements associated with an on demand system information block 1 (OD-SIB1) for the second cell based on one or more value tags.

Aspect 2 is the method of aspect 1, further comprising: transmitting a PRACH transmission to request the OD-SIB1 based on the one or more value tags indicating a change in the one or more information elements for the OD-SIB1; or skipping the PRACH transmission to request the OD-SIB1 based on the one or more value tags indicating no change in the one or more information elements for the OD-SIB1.

Aspect 3 is the method of aspect 2, wherein the one or more value tags indicate no change if the one or more value tags match a value for the one or more information elements, and wherein the one or more value tags indicate the change if the one or more value tags do not match the value.

Aspect 4 is the method of any of aspects 1 to 3, wherein the one or more information elements include one or more of: a first uplink wake up signal (UL-WUS) configuration for the OD-SIB1 of the second cell, a second UL-WUS configuration for a set of cells that support the NES mode, wherein the second cell is one of the set of cells, a SIB1 of the second cell, or multiple SIB Is for the set of cells that support the NES mode, wherein the second cell is one of the set of cells.

Aspect 5 is the method of any of aspects 1 to 4, further comprising: receiving the one or more value tags from the first cell or a third cell.

Aspect 6 is the method of aspect 5, wherein receiving the one or more value tags comprises receiving the one or more value tags in a periodically transmitted message.

Aspect 7 is the method of any of aspects 5 and 6, wherein the one or more value tags are comprised in a same message as the one or more information elements.

Aspect 8 is the method of any of aspects 5 and 6, wherein the one or more value tags are comprised in a different message than the one or more information elements.

Aspect 9 is the method of aspect 5, wherein the one or more value tags are comprised in one of: a periodic SIB1 from the first cell or the third cell, a system information block (SIB) from the first cell, or the third cell, a radio resource control (RRC) release message from the first cell or the third cell, or a master information block (MIB) from the second cell.

Aspect 10 is a method of wireless communication at user equipment (UE), comprising: camping on a first cell; and receiving, while camping on the first cell, a cross-cell change indication of an update in a next modification period to system information (SI) transmitted by a second cell associated with the first cell.

Aspect 11 is the method of aspect 10, further comprising, in response to the cross-cell change indication: updating a flag indicating a change to the SI transmitted by the second cell; or acquiring updates to the SI transmitted by a second cell during the next modification period.

Aspect 12 is the method of aspect 10, further comprising: determining, in response to the cross-cell change indication, whether there is a change in one or more information elements associated with the second cell; and updating at least one of a flag indicating a change to the one or more information elements or the one or more information elements during the next modification period when the change is determined, wherein updating the one or more information elements comprises acquiring updates to the one or more information elements from the second cell during the next modification period; or skipping updating the flag or the one or more information elements when no change is determined.

Aspect 13 is the method of aspect 12, wherein the second cell transmits SI for a third cell that supports a network energy saving (NES) mode and at least one information element of the one or more information elements is associated with the third cell, the method further comprising: selecting the third cell for camping; determining, in response to the third cell being selected, whether the flag indicating the change to the one or more information elements indicates a change to the at least one information element; and acquiring an update to the at least one information element from the second cell when the flag indicates the change to the at least one information element; or camping on the third cell without acquiring an update to the at least one information element from the second cell when the flag indicates no change to the at least one information element.

Aspect 14 is the method of aspect 13, wherein the one or more information elements associated with the second cell are information elements related to an on demand system information block 1 (OD-SIB1) for one of the second cell or the third cell, and wherein determining whether there is a change in the one or more information elements further comprises acquiring a SIB1 transmitted by the second cell based on the update in the next modification period to the SI, wherein the SIB1 comprises one or more value tags corresponding to the one or more information elements, and at least one of: determining, based on the SIB1 transmitted by the second cell indicating a change in the one or more information elements related to the OD-SIB1, the change in the one or more information elements, wherein the one or more information elements relate to the OD-SIB1 for the second cell, and wherein updating the at least one of the flag or the one or more information elements during the next modification period when the change is determined comprises acquiring updates to the one or more information elements from the second cell during the next modification period; determining, based on the SIB1 transmitted by the second cell indicating a change in the one or more information elements related to the OD-SIB1, the change in the one or more information elements includes a change to the at least one information element, wherein the at least one information element relates to the OD-SIB1 for the third cell, and wherein updating the flag when the change is determined comprises updating the flag when the change is determined for the at least one information element relating to the OD-SIB1 for the third cell; or determining, based on the SIB1 transmitted by the second cell indicating no change in the one or more information elements related to the OD-SIB1, no change in the one or more information elements; and

Aspect 15 is the method of any of aspects 10-14, wherein the association between the first cell and the second cell is indicated in at least one of first SI transmitted by the first cell or in second SI transmitted by the second cell.

Aspect 16 is the method of any of aspects 10-15, wherein the SI transmitted by the second cell includes one or more information elements for a third cell that supports a network energy saving (NES) mode.

Aspect 17 is the method of aspect 16, wherein the one or more information elements comprise one or more of: a uplink wake up signal (UL-WUS) configuration for an on demand system information block 1 (OD-SIB1) of the third cell, the OD-SIB1 of the third cell, a first value tag for the OD-SIB1 of the third cell, or a second value tag for the UL-WUS configuration for the OD-SIB1 of the third cell.

Aspect 18 is the method of any of aspects 16 and 17, wherein the third cell is comprised in a group of cells that support the NES mode, wherein the group of cells includes at least the first cell, and the group of cells is associated with the second cell that does not operate in a network energy saving (NES) mode.

Aspect 19 is the method of any of aspects 10-19, wherein the cross-cell change indication is comprised in a short message.

Aspect 20 is the method of aspect 19, wherein the cross-cell change indication is indicated in one of a set of reserved bits in the short message or a repurposed field in the short message.

Aspect 21 is method of wireless communication at a network node, comprising: obtaining an indication of a change associated with system information for a first cell that provides information about one or more cells that support a network energy saving (NES) mode or a second cell from the one or more cells that support the NES mode; and transmitting one or more of a value tag associated with updated system information of the second cell that supports the NES mode or a cross-cell change indication for a system information update.

Aspect 22 is the method of aspect 21, wherein the transmitting includes transmitting the value tag indicating a change for one or more of: a first uplink wake up signal (UL-WUS) configuration for the OD-SIB1 of the second cell, a second UL-WUS configuration for a set of cells that support the NES mode, wherein the second cell is one of the set of cells, a SIB1 of the second cell, or multiple SIB1s for the set of cells that support the NES mode, wherein the second cell is one of the set of cells.

Aspect 23 is the method of any of aspects 21 and 22, wherein the one or more value tags are comprised in one of: a periodic SIB1 from the first cell, a system information block (SIB) from the first cell, a radio resource control (RRC) release message from the first cell, or a master information block (MIB) from the second cell.

Aspect 24 is the method of any of aspects 21-23, wherein obtaining the indication of the change includes receiving the indication at the second cell from the first cell, and wherein the transmitting includes transmitting the cross-cell change indication for the system information update of the first cell.

Aspect 25 is an apparatus for wireless communication at a device including a memory and at least one processor coupled to the memory and, based at least in part on information stored in the memory, the at least one processor is configured to implement any of aspects 1 to 20.

Aspect 26 is the apparatus of aspect 25, further including a transceiver or an antenna coupled to the at least one processor.

Aspect 27 is an apparatus for wireless communication at a device including means for implementing any of aspects 1 to 20.

Aspect 28 is a computer-readable medium (e.g., a non-transitory computer-readable medium) storing computer executable code, where the code when executed by a processor causes the processor to implement any of aspects 1 to 20.

Aspect 29 is an apparatus for wireless communication at a device including a memory and at least one processor coupled to the memory and, based at least in part on information stored in the memory, the at least one processor is configured to implement any of aspects 21 to 24.

Aspect 30 is the apparatus of aspect 29, further including a transceiver or an antenna coupled to the at least one processor.

Aspect 31 is an apparatus for wireless communication at a device including means for implementing any of aspects 21 to 24.

Aspect 32 is a computer-readable medium (e.g., a non-transitory computer-readable medium) storing computer executable code, where the code when executed by a processor causes the processor to implement any of aspects 21 to 24.

What is claimed is:

1. An apparatus for wireless communication at a user equipment (UE), comprising:
at least one memory; and
at least one processor coupled to the at least one memory and, based at least in part on stored information that is stored in the at least one memory, the at least one processor is configured to:
select, while camped on a first cell, a second cell that supports a network energy saving (NES) mode; and
check, in response to selection of the second cell that supports the NES mode, a validity of one or more information elements associated with an on demand system information block 1 (OD-SIB1) for the second cell based on one or more value tags.

2. The apparatus of claim 1, wherein the at least one processor is further configured to:
transmit a PRACH transmission to request the OD-SIB1 based on the one or more value tags that indicate a change to the one or more information elements for the OD-SIB1, wherein the one or more value tags indicate the change if the one or more value tags do not match a value for the one or more information elements; or
skip the PRACH transmission to request the OD-SIB1 based on the one or more value tags that indicate no change to the one or more information elements for the OD-SIB1, wherein the one or more value tags indicate the no change if the one or more value tags match the value for the one or more information elements.

3. The apparatus of claim 1, wherein the one or more information elements include one or more of:
a first uplink wake up signal (UL-WUS) configuration for the OD-SIB1 of the second cell,
a second UL-WUS configuration for a set of cells that support the NES mode, wherein the second cell is one of the set of cells,
a SIB1 of the second cell, or
multiple SIB Is for the set of cells that support the NES mode, wherein the second cell is one of the set of cells.

4. The apparatus of claim 1, wherein the at least one processor is further configured to:
receive the one or more value tags from the first cell or a third cell.

5. The apparatus of claim 4, wherein to receive the one or more value tags, the at least one processor is configured to receive the one or more value tags in a periodically transmitted message.

6. The apparatus of claim 4, wherein the one or more value tags are comprised in a same message as the one or more information elements.

7. The apparatus of claim 4, wherein the one or more value tags are comprised in a different message than the one or more information elements.

8. The apparatus of claim 4, wherein the one or more value tags are comprised in one of:
a periodic SIB1 from the first cell or the third cell,
a system information block (SIB) from the first cell, or the third cell,
a radio resource control (RRC) release message from the first cell or the third cell, or
a master information block (MIB) from the second cell.

9. An apparatus for wireless communication at a user equipment (UE), comprising:
at least one memory; and
at least one processor coupled to the at least one memory and, based at least in part on stored information that is stored in the at least one memory, the at least one processor is configured to:
camp on a first cell; and
receive, while camped on the first cell, a cross-cell change indication of an update in a next modification period to system information (SI) transmitted by a second cell associated with the first cell.

10. The apparatus of claim 9, wherein, in response to the cross-cell change indication, the at least one processor is further configured to:
update a flag that indicates a change to the SI transmitted by the second cell; or
acquire updates to the SI transmitted by the second cell during the next modification period.

11. The apparatus of claim 9, wherein the at least one processor is further configured to:
determine, in response to the cross-cell change indication, whether there is a change to one or more information elements associated with the second cell; and
update at least one of a flag used to indicate the change to the one or more information elements or the one or more information elements during the next modification period based on a determined change, wherein to update the one or more information elements, the at least one processor is configured to acquire updates to the one or more information elements from the second cell during the next modification period; or
skip the update of the flag or the one or more information elements based on a determination that there has been no change to the one or more information elements.

12. The apparatus of claim 11, wherein the second cell transmits SI for a third cell that supports a network energy saving (NES) mode and at least one information element of the one or more information elements is associated with the third cell, wherein the at least one processor is further configured to:
select the third cell for camping;
determine, in response to the third cell being selected, whether the flag indicates a change to the at least one information element; and
acquire the update to the at least one information element from the second cell based on a first determination that the flag indicates the change to the at least one information element; or
camp on the third cell without acquiring the update to the at least one information element from the second cell based on a second determination that the flag indicates no change to the at least one information element.

13. The apparatus of claim 12, wherein the one or more information elements associated with the second cell are information elements related to an on demand system information block 1 (OD-SIB1) for one of the second cell or the third cell, and wherein to determine whether there is the change to the one or more information elements, the at least one processor is further configured to acquire a SIB1 transmitted by the second cell based on the update in the next modification period to the SI, wherein the SIB1 comprises one or more value tags that correspond to the one or more information elements, and wherein the at least one processor is further configured to at least one of:
determine, based on the SIB1 transmitted by the second cell that indicates the change to the one or more information elements related to the OD-SIB1, the change to the one or more information elements, wherein the one or more information elements relate to the OD-SIB1 for the second cell, and wherein, to update the at least one of the flag or the one or more information elements during the next modification period based on the determined change, the at least one processor is configured to acquire the updates to the one or more information elements from the second cell during the next modification period;
determine, based on the SIB1 transmitted by the second cell that indicates the change to the one or more information elements related to the OD-SIB1, that the change to the one or more information elements includes the change to the at least one information element, wherein the at least one information element relates to the OD-SIB1 for the third cell, and wherein, to update the flag based on the determined change, the at least one processor is configured to update the flag based on the determined change for the at least one information element relating to the OD-SIB1 for the third cell; or
determine, based on the SIB1 transmitted by the second cell that indicates the no change to the one or more information elements related to the OD-SIB1, that there has been the no change to the one or more information elements.

14. The apparatus of claim 9, wherein an association between the first cell and the second cell is indicated in at least one of first SI transmitted by the first cell or in second SI transmitted by the second cell.

15. The apparatus of claim 9, wherein the SI transmitted by the second cell includes one or more information elements for a third cell that supports a network energy saving (NES) mode.

16. The apparatus of claim 15, wherein the one or more information elements comprise one or more of:
an uplink wake up signal (UL-WUS) configuration for an on demand system information block 1 (OD-SIB1) of the third cell,
the OD-SIB1 of the third cell,
a first value tag for the OD-SIB1 of the third cell, or
a second value tag for the UL-WUS configuration for the OD-SIB1 of the third cell.

17. The apparatus of claim 15, wherein the third cell is comprised in a group of cells that support the NES mode, wherein the group of cells includes at least the first cell, and the group of cells is associated with the second cell that does not operate in the NES mode.

18. The apparatus of claim 9, wherein the cross-cell change indication is comprised in a short message and wherein the cross-cell change indication is indicated in one of a set of reserved bits in the short message or a repurposed field in the short message.

19. An apparatus for wireless communication at a network node, comprising:
at least one memory; and
at least one processor coupled to the at least one memory and, based at least in part on stored information that is stored in the at least one memory, the at least one processor is configured to:
obtain an indication of a change associated with system information for a first cell that provides information about one or more cells that support a network energy saving (NES) mode or a second cell from the one or more cells that support the NES mode; and
transmit one or more of a value tag associated with updated system information of the second cell that supports the NES mode or a cross-cell change indication for a system information update.

20. The apparatus of claim 19, wherein to obtain the indication of the change, the at least one processor is configured to receive the indication at the second cell from the first cell, and wherein to transmit, the at least one processor is configured to transmit the cross-cell change indication for the system information update of the first cell.
